(19) United States
(12) Patent Application Publication
(10) Pub. No.: US 2018/0284972 A1
(43) Pub. Date: Oct. 4, 2018

(54) DISPLAY CONTROL APPARATUS, METHOD, AND PROGRAM

(71) Applicants: SONY CORPORATION, Tokyo (JP); Sony Mobile Communications Inc., Tokyo (JP)

(72) Inventors: Satoshi AKAGAWA, Tokyo (JP); Shinichi IRIYA, Kanagawa (JP); Yoshihito OHKI, Tokyo (JP); Makoto IMAMURA, Tokyo (JP); Takahiro KAWAGUCHI, San Diego, CA (US); Masanori MATSUSHIMA, Tokyo (JP); Kazuma TAKAHASHI, Chiba (JP)

(73) Assignees: SONY CORPORATION, Tokyo (JP); Sony Mobile Communications Inc., Tokyo (JP)

(21) Appl. No.: 15/559,694

(22) PCT Filed: Feb. 16, 2017
(86) PCT No.: PCT/JP2017/005703

§ 371 Date: Sep. 19, 2017

Related U.S. Application Data
(60) Provisional application No. 62/297,382, filed on Feb. 19, 2016.

(51) Int. Cl. G06F 3/0484

(52) U.S. Cl. CPC G06F 3/04845; G06F 3/04842

(57) ABSTRACT

There is provided a GUI with which a user easily notices what a computer system should inform a user. An aspect of the present technology that accomplishes the object above is a display control apparatus including a control unit. The control unit outputs a first display element expressed on a display surface by a dot having a first color whose contrast is higher than that of the display surface. Further, the control unit outputs one or a plurality of second display elements expressed on the display surface by a line having the first color. Further, the control unit moves or deforms at least any of the first display element and the second display elements.

### TECHNICAL FIELD

The present technology belongs to a technical field of a graphical user interface (hereinafter, referred to as “GUI”).

### BACKGROUND ART

For example, as mentioned in Patent Literature 1, GUIs have been generally used as user interfaces in various electronic devices such as a portable information terminal and a personal computer.

### CITATION LIST

### Patent Literature

Patent Literature 1: Japanese Patent Application Laid-open No. 2014-59887

### DISCLOSURE OF INVENTION

### Technical Problem

In recent years, devices (display apparatuses) that display GUIs are significantly diversified. Some devices display GUIs at positions at which users do not expect that the GUIs will be displayed. There are devices including transmissive-type display surfaces and devices of a head-mounted display type. Due to such diversification of devices, there can be a possibility that the users may not notice what computer systems should inform the users.

In view of the above-mentioned circumstances, it is an object of the present technology to provide a GUI with which a user can easily notice what a computer system should inform the user.

### Solution to Problem

An aspect of the present technology that accomplishes the object above is a display apparatus including a control unit.

The control unit outputs a first display element expressed on a display surface by a dot having a first color whose contrast is higher than that of the display surface.

The control unit outputs one or a plurality of second display elements expressed on the display surface by a line having the first color.

The control unit moves or deforms at least any of the first display element and the second display elements.

In accordance with this display control apparatus, it is possible to provide a GUI with which a user can easily notice what a computer system should inform the user. Note that the “computer system” set forth herein may include the “display control apparatus”.

The control unit may deform the second display element such that the second display element is pulled out of the first display element.

In accordance with this configuration, an animation in which the second display element is pulled out of the first display element is provided and the user can easily notice each display element.

In this case, the control unit may deform the second display element such that an end portion of the second display element pulled out of the first display element is combined with the first display element and draws an endless figure.

Alternatively, the control unit may deform the second display element such that the second display element that is an endless figure is pulled out of the first display element.

In accordance with these configurations, a surface on which the information presented to the user is displayed is generated by the endless figure drawn by the second display element. Thus, user's attention can be easily attracted to a notification matter.

In either case, the control unit may output information presented to a user within the second display element that is the endless figure, and determine a shape of the endless figure in a manner that depends on a type of the output information.

In accordance with this configuration, the user can grasp the priority or urgency of a notification matter only with the shape.

In this case, the control unit may change a width of the second display element in a manner that depends on the degree of necessity for calling attention.

In accordance with this configuration, the easiness to make it prominent can be finely adjusted by changing the width of the line by program control.

The control unit may display the plurality of second display elements while the plurality of second display elements are partially superimposed on each other, and may continuously deform the plurality of superimposed second display elements over time.

Further, with this configuration, the control unit may output each of the plurality of second display elements to have a closed curve or polygonal shape.

Further, with this configuration, the control unit may continuously deform the plurality of superimposed second display elements over time, as a response to input from the user.

Further, with this configuration, the control unit may input voice as the input from the user, and continuously deform the plurality of superimposed second display elements over time while the voice input is being done, as a response of the voice input.

In accordance with these configurations, for example, a plurality of lines (second display element) having a closed curve or polygonal shape are displayed in accordance with the voice input of the user and an animation in which they continuously move while they are partially superimposed on each other is obtained.

The control unit may output the second display element to have a width smaller than a diameter of the dot of the first display element.

In accordance with this configuration, it becomes easy to distinguish the first display element.

Further, another aspect of the present technology for accomplishing the above-mentioned object is a display control method executed by a control unit of a display control apparatus, the display control method including: outputting a first display element expressed on a display surface by a dot having a first color whose contrast is higher than that of the display surface; outputting one or a plurality of second display elements expressed on the display surface by a line having the first color; and moving or deforming at least any of the first display element and the second display elements.

Further, another aspect of the present technology for accomplishing the above-mentioned object is a display control program that causes a control unit of a display control apparatus to execute steps of: outputting a first display element expressed on a display surface by a dot having a first color whose contrast is higher than that of the display surface; outputting one or a plurality of second display elements expressed on the display surface by a line having the first color; and moving or deforming at least any of the first display element and the second display elements.

Also with the above-mentioned display control method and program, it is possible to provide a GUI with which a user can easily notice what a computer system should inform the user.

### Advantageous Effects of Invention

As described above, in accordance with the present technology, it is possible to provide a GUI with which a user can easily notice what a computer system should inform the user.

It should be noted that the effects described here are not necessarily limitative and may be any effect described in the present disclosure.

### BRIEF DESCRIPTION OF DRAWINGS

FIG. 1 A diagram showing a configuration of a display control apparatus according to an embodiment of the present technology.

FIG. 2 A flowchart showing an operation example of the display control apparatus according to the embodiment.

FIG. 3 A display example of the display control apparatus according to the embodiment.

FIG. 4 A display example of the display control apparatus according to the embodiment.

FIG. 5 A display example of the display control apparatus according to the embodiment.

FIG. 6 A display example of the display control apparatus according to the embodiment.

FIG. 7 A display example of the display control apparatus according to the embodiment.

FIG. 8 A display example of the display control apparatus according to the embodiment.

FIG. 9 A display example of the display control apparatus according to the embodiment.

FIG. 10 A display example of the display control apparatus according to the embodiment.

FIG. 12 A display example of the display control apparatus according to the embodiment.

FIG. 13 A display example of the display control apparatus according to the embodiment.

FIG. 14 A display example of the display control apparatus according to the embodiment.

FIG. 15 A display example of the display control apparatus according to the embodiment.

FIG. 16 A display example of the display control apparatus according to the embodiment.

FIG. 17 A display example of the display control apparatus according to the embodiment.

FIG. 18 A display example of the display control apparatus according to the embodiment.

FIG. 19 A display example of the display control apparatus according to the embodiment.

FIG. 20 A display example of the display control apparatus according to the embodiment.

FIG. 21 Display examples of the display control apparatus according to the embodiment.

FIG. 22 A diagram showing Display Control Example (Animation Example) 1 according to the present technology.

FIG. 23 A diagram showing Display Control Example (Animation Example) 1 according to the present technology.

FIG. 24 A diagram showing Display Control Example (Animation Example) 1 according to the present technology.

FIG. 25 A diagram showing Display Control Example (Animation Example) 1 according to the present technology.

FIG. 26 A diagram showing Display Control Example (Animation Example) 1 according to the present technology.

FIG. 27 A diagram showing Display Control Example (Animation Example) 1 according to the present technology.

FIG. 28 A diagram showing Display Control Example (Animation Example) 1 according to the present technology.

FIG. 29 A diagram showing Display Control Example (Animation Example) 1 according to the present technology.

FIG. 30 A diagram showing Display Control Example (Animation Example) 1 according to the present technology.

FIG. 31 A diagram showing Display Control Example (Animation Example) 1 according to the present technology.

FIG. 32 A diagram showing Display Control Example (Animation Example) 1 according to the present technology.

FIG. 33 A diagram showing Display Control Example (Animation Example) 1 according to the present technology.

FIG. 34 A diagram showing Display Control Example (Animation Example) 1 according to the present technology.

FIG. 35 A diagram showing Display Control Example (Animation Example) 1 according to the present technology.

FIG. 36 A diagram showing Display Control Example (Animation Example) 1 according to the present technology.

FIG. 37 A diagram showing Display Control Example (Animation Example) 1 according to the present technology.

FIG. 38 A diagram showing Display Control Example (Animation Example) 1 according to the present technology.

FIG. 39 A diagram showing Display Control Example (Animation Example) 1 according to the present technology.

FIG. 40 A diagram showing Display Control Example (Animation Example) 1 according to the present technology.

FIG. 41 A diagram showing Display Control Example (Animation Example) 1 according to the present technology.

FIG. 42 A diagram showing Display Control Example (Animation Example) 1 according to the present technology.

FIG. 43 A diagram showing Display Control Example (Animation Example) 1 according to the present technology.

FIG. 44 A diagram showing Display Control Example (Animation Example) 1 according to the present technology.

FIG. 45 A diagram showing Display Control Example (Animation Example) 1 according to the present technology.

FIG. 46 A diagram showing Display Control Example (Animation Example) 1 according to the present technology.

FIG. 47 A diagram showing Display Control Example (Animation Example) 1 according to the present technology.

FIG. 48 A diagram showing Display Control Example (Animation Example) 2 according to the present technology.

FIG. 49 A diagram showing Display Control Example (Animation Example) 2 according to the present technology.

FIG. 50 A diagram showing Display Control Example (Animation Example) 2 according to the present technology.

FIG. 51 A diagram showing Display Control Example (Animation Example) 2 according to the present technology.

FIG. 52 A diagram showing Display Control Example (Animation Example) 2 according to the present technology.

FIG. 53 A diagram showing Display Control Example (Animation Example) 2 according to the present technology.

FIG. 54 A diagram showing Display Control Example (Animation Example) 2 according to the present technology.

FIG. 55 A diagram showing Display Control Example (Animation Example) 2 according to the present technology.

FIG. 56 A diagram showing Display Control Example (Animation Example) 2 according to the present technology.

FIG. 57 A diagram showing Display Control Example (Animation Example) 2 according to the present technology.

FIG. 58 A diagram showing Display Control Example (Animation Example) 2 according to the present technology.

FIG. 59 A diagram showing Display Control Example (Animation Example) 2 according to the present technology.

FIG. 60 A diagram showing Display Control Example (Animation Example) 2 according to the present technology.

FIG. 61 A diagram showing Display Control Example (Animation Example) 2 according to the present technology.

FIG. 62 A diagram showing Display Control Example (Animation Example) 2 according to the present technology.

FIG. 63 A diagram showing Display Control Example (Animation Example) 2 according to the present technology.

FIG. 64 A diagram showing Display Control Example (Animation Example) 2 according to the present technology.

FIG. 65 A diagram showing Display Control Example (Animation Example) 2 according to the present technology.

FIG. 66 A diagram showing Display Control Example (Animation Example) 2 according to the present technology.

FIG. 67 A diagram showing Display Control Example (Animation Example) 2 according to the present technology.

FIG. 68 A diagram showing Display Control Example (Animation Example) 2 according to the present technology.

FIG. 69 A diagram showing Display Control Example (Animation Example) 2 according to the present technology.

FIG. 70 A diagram showing Display Control Example (Animation Example) 2 according to the present technology.

FIG. 71 A diagram showing Display Control Example (Animation Example) 2 according to the present technology.

FIG. 72 A diagram showing Display Control Example (Animation Example) 2 according to the present technology.

FIG. 73 A diagram showing Display Control Example (Animation Example) 2 according to the present technology.

FIG. 74 A diagram showing Display Control Example (Animation Example) 2 according to the present technology.

FIG. 75 A diagram showing Display Control Example (Animation Example) 2 according to the present technology.

FIG. 76 A diagram showing Display Control Example (Animation Example) 2 according to the present technology.

FIG. 77 A diagram showing Display Control Example (Animation Example) 2 according to the present technology.

FIG. 78 A diagram showing Display Control Example (Animation Example) 2 according to the present technology.

FIG. 79 A diagram showing Display Control Example (Animation Example) 2 according to the present technology.

FIG. 80 A diagram showing Display Control Example (Animation Example) 2 according to the present technology.

FIG. 81 A diagram showing Display Control Example (Animation Example) 2 according to the present technology.

FIG. 82 A diagram showing Display Control Example (Animation Example) 2 according to the present technology.

FIG. 83 A diagram showing Display Control Example (Animation Example) 2 according to the present technology.

FIG. 84 A diagram showing Display Control Example (Animation Example) 3 according to the present technology.

FIG. 85 A diagram showing Display Control Example (Animation Example) 3 according to the present technology.

FIG. 86 A diagram showing Display Control Example (Animation Example) 3 according to the present technology.

FIG. 87 A diagram showing Display Control Example (Animation Example) 3 according to the present technology.

FIG. 88 A diagram showing Display Control Example (Animation Example) 3 according to the present technology.

FIG. 89 A diagram showing Display Control Example (Animation Example) 3 according to the present technology.

FIG. 90 A diagram showing Display Control Example (Animation Example) 3 according to the present technology.

FIG. 91 A diagram showing Display Control Example (Animation Example) 3 according to the present technology.

FIG. 92 A diagram showing Display Control Example (Animation Example) 3 according to the present technology.

FIG. 93 A diagram showing Display Control Example (Animation Example) 3 according to the present technology.

FIG. 94 A diagram showing Display Control Example (Animation Example) 3 according to the present technology.

FIG. 95 A diagram showing Display Control Example (Animation Example) 3 according to the present technology.

FIG. 96 A diagram showing Display Control Example (Animation Example) 3 according to the present technology.

FIG. 97 A diagram showing Display Control Example (Animation Example) 3 according to the present technology.

FIG. 98 A diagram showing Display Control Example (Animation Example) 3 according to the present technology.

FIG. 99 A diagram showing Display Control Example (Animation Example) 3 according to the present technology.

FIG. 100 A diagram showing Display Control Example (Animation Example) 3 according to the present technology.

FIG. 101 A diagram showing Display Control Example (Animation Example) 3 according to the present technology.

FIG. 102 A diagram showing Display Control Example (Animation Example) 3 according to the present technology.

FIG. 103 A diagram showing Display Control Example (Animation Example) 4 according to the present technology.

FIG. 104 A diagram showing Display Control Example (Animation Example) 4 according to the present technology.

FIG. 105 A diagram showing Display Control Example (Animation Example) 4 according to the present technology.

FIG. 106 A diagram showing Display Control Example (Animation Example) 4 according to the present technology.

FIG. 107 A diagram showing Display Control Example (Animation Example) 4 according to the present technology.

FIG. 108 A diagram showing Display Control Example (Animation Example) 4 according to the present technology.

FIG. 109 A diagram showing Display Control Example (Animation Example) 4 according to the present technology.

FIG. 110 A diagram showing Display Control Example (Animation Example) 4 according to the present technology.

FIG. 111 A diagram showing Display Control Example (Animation Example) 4 according to the present technology.

FIG. 112 A diagram showing Display Control Example (Animation Example) 4 according to the present technology.

FIG. 113 A diagram showing Display Control Example (Animation Example) 4 according to the present technology.

FIG. 114 A diagram showing Display Control Example (Animation Example) 4 according to the present technology.

FIG. 115 A diagram showing Display Control Example (Animation Example) 4 according to the present technology.

FIG. 116 A diagram showing Display Control Example (Animation Example) 4 according to the present technology.

FIG. 117 A diagram showing Display Control Example (Animation Example) 4 according to the present technology.

FIG. 118 A diagram showing Display Control Example (Animation Example) 4 according to the present technology.

FIG. 119 A diagram showing Display Control Example (Animation Example) 4 according to the present technology.

FIG. 120 A diagram showing Display Control Example (Animation Example) 4 according to the present technology.

FIG. 121 A diagram showing Display Control Example (Animation Example) 4 according to the present technology.

FIG. 122 A diagram showing Display Control Example (Animation Example) 4 according to the present technology.

FIG. 123 A diagram showing Display Control Example (Animation Example) 4 according to the present technology.

FIG. 124 A diagram showing Display Control Example (Animation Example) 4 according to the present technology.

FIG. 125 A diagram showing Display Control Example (Animation Example) 4 according to the present technology.

FIG. 126 A diagram showing Display Control Example (Animation Example) 4 according to the present technology.

FIG. 127 A diagram showing Display Control Example (Animation Example) 4 according to the present technology.

FIG. 128 A diagram showing Display Control Example (Animation Example) 4 according to the present technology.

FIG. 129 A diagram showing Display Control Example (Animation Example) 4 according to the present technology.

FIG. 130 A diagram showing Display Control Example (Animation Example) 4 according to the present technology.

FIG. 131 A diagram showing Display Control Example (Animation Example) 5 according to the present technology.

FIG. 132 A diagram showing Display Control Example (Animation Example) 5 according to the present technology.

FIG. 133 A diagram showing Display Control Example (Animation Example) 5 according to the present technology.

FIG. 134 A diagram showing Display Control Example (Animation Example) 5 according to the present technology.

FIG. 135 A diagram showing Display Control Example (Animation Example) 5 according to the present technology.

FIG. 136 A diagram showing Display Control Example (Animation Example) 5 according to the present technology.

FIG. 137 A diagram showing Display Control Example (Animation Example) 5 according to the present technology.

FIG. 138 A diagram showing Display Control Example (Animation Example) 6 according to the present technology.

FIG. 139 A diagram showing Display Control Example (Animation Example) 6 according to the present technology.

FIG. 140 A diagram showing Display Control Example (Animation Example) 6 according to the present technology.

FIG. 141 A diagram showing Display Control Example (Animation Example) 6 according to the present technology.

FIG. 142 A diagram showing Display Control Example (Animation Example) 6 according to the present technology.

FIG. 143 A diagram showing Display Control Example (Animation Example) 6 according to the present technology.

FIG. 144 A diagram showing Display Control Example (Animation Example) 6 according to the present technology.

FIG. 145 A diagram showing Display Control Example (Animation Example) 7 according to the present technology.

FIG. 146 A diagram showing Display Control Example (Animation Example) 7 according to the present technology.

FIG. 147 A diagram showing Display Control Example (Animation Example) 7 according to the present technology.

FIG. 148 A diagram showing Display Control Example (Animation Example) 7 according to the present technology.

FIG. 149 A diagram showing Display Control Example (Animation Example) 7 according to the present technology.

FIG. 150 A diagram showing Display Control Example (Animation Example) 7 according to the present technology.

FIG. 151 A diagram showing Display Control Example (Animation Example) 7 according to the present technology.

FIG. 152 A diagram showing Display Control Example (Animation Example) 8 according to the present technology.

FIG. 153 A diagram showing Display Control Example (Animation Example) 8 according to the present technology.

FIG. 154 A diagram showing Display Control Example (Animation Example) 8 according to the present technology.

FIG. 155 A diagram showing Display Control Example (Animation Example) 8 according to the present technology.

FIG. 156 A diagram showing Display Control Example (Animation Example) 8 according to the present technology.

FIG. 157 A diagram showing Display Control Example (Animation Example) 8 according to the present technology.

FIG. 158 A diagram showing Display Control Example (Animation Example) 8 according to the present technology.

FIG. 159 A diagram showing Display Control Example (Animation Example) 9 according to the present technology.

FIG. 160 A diagram showing Display Control Example (Animation Example) 9 according to the present technology.

FIG. 161 A diagram showing Display Control Example (Animation Example) 9 according to the present technology.

FIG. 162 A diagram showing Display Control Example (Animation Example) 9 according to the present technology.

FIG. 163 A diagram showing Display Control Example (Animation Example) 9 according to the present technology.

FIG. 164 A diagram showing Display Control Example (Animation Example) 9 according to the present technology.

FIG. 165 A diagram showing Display Control Example (Animation Example) 9 according to the present technology.

FIG. 166 A diagram showing Display Control Example (Animation Example) 10 according to the present technology.

FIG. 167 A diagram showing Display Control Example (Animation Example) 10 according to the present technology.

FIG. 168 A diagram showing Display Control Example (Animation Example) 10 according to the present technology.

FIG. 169 A diagram showing Display Control Example (Animation Example) 10 according to the present technology.

FIG. 170 A diagram showing Display Control Example (Animation Example) 10 according to the present technology.

FIG. 171 A diagram showing Display Control Example (Animation Example) 10 according to the present technology.

FIG. 172 A diagram showing Display Control Example (Animation Example) 10 according to the present technology.

FIG. 173 A diagram showing Display Control Example (Animation Example) 10 according to the present technology.

FIG. 174 A diagram showing Display Control Example (Animation Example) 10 according to the present technology.

FIG. 175 A diagram showing Display Control Example (Animation Example) 10 according to the present technology.

FIG. 176 A diagram showing Display Control Example (Animation Example) 10 according to the present technology.

FIG. 177 A diagram showing Display Control Example (Animation Example) 10 according to the present technology.

FIG. 178 A diagram showing Display Control Example (Animation Example) 10 according to the present technology.

FIG. 179 A diagram showing Display Control Example (Animation Example) 10 according to the present technology.

FIG. 180 A diagram showing Display Control Example (Animation Example) 10 according to the present technology.

FIG. 181 A diagram showing Display Control Example (Animation Example) 10 according to the present technology.

FIG. 182 A diagram showing Display Control Example (Animation Example) 11 according to the present technology.

FIG. 183 A diagram showing Display Control Example (Animation Example) 11 according to the present technology.

FIG. 184 A diagram showing Display Control Example (Animation Example) 11 according to the present technology.

FIG. 185 A diagram showing Display Control Example (Animation Example) 11 according to the present technology.

FIG. 186 A diagram showing Display Control Example (Animation Example) 11 according to the present technology.

FIG. 187 A diagram showing Display Control Example (Animation Example) 11 according to the present technology.

FIG. 188 A diagram showing Display Control Example (Animation Example) 11 according to the present technology.

FIG. 189 A diagram showing Display Control Example (Animation Example) 11 according to the present technology.

FIG. 190 A diagram showing Display Control Example (Animation Example) 11 according to the present technology.

FIG. 191 A diagram showing Display Control Example (Animation Example) 11 according to the present technology.

FIG. 192 A diagram showing Display Control Example (Animation Example) 11 according to the present technology.

FIG. 193 A diagram showing Display Control Example (Animation Example) 12 according to the present technology.

FIG. 194 A diagram showing Display Control Example (Animation Example) 12 according to the present technology.

FIG. 195 A diagram showing Display Control Example (Animation Example) 12 according to the present technology.

FIG. 196 A diagram showing Display Control Example (Animation Example) 12 according to the present technology.

FIG. 197 A diagram showing Display Control Example (Animation Example) 12 according to the present technology.

FIG. 198 A diagram showing Display Control Example (Animation Example) 12 according to the present technology.

FIG. 199 A diagram showing Display Control Example (Animation Example) 12 according to the present technology.

FIG. 200 A diagram showing Display Control Example (Animation Example) 12 according to the present technology.

FIG. 201 A diagram showing Display Control Example (Animation Example) 12 according to the present technology.

FIG. 202 A diagram showing Display Control Example (Animation Example) 13 according to the present technology.

FIG. 203 A diagram showing Display Control Example (Animation Example) 13 according to the present technology.

FIG. 204 A diagram showing Display Control Example (Animation Example) 13 according to the present technology.

FIG. 205 A diagram showing Display Control Example (Animation Example) 13 according to the present technology.

FIG. 206 A diagram showing Display Control Example (Animation Example) 13 according to the present technology.

FIG. 207 A diagram showing Display Control Example (Animation Example) 13 according to the present technology.

FIG. 208 A diagram showing Display Control Example (Animation Example) 13 according to the present technology.

FIG. 209 A diagram showing Display Control Example (Animation Example) 13 according to the present technology.

FIG. 210 A diagram showing Display Control Example (Animation Example) 13 according to the present technology.

FIG. 211 A diagram showing Display Control Example (Animation Example) 14 according to the present technology.

FIG. 212 A diagram showing Display Control Example (Animation Example) 14 according to the present technology.

FIG. 213 A diagram showing Display Control Example (Animation Example) 14 according to the present technology.

FIG. 214 A diagram showing Display Control Example (Animation Example) 14 according to the present technology.

FIG. 215 A diagram showing Display Control Example (Animation Example) 14 according to the present technology.

FIG. 216 A diagram showing Display Control Example (Animation Example) 14 according to the present technology.

FIG. 217 A diagram showing Display Control Example (Animation Example) 14 according to the present technology.

FIG. 218 A diagram showing Display Control Example (Animation Example) 14 according to the present technology.

FIG. 219 A diagram showing Display Control Example (Animation Example) 14 according to the present technology.

FIG. 220 A diagram showing Display Control Example (Animation Example) 14 according to the present technology.

FIG. 221 A diagram showing Display Control Example (Animation Example) 14 according to the present technology.

FIG. 222 A diagram showing Display Control Example (Animation Example) 14 according to the present technology.

FIG. 223 A diagram showing Display Control Example (Animation Example) 14 according to the present technology.

FIG. 224 A diagram showing Display Control Example (Animation Example) 15 according to the present technology.

FIG. 225 A diagram showing Display Control Example (Animation Example) 15 according to the present technology.

FIG. 226 A diagram showing Display Control Example (Animation Example) 15 according to the present technology.

FIG. 227 A diagram showing Display Control Example (Animation Example) 15 according to the present technology.

FIG. 228 A diagram showing Display Control Example (Animation Example) 15 according to the present technology.

FIG. 229 A diagram showing Display Control Example (Animation Example) 15 according to the present technology.

FIG. 230 A diagram showing Display Control Example (Animation Example) 15 according to the present technology.

FIG. 231 A diagram showing Display Control Example (Animation Example) 15 according to the present technology.

FIG. 232 A diagram showing Display Control Example (Animation Example) 15 according to the present technology.

FIG. 233 A diagram showing Display Control Example (Animation Example) 16 according to the present technology.

FIG. 234 A diagram showing Display Control Example (Animation Example) 16 according to the present technology.

FIG. 235 A diagram showing Display Control Example (Animation Example) 16 according to the present technology.

FIG. 236 A diagram showing Display Control Example (Animation Example) 16 according to the present technology.

FIG. 237 A diagram showing Display Control Example (Animation Example) 16 according to the present technology.

FIG. 238 A diagram showing Display Control Example (Animation Example) 16 according to the present technology.

FIG. 239 A diagram showing Display Control Example (Animation Example) 17 according to the present technology.

FIG. 240 A diagram showing Display Control Example (Animation Example) 17 according to the present technology.

FIG. 241 A diagram showing Display Control Example (Animation Example) 17 according to the present technology.

FIG. 242 A diagram showing Display Control Example (Animation Example) 17 according to the present technology.

FIG. 243 A diagram showing Display Control Example (Animation Example) 17 according to the present technology.

FIG. 244 A diagram showing Display Control Example (Animation Example) 17 according to the present technology.

FIG. 245 A diagram showing Display Control Example (Animation Example) 17 according to the present technology.

FIG. 246 A diagram showing Display Control Example (Animation Example) 17 according to the present technology.

FIG. 247 A diagram showing Display Control Example (Animation Example) 17 according to the present technology.

FIG. 248 A diagram showing Display Control Example (Animation Example) 17 according to the present technology.

FIG. 249 A diagram showing Display Control Example (Animation Example) 17 according to the present technology.

FIG. 250 A diagram showing Display Control Example (Animation Example) 17 according to the present technology.

FIG. 251 A diagram showing Display Control Example (Animation Example) 17 according to the present technology.

FIG. 252 A diagram showing Display Control Example (Animation Example) 17 according to the present technology.

FIG. 253 A diagram showing Display Control Example (Animation Example) 17 according to the present technology.

FIG. 254 A diagram showing Display Control Example (Animation Example) 17 according to the present technology.

FIG. 255 A diagram showing Display Control Example (Animation Example) 17 according to the present technology.

FIG. 256 A diagram showing Display Control Example (Animation Example) 17 according to the present technology.

FIG. 257 A diagram showing Display Control Example (Animation Example) 17 according to the present technology.

FIG. 258 A diagram showing Display Control Example (Animation Example) 18 according to the present technology.

FIG. 259 A diagram showing Display Control Example (Animation Example) 38 according to the present technology.

FIG. 260 A diagram showing Display Control Example (Animation Example) 18 according to the present technology.

FIG. 261 A diagram showing Display Control Example (Animation Example) 18 according to the present technology.

FIG. 262 A diagram showing Display Control Example (Animation Example) 18 according to the present technology.

FIG. 263 A diagram showing Display Control Example (Animation Example) 18 according to the present technology.

FIG. 264 A diagram showing Display Control Example (Animation Example) 18 according to the present technology.

FIG. 265 A diagram showing Display Control Example (Animation Example) 18 according to the present technology.

FIG. 266 A diagram showing Display Control Example (Animation Example) 18 according to the present technology.

FIG. 267 A diagram showing Display Control Example (Animation Example) 18 according to the present technology.

FIG. 268 A diagram showing Display Control Example (Animation Example) 19 according to the present technology.

FIG. 269 A diagram showing Display Control Example (Animation Example) 19 according to the present technology.

FIG. 270 A diagram showing Display Control Example (Animation Example) 19 according to the present technology.

FIG. 271 A diagram showing Display Control Example (Animation Example) 19 according to the present technology.

FIG. 272 A diagram showing Display Control Example (Animation Example) 19 according to the present technology.

FIG. 273 A diagram showing Display Control Example (Animation Example) 19 according to the present technology.

FIG. 274 A diagram showing Display Control Example (Animation Example) 19 according to the present technology.

FIG. 275 A diagram showing Display Control Example (Animation Example) 20 according to the present technology.

FIG. 276 A diagram showing Display Control Example (Animation Example) 20 according to the present technology.

FIG. 277 A diagram showing Display Control Example (Animation Example) 20 according to the present technology.

FIG. 278 A diagram showing Display Control Example (Animation Example) 20 according to the present technology.

FIG. 279 A diagram showing Display Control Example (Animation Example) 20 according to the present technology.

FIG. 280 A diagram showing Display Control Example (Animation Example) 21 according to the present technology.

FIG. 281 A diagram showing Display Control Example (Animation Example) 21 according to the present technology.

FIG. 282 A diagram showing Display Control Example (Animation Example) 21 according to the present technology.

FIG. 283 A diagram showing Display Control Example (Animation Example) 21 according to the present technology.

FIG. 284 A diagram showing Display Control Example (Animation Example) 21 according to the present technology.

FIG. 285 A diagram showing Display Control Example (Animation Example) 21 according to the present technology.

FIG. 286 A diagram showing Display Control Example (Animation Example) 21 according to the present technology.

### MODE(S) FOR CARRYING OUT THE INVENTION

Hereinafter, embodiments of the present technology will be shown and described with reference to the drawings.

The descriptions will be made in the following order.

Configuration of Display Control Apparatus

Description of Information to be Displayed

Description of Trigger

Description of Flow of Display Control According to Trigger

Specific Examples (Animation Examples) of Display Control

<Display Control Apparatus>

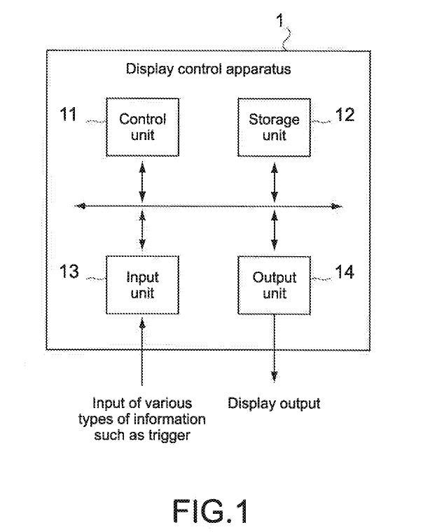

FIG. 1 shows a configuration of a display control apparatus 1 according to this embodiment. As shown in the figure, the display control apparatus 1 includes a control unit 11, a storage unit 12, an input unit 13, and an output unit 14 like general display control apparatuses. These respective units are connected to one another, using an internal bus as a center.

Specific implementations of the display control apparatus 1 have no limitations. For example, the present technology can be applied to a smartphone, a head-mounted display (display output device thereof can be of any type such as optical see-through type and immersive type), a smart watch, an interactive projector, a hologram display, a spatial projection display, and the like as the specific implementations of the display control apparatus 1.

Although specific implementations of the control unit 11 have no limitations, the control unit 11 can be implemented as, for example, a central processing unit. The storage unit 12 can be implemented as a configuration combining a volatile memory and a nonvolatile memory.

The input unit 13 receives input of information into the display control apparatus 1 and inputs the received information into the control unit 11. The input unit 13 can be implemented as, for example, a configuration including a network device, a human interface device (user interface device), and the like. There can also be a microphone (voice input apparatus) as an example of an embodiment of the input unit 13. In some cases, information input into the display control apparatus 1 by the input unit 13 is used as a trigger for GUI control of the control unit 11.

The output unit 14 outputs information from the display control, apparatus 1 to an outside. In particular, the output unit 14 performs display output in this embodiment. Although specific implementations of the output unit 14 have no limitations, a type that displays images through light emission from a display surface may be employed or a type that projects images on a display surface may be employed, for example, Otherwise, a display output device may also be employed, which is configured such that an image having a curve surface to which a deformation has been added is displayed or projected and a user who views the curve surface can recognize it as if an image before the deformation has been added came up to a space in front of the curve surface. It is conventionally known that the display output device of this type can be employed in a spatial projection display and the like.

When detecting input or generation of a trigger, the display control apparatus 1 according to this embodiment displays a characteristic GUI through the output unit 14 or deforms an already displayed GUI. Here, like general GUIs, GUIs according to this embodiment function as containers for displaying information of which the user should be informed.

<Description of Information to be Displayed>

Examples of the type of information displayed by the output unit 14 (hereinafter, referred to as “display information”) can be as follows.

Time

Weather

Position of the display control apparatus 1

Notification or caution to the user (hereinafter, referred to as “notification matter to user”)

GUIs (remote controller and player) for device control that controls device information of the display control apparatus 1, the display control apparatus 1, and an external apparatus (not shown)

Content (e.g., news, recipes, and photographs)

Living-body information (e.g., amount of exercise and heart rate of user)

The control unit 11 changes a mode (e.g., shape and animation) of a displayed GUI in a manner that depends on the type of the display information” above.

<Description of Trigger>

Those recognized by the control unit 11 as triggers for GUI control are roughly classified into “manual triggers” and “automatic triggers”. The control unit 11 considers a user's action as input or generation of a “manual trigger”, for example.

If the input unit 13 is a touch panel for example, one of examples of the user's action can be a user's action of tapping the input unit 13.

Otherwise, if the input unit 13 includes a proximity sensor for example, one of the examples of the user's action can be a user's action of approaching the input unit 13. In this case, if the proximity sensor is placed near the output unit 14, a trigger can be generated when a person approaches a display target object.

Otherwise, if the input unit 13 includes a camera for example, one of the examples of the user's action can also be an action that an image of the face of the user is taken by an camera and the user is recognized on the basis of the taken image using a facial recognition technique.

Otherwise, if the input unit 13 includes a microphone for example, one of the examples of the user's action can be voice input through the microphone.

One of examples of an “automatic trigger” recognized by the control unit 11 can be an input of a surrounding environment (sound, temperature, illuminance, etc). In this case, the input unit 13 includes sensors for voice input, temperature detection, and illuminance detection. Another one of the examples of the automatic trigger can be a context in which the display control apparatus 1 is placed.

### <Flow of Display Control According to Trigger>

### <Display Control Pattern 1>

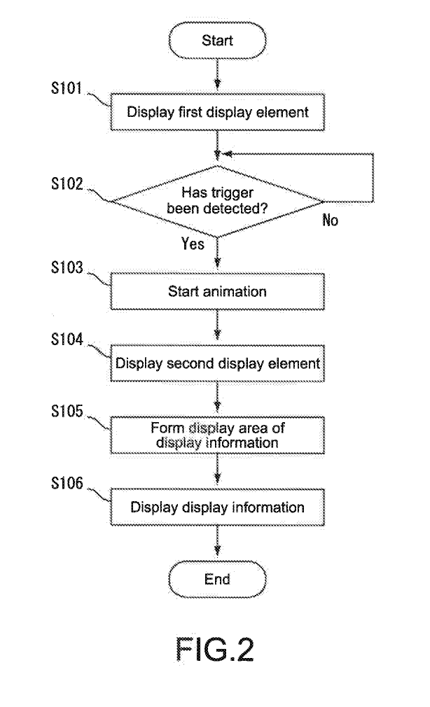

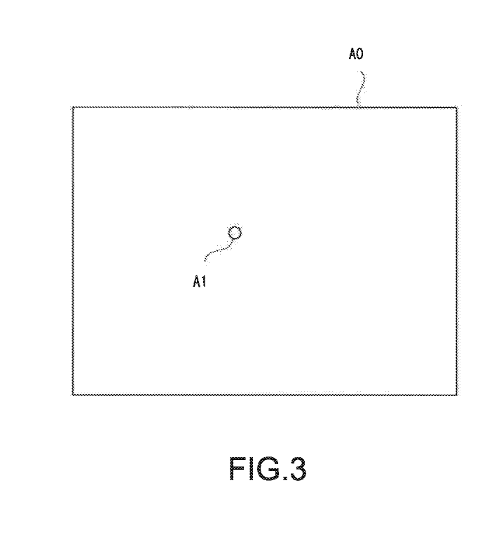

Next, a flow of display control according to a trigger will be described with reference to FIGS. 2 to 7. FIG. 2 is a flowchart showing a flow of operations. FIGS. 3 to 7 are display screen examples output from the output unit 14.

As shown in display screens shown in FIGS. 3 to 7, the control unit 11 controls the output unit 14 to display a first display element A1 having a dot shape and a second display element A2 having a line shape. In addition, the control unit 11 moves the first display element A1 and the second display element A2 on a display surface. The flow of operations will be described with reference to FIG. 2.

First of all, as shown in FIG. 3, the control unit 11 displays a first display element A1 having a dot shape on a display surface A0 (S101). At this time, the display color of the first display element is set to a first color whose contrast is higher than that of the display surface.

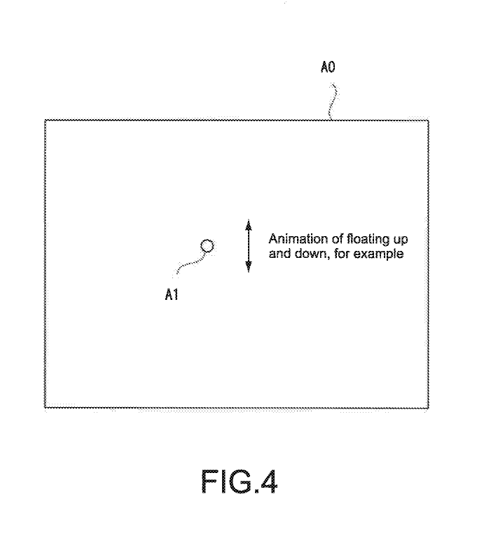

The control unit 11 stands by until a trigger is input or generated (S102). As shown in FIG. 4, the control unit 11 performs an animation of floating the first display element A1 up and down or to the left and right, for example, for that period.

When detecting a trigger, the control unit 11 moves the displayed first display element A1 and starts an animation (S103). At this time, the control unit 11 may display an animation in which the first display element is enlarged and reduced in size.

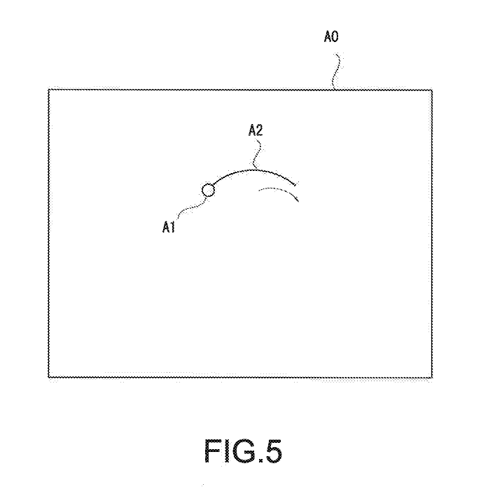

Subsequently, as shown in FIG. 5, the control unit 11 displays, on the display surface, one or a plurality of second display elements expressed by a line shape having the same first color as the display color of the first display element (S104).

Subsequently, the control unit 11 moves or deforms at least either one of the first display element and the second display element. In this example, deformation in which the length of the second display element A2 having the line shape is extended is performed. In this example, with this deformation, an animation in which the second display element A2 is pulled out of the first display element A1 is obtained. Note that, when displaying this second display element A2, the control unit 11 performs display such that the width determining the line shape thereof is smaller than the radius determining the dot shape of the first display element A1. With this, the animation in which the second display element A2 is pulled out of the first display element A1 becomes reasonable.

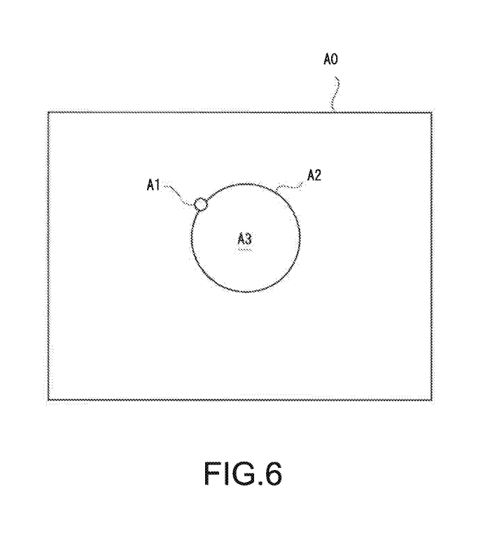

In addition, in this control example, the control unit 11 moves and deforms the second display element having the line shape to thereby draw an endless figure. This endless figure is a display area A3 of the display information. That is, the control unit 11 forms the display area A3 of the display information (S105). FIG. 6 shows a display screen example in which the display area A3 is formed.

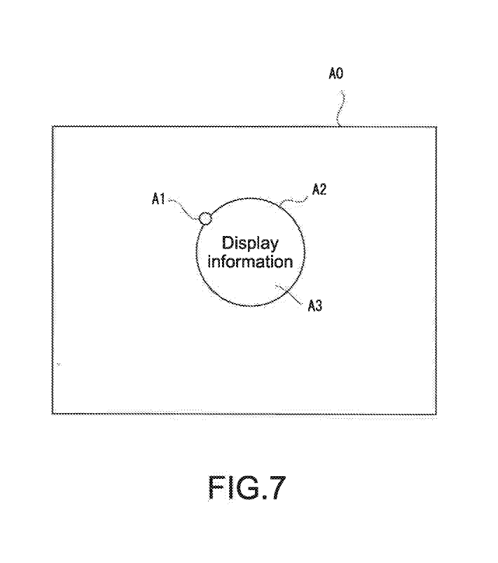

Subsequently, as shown in FIG. 7, the control unit 11 displays “display information” including a notification matter to the user and the like within this endless figure (S106).

By the control unit 11 performing the above-mentioned display control, the output unit 14 can receive the input or generation of various triggers such as a manual trigger and an automatic trigger and display a characteristic GUI and display display information of which the display control apparatus 1 should inform the user within that GUI.

Note that, when the display disappears, the GUI is controlled to transition in an order opposite to the order shown in the figures.

Effects given by the GUI provided by the display control apparatus 1 according to this embodiment described above will be described.

Drawing the GUI with a thin line does not obstruct the background and the field of view. Therefore, it is suitable for drawing on a transmissive-type display surface such as a smart glass and a window glass. Regarding the display method of the output unit 14 of the display control apparatus 1, a display method for a wearable device and a transmissive-type display surface also fall within a scope thereof as described above in the description on the configuration of the “display control apparatus”.

On the other hand, in terms of the visibility, a thin line may be inferior to a typical drawing style (painting a surface). Further, there is a high risk that those constantly displayed on the screen, such as an indicator, may be hidden in the background and it is more unnoticeable to the user than an indicator (e.g., icon on status bar) on a conventional screen (e.g., smartphone).

In Display Control Pattern 1 above, the control unit 11 deforms the second display element A2 having a thin line shape with the animation. With this, first of all, it is a movement that is impossible in reality, and hence it can be well separated from the background and it becomes easier for the user to know where the GUI is. Second of all, it is possible to catch the user's eyes due to its transition from the still state to the dynamic state.

<Display Control Pattern 2>

Next, another display control pattern by the control unit 11 will be described. In this example, a plurality of triggers are input into the display control apparatus 1. One of the triggers is voice input. A control flow of the control unit 11 is basically the same as the flow shown in Display Control Pattern 1 and FIG. 2. They are different in that the control unit 11 performs control to move or deform at least either one of the first display element A1 and the second display element A2 when a further trigger is detected after a trigger (S102) is detected and the second display element A2 is displayed (S104).

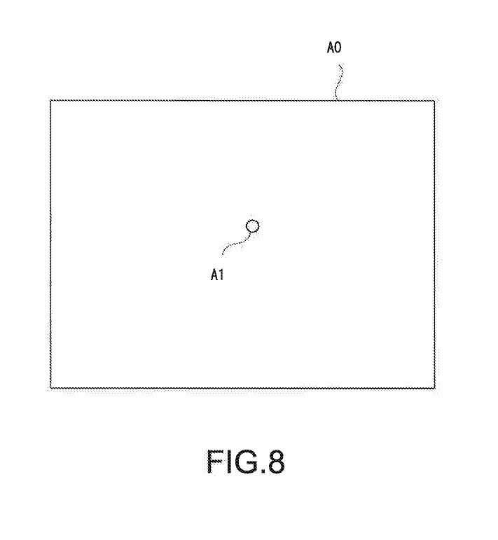

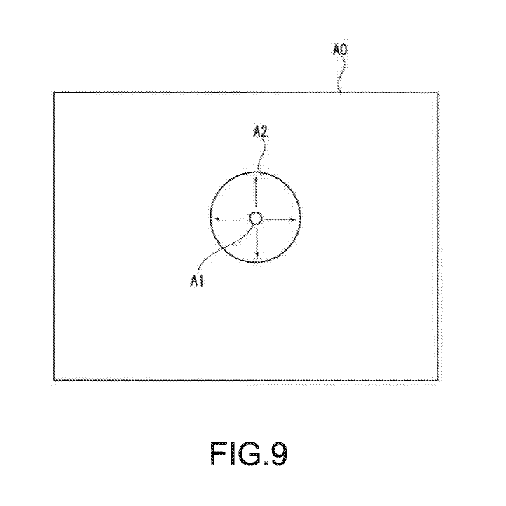

FIGS. 8 to 13 show screen transitions according to this control example. As shown in FIG. 8, the control unit 11 first displays, on the display surface A0, the first display element A1 having a dot shape. Subsequently, as shown in FIG. 9, when detecting input of a first trigger (e.g., signal indicating the fact that the user has instructed to start the voice input), the control unit 11 displays a second display element A2. In this control example, display is performed with an animation in which the second display element A2 concentrically spreads from the first display element A1. At this time, the second display element A2 output such that it is pulled out of the first display element A1 is an endless figure from the beginning.

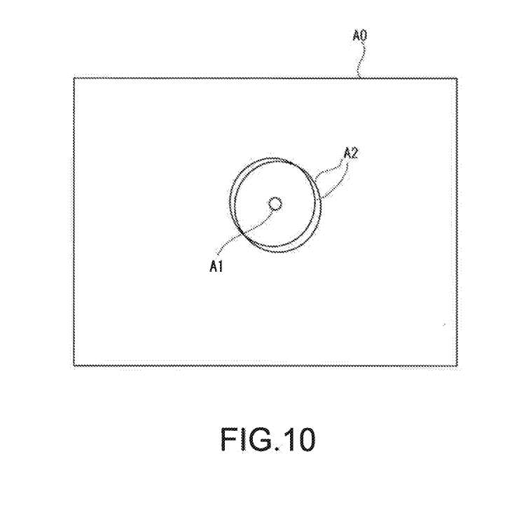

In this control example, as shown in FIG. 10, the control unit 11 displays the second display element A2 while a plurality of second display elements described above are partially superimposed on each other. In addition, when receiving voice input that is a second trigger in this state of FIG. 10, the control unit 11 continuously deforms the plurality of superimposed second display elements A2 over time during reception of that voice input.

FIG. 11 shows an example in which the control unit 11 continuously deforms the plurality of second display elements A2. If the control unit 11 displays two second display element A2, an animation in which one of the second display elements A2 is rotated clockwise and the other of the second display elements A2 is rotated counterclockwise may be made.

As shown in FIGS. 10 and 11, the control unit 11 may display the plurality of second display elements A2 while the plurality of second display elements A2 are partially superimposed on each other. Further, as shown in FIGS. 10 and 11, the control unit 11 may display each of the plurality of second display elements A2 to have a closed curve or polygonal shape.

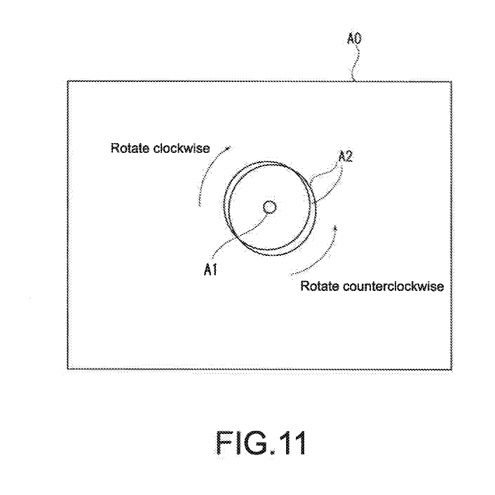

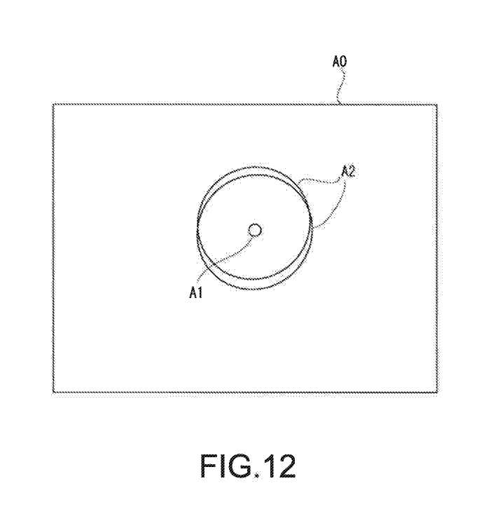

In this control example, when a third trigger, or the end of the voice input, is generated, the control unit 11 determines the end of voice recognition and temporarily enlarges each of the second display elements A2. FIG. 12 shows a screen example including the second display elements A2 temporarily enlarged when the voice recognition ends.

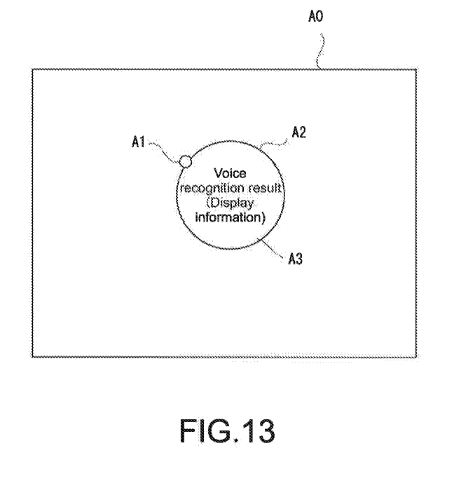

Subsequently, the control unit 11 deforms and moves the first display element A1 and the second display elements A2 and displays the display area A3. FIG. 13 shows a screen example including a display area A3 in this control example. The control unit 11 deforms the second display elements A2 such that the second display elements A2 having a line shape is unified and arranges the first display element A1 on the second display element A2. In this manner, the control unit 11 continuously deforms the plurality of superimposed second display elements over time as a response to input from the user.

As shown in FIG. 13, with an area surrounded with the second display element A2 being the display area A3, the control unit 11 displays display information in the display area A3. With this control example, a result of recognizing sound input by voice input is displayed as the display information.

As described above, in this control example, the control unit 11 inputs voice as the input from the user and continuously deforms the plurality of superimposed second display elements A2 over time while the voice input is being done, as a response of the voice input (FIG. 11).

Therefore, in this control example, a plurality of lines (second display elements A2) having a closed curve or polygonal shape are displayed in accordance with the voice input of the user and an animation in which they continuously move while they are partially superimposed on each other is obtained.

Effects given by the GUI provided by the display control apparatus 1 according to this embodiment described above will be described.

In Display Control Pattern 2 above, the control unit 11 deforms and rotates the plurality of thin lines (plurality of second display elements A2) with the animation. That is, the control unit 11 does not simply make the second display element A2 thick but moves the plurality of thin, superimposed second display elements A2 at the same time. With this, due to a synergistic effect with the configuration of Display Control Pattern 1, an effect of making the GUI prominent as well as the effect of Display Control Pattern 1 are obtained.

<Display Control Pattern 3>

In Display Control Pattern 2, the voice input has been shown as an application example of the control to move at least one of the first display element A1 and the second display element A2 when the further trigger is detected after the trigger is detected (S102) and the second display element A2 is displayed (S104). In contrast, in this display control pattern, calling user's attention is shown as another application example.

In Display Control Pattern 1 or 2, the control unit 11 displays the second display element A2 such that the shape of the display area A3 of the display information is the circular shape. However, the shape of the display area A3 is not limited to the circular shape. In this display control pattern, the control unit 11 determines the shape of the display area A3 of the endless figure in a manner that depends on a degree of necessity for calling user's attention which is associated with a notification matter.

The control unit 11 basically performs display control through the flow of FIG. 2 as in the operations of Display Control Pattern 1. They are different in that, in S105 (formation of display area of display information), the first display element A1 and the second display element A2 are continuously deformed over time such that the shape of the display area A3 is a shape depending on the degree of necessity for calling user's attention which is associated with the notification matter.

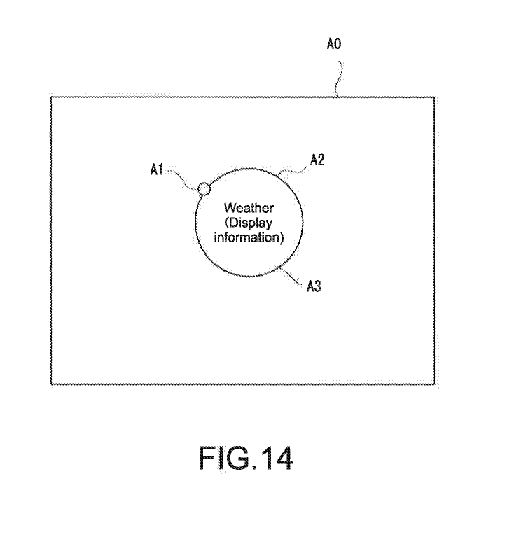

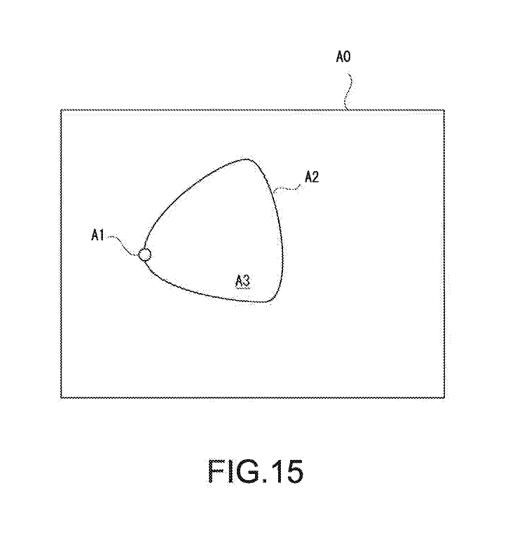

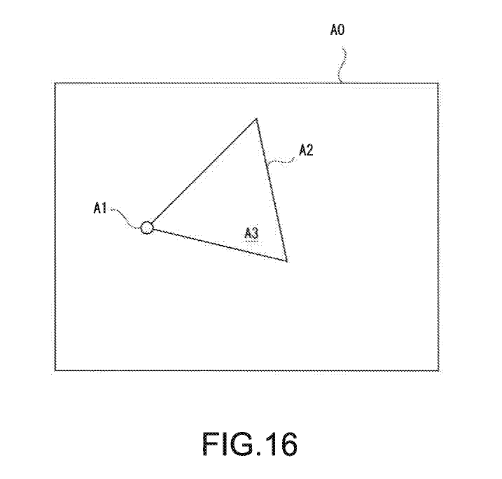

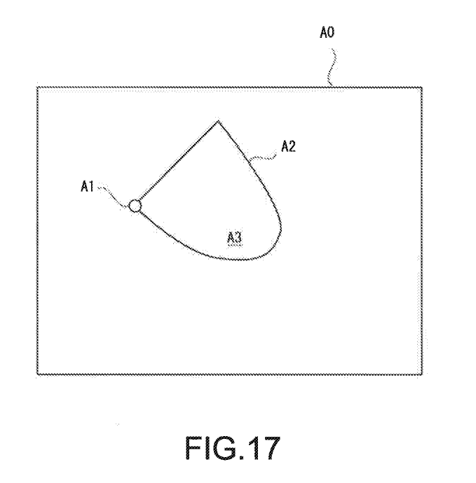

FIGS. 14 to 20 show screen examples. In FIG. 14, weather is shown in a display area A3 having a circular shape as an example of the display information. When a trigger such as input of a notification matter is generated or input there, the control unit 11 deforms a second display element A2 from a circular shape (FIG. 15, FIG. 16). The control unit 11 may change the position of a first display element A1 having a dot shape. In FIG. 16, the control unit 11 moves the first display element A1 to the position of a vertex of a triangle.

As shown in deformation of FIGS. 14 to 16, the control unit 11 may perform deformation such that the shape of the display area A3 drawn by the second display element A2 is an equilateral triangle. In the case of the triangular shape, it may be set to indicate that the priority of a notification matter associated with the display information is high, that is, the degree of necessity for calling user's attention is high.

In addition, the control unit 11 may determine the shape of the display area A3 in a manner that depends on the (small or large) amount of information of the display information. If the amount of information is large, it is set to a rectangle. For deforming the shape from the triangle to the rectangle, the control unit 11 performs deformation as shown in FIGS. 16, 17, and 18.

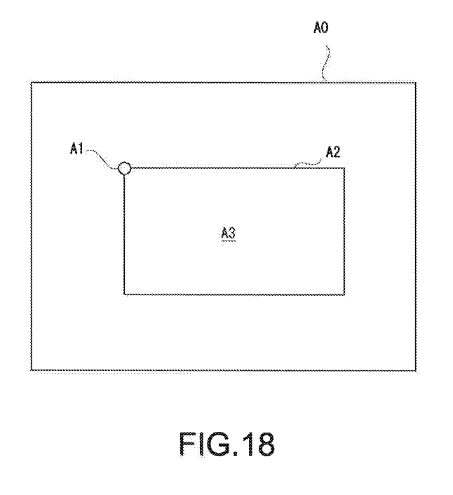

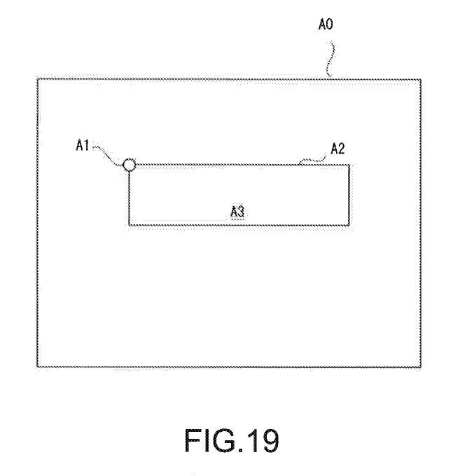

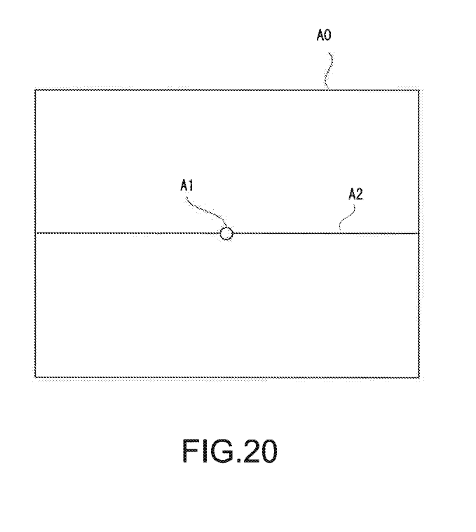

If there is no longer any display information and the display area A3 does not need to be displayed, the control unit 11 performs deformation as shown in FIGS. 18, 19, and 20. That is, the control unit 11 performs deformation such that the area of the rectangle formed by the second display element A2 becomes smaller (FIG. 19) and only a line remains (FIG. 20). The control unit 11 may perform an animation in which the line is further deformed to be shorter and integrated into the first display element A1.

As an effect given by the GUI according to this display control pattern described above, the user can grasp the priority or urgency of a notification matter only with the shape. In particular, in a transmissive-type display method, in a case of displaying information, for example, a caution by which the user's eyes should be especially caught, it is highly effective for the application of this display control pattern in comparison with a method of simply displaying it. It is because the user's eyes can be caught with interruption of the field of view and the background being kept at a minimum.

<Display Control Pattern 4>

In Display Control Pattern 3, also if there is information displayed to the user from normal display information to display information for calling attention, the control unit 11 changes only the shape without changing the width of the second display element A2. In contrast, in this display control pattern, the shape of the second display element A2 is changed and the width is also changed in a manner that depends on the degree of necessity for calling attention.

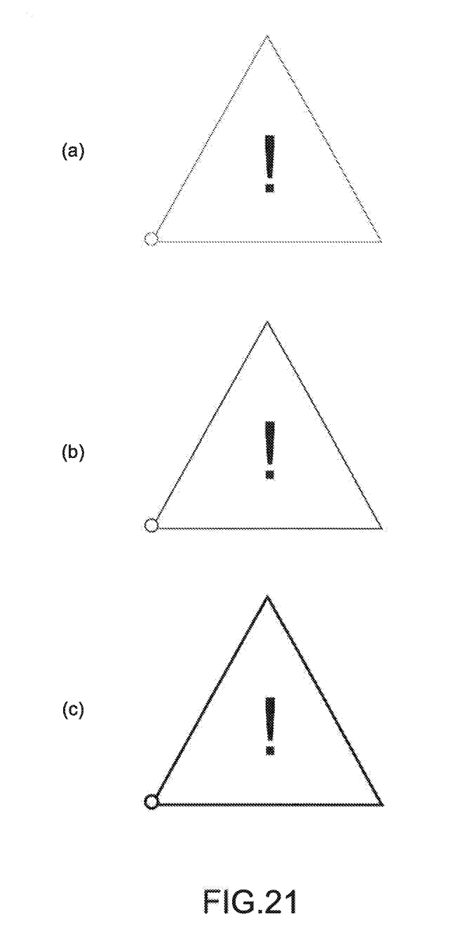

FIG. 21 shows screen examples of the second display element A2 whose width has been changed by the control unit 11. The control unit 11 changes the width to be thin if the degree of necessity for calling attention is low as shown in (a) of FIG. 21 or to be thick if the degree of necessity for calling attention is high as shown in (c) of FIG. 21. In accordance with this Display Control Pattern 4, the easiness to make it prominent can be finely adjusted by changing the width of the line by program control.

The visibility and visual attractiveness of the GUI is easily controlled only by the control unit 11 changing items which can be controlled through a program, such as the width, speed, and elasticity of the line in this manner. For example, by the control unit 11 moving the first display element A1 and the second display element A2 in a thick, dense state with a wide movement, they can be made more prominent in comparison with a normal animation.

As an effect given by the GUI according to this display control pattern, it becomes possible to finely control a degree of necessity of information in comparison with a conventional drawing method in which a plurality of variations of the color and the shape should be prepared.

<Specific Examples of Display Control>

Hereinafter, specific examples of the display control of the present technology will be described with reference to the drawings.

<Display Control Example 1>

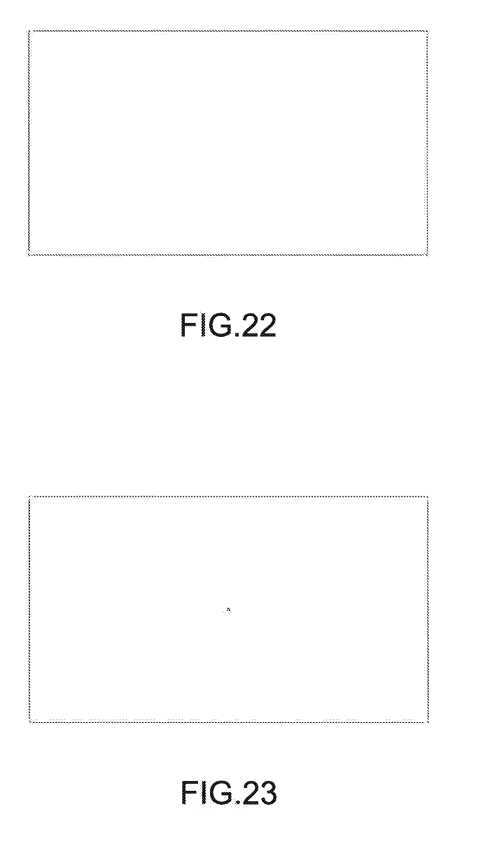

The display control apparatus 1 displays an animation that changes in the order from FIGS. 22 to 47. This animation is an example of the display control combining Display Control Pattern 1, Display Control Pattern 2, and Display Control Pattern 4 above. Hereinafter, the animation will be described.

First of all, on a screen in an initial state (FIG. 22), a dot (first display element) is faded in and displayed (FIG. 23).

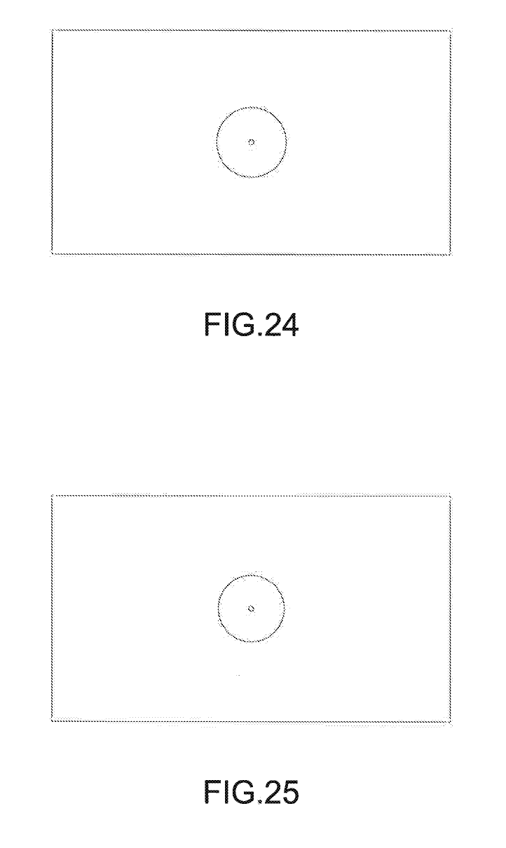

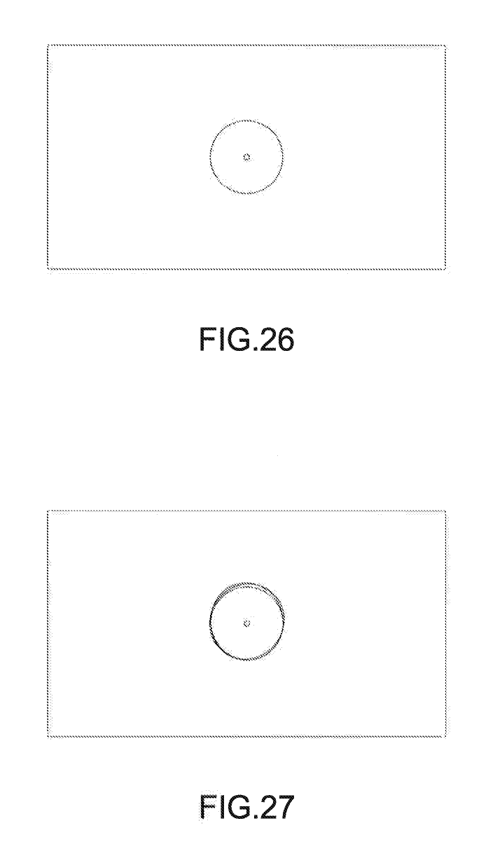

Next, a line (second display element) radially spreads from the dot (FIG. 24) and reduction in size (FIG. 25) and enlargement (FIG. 26) are repeated. The animation of FIGS. 24 to 26 is an animation showing waiting for a trigger.

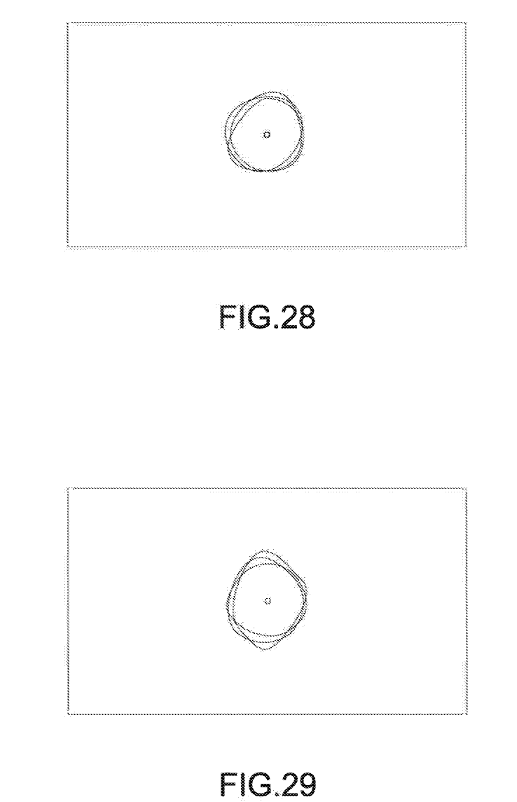

Next, when a trigger (e.g., voice input) is recognized, a plurality of lines are displayed (FIG. 27) and the plurality of lines rotate while information is being input (FIG. 28, FIG. 29). The animation of FIGS. 27 to 29 is an animation showing the information being input.

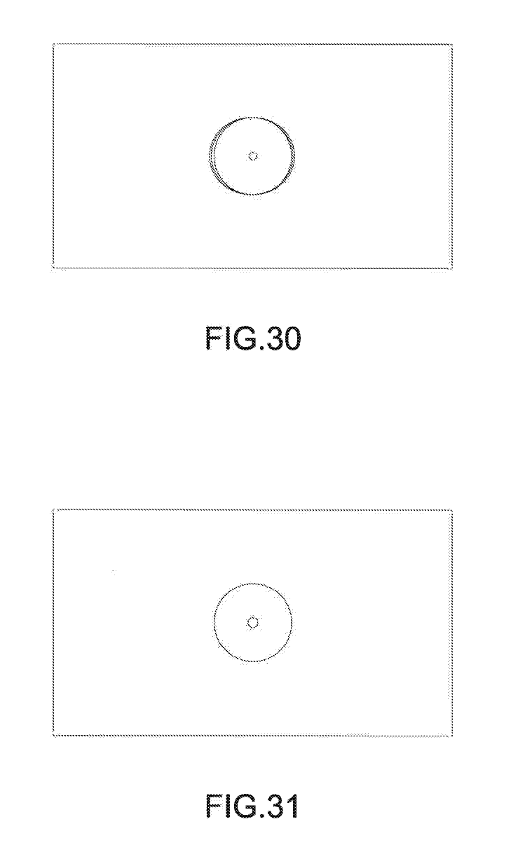

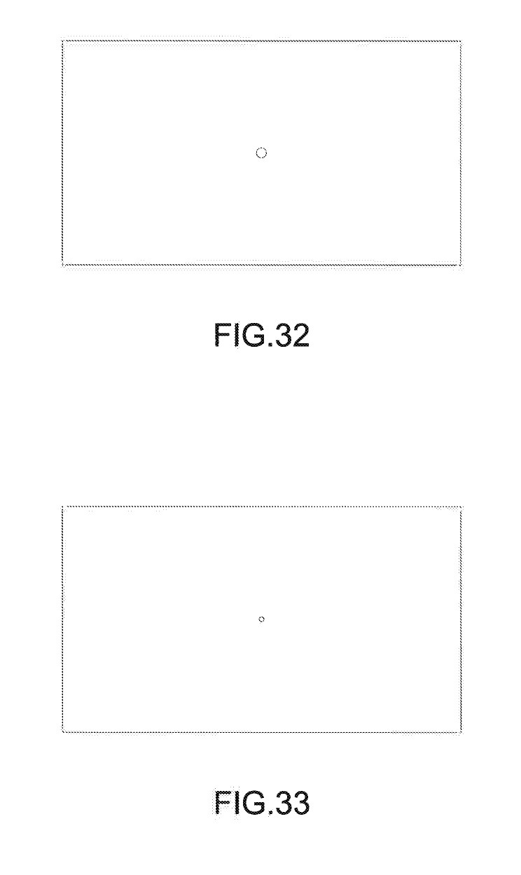

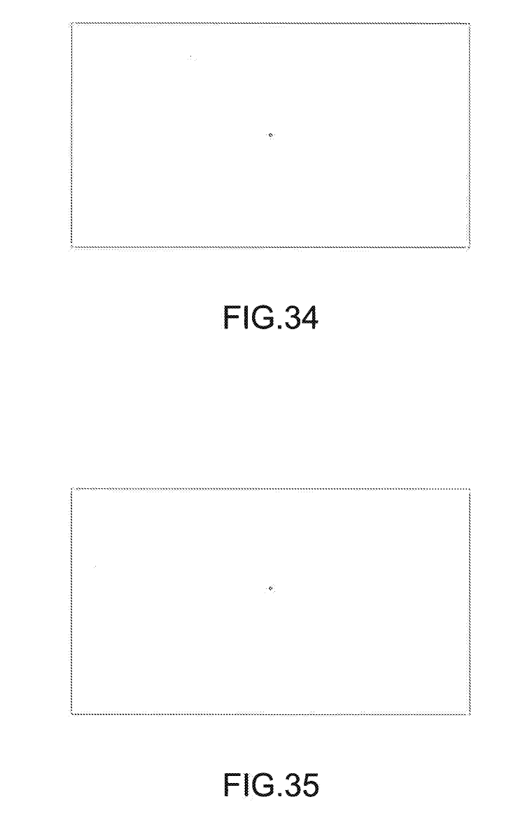

Next, when a trigger (e.g., end of input) is recognized, the lines are unified (FIG. 30, FIG. 31). Next, the line is integrated into the dot (FIG. 32). The dot is reduced in size (FIG. 33, FIG. 34) and starts to move after it is completely reduced in size (FIG. 35).

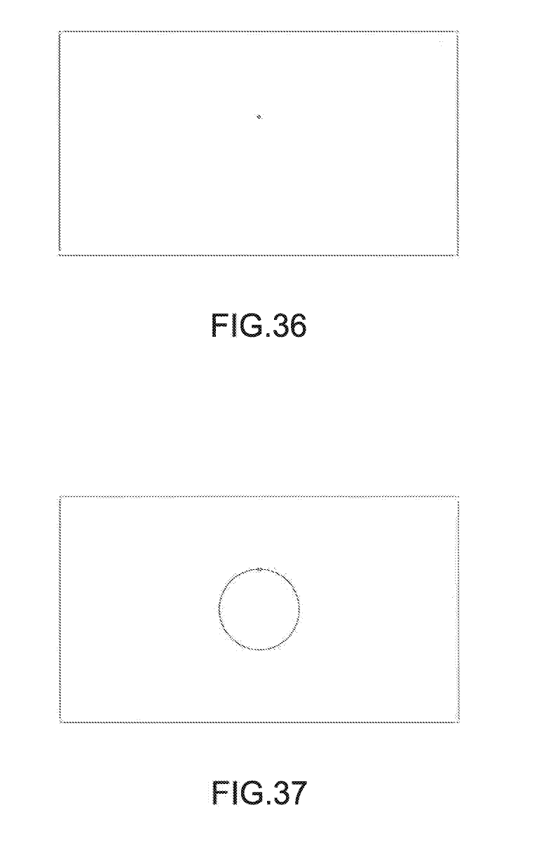

The dot continues to move and moves to draw a circle (FIG. 36). Along with this, a movement trajectory is displayed as a line (FIG. 37). This movement trajectory is also an example of the second display element.

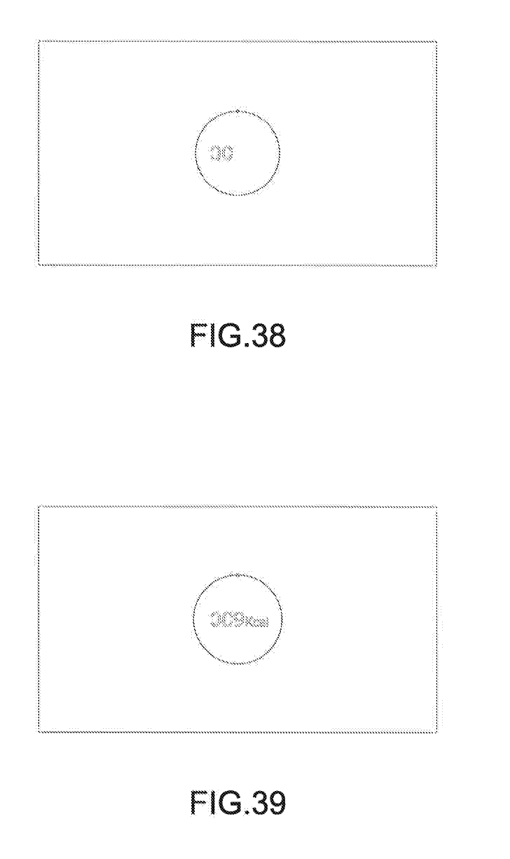

Next, the information is displayed in an area surrounded with the line (FIG. 38, FIG. 39). In this example, the display control apparatus 1 recognizes the names of a plurality of foods, that the user has said by voice recognition, and searches for and displays their calories. In this manner, feedback with respect to the voice input may be displayed.

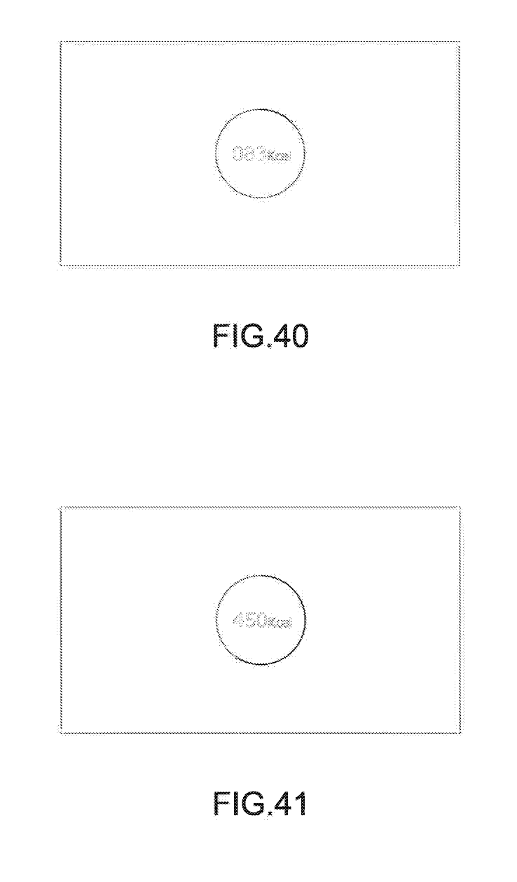

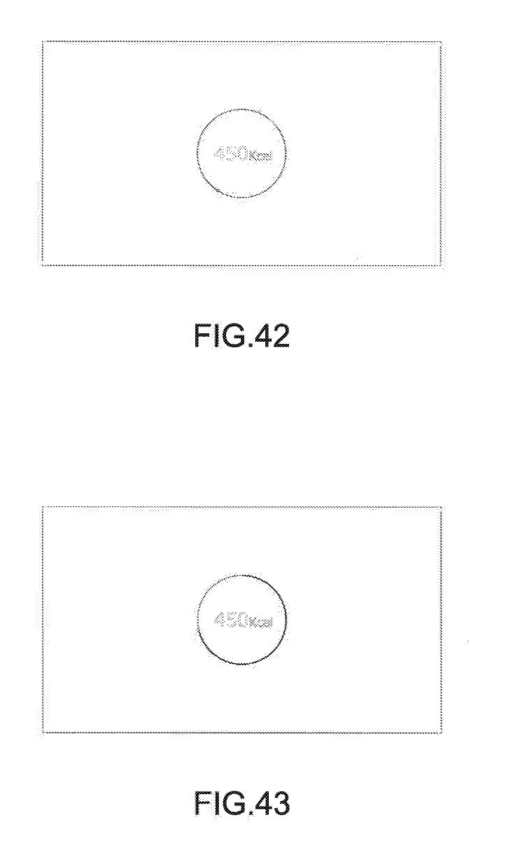

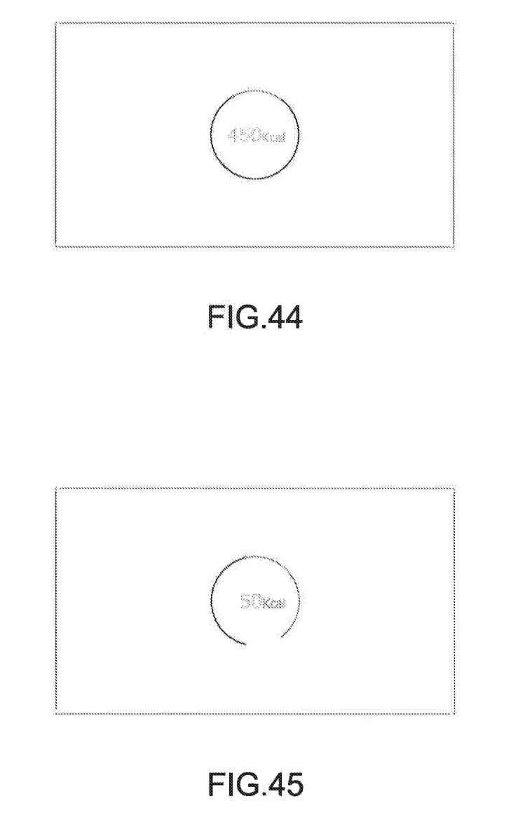

Next, the dot moves on the line (FIG. 40, FIG. 41, FIG. 42, FIG. 43, FIG. 44). At this time, the movement trajectory of the dot is displayed with the line pulled out of the dot (FIG. 41, FIG. 43). The display is performed such that the width of that line is larger than the width of the line showing the area in which the information is displayed (FIG. 41, FIG. 43). By varying the width of the line, the line (one example of second display element) showing the dot's trajectory is differentiated from the line (another example of second display element) showing the area in which the information is displayed.

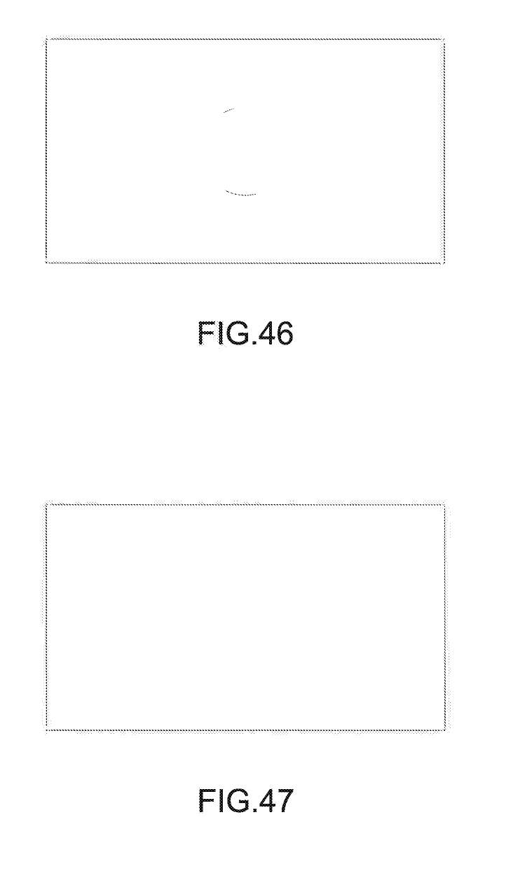

While the dot is rotating on the circle formed by the line, a part of the circle disappears (FIG. 45), the displayed information disappears, and the line also successively disappears (FIG. 46). The dot also disappears (FIG. 46). Finally, the initial state is displayed again (FIG. 47).

<Display Control Example 2>

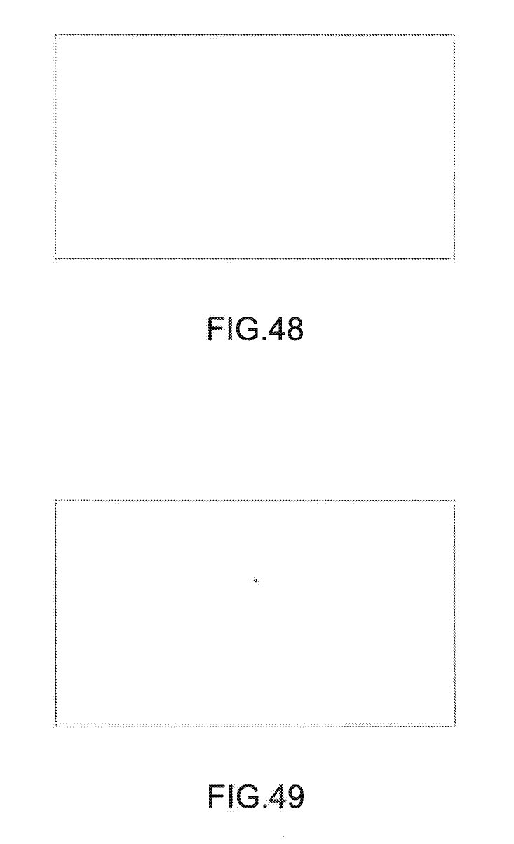

The display control apparatus 1 displays an animation that changes in the order from FIGS. 48 to 82. This animation is an example of the display control combining Display Control Pattern 1, Display Control Pattern 2, and Display Control Pattern 3 above. Hereinafter, the animation will be described.

First of all, on a screen in an initial state (FIG. 48), a dot (first display element) is faded in and displayed (FIG. 49).

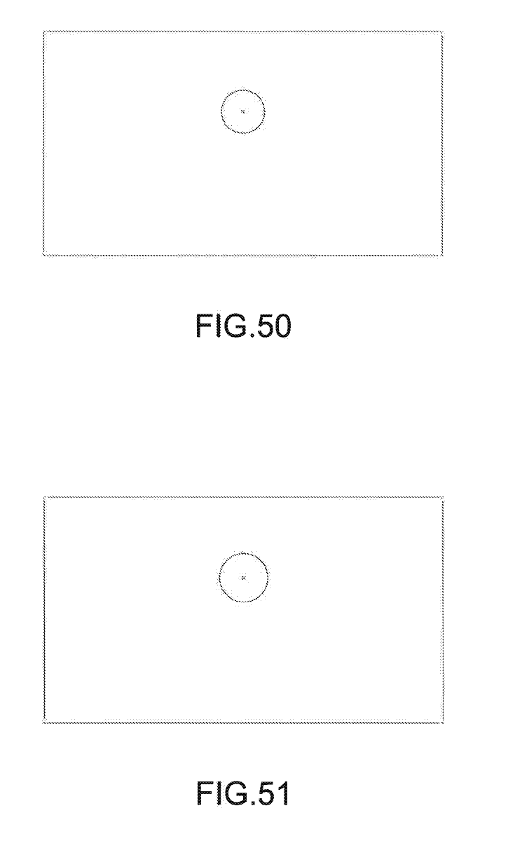

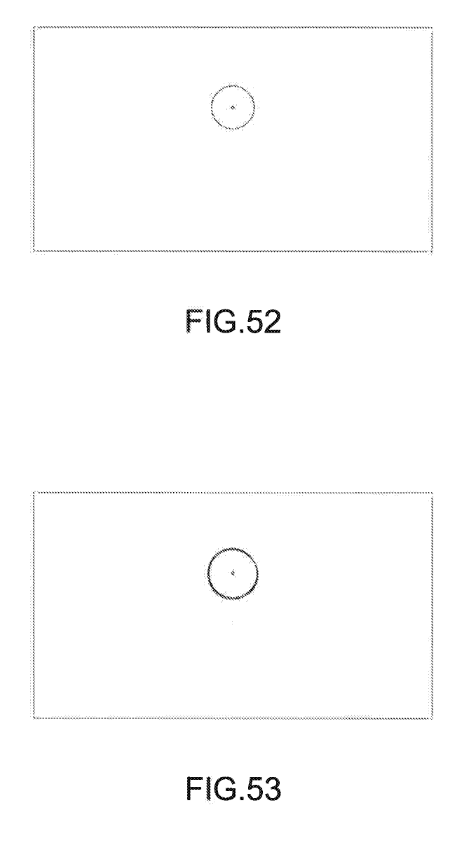

Next, a line (second display element) radially spreads from the dot (FIG. 50) and reduction in size (FIG. 51) and enlargement (FIG. 52) are repeated. The animation of FIGS. 50 to 52 is an animation showing waiting for a trigger.

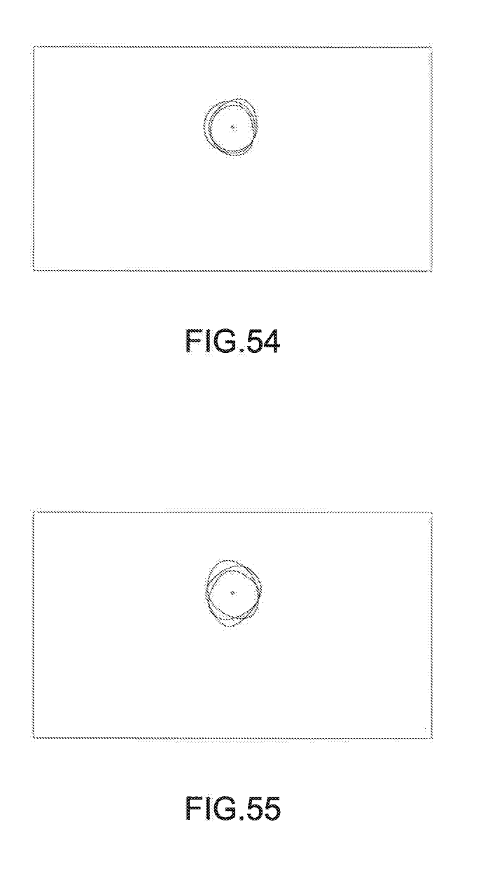

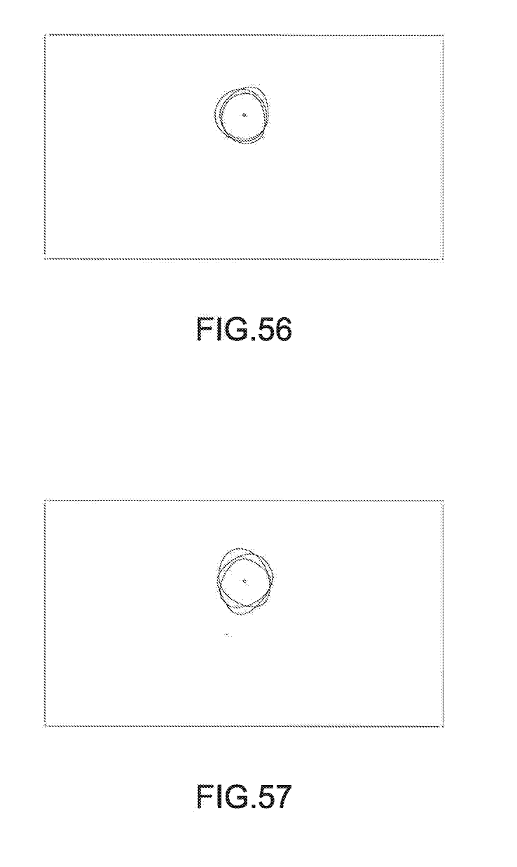

Next, when a trigger (e.g., voice input) is recognized, a plurality of lines are displayed (FIG. 53), the plurality of lines rotate while information is being input (FIG. 54, FIG. 55, FIG. 56, FIG. 57). The animation of FIGS. 53 to 57 is an animation showing the information being input.

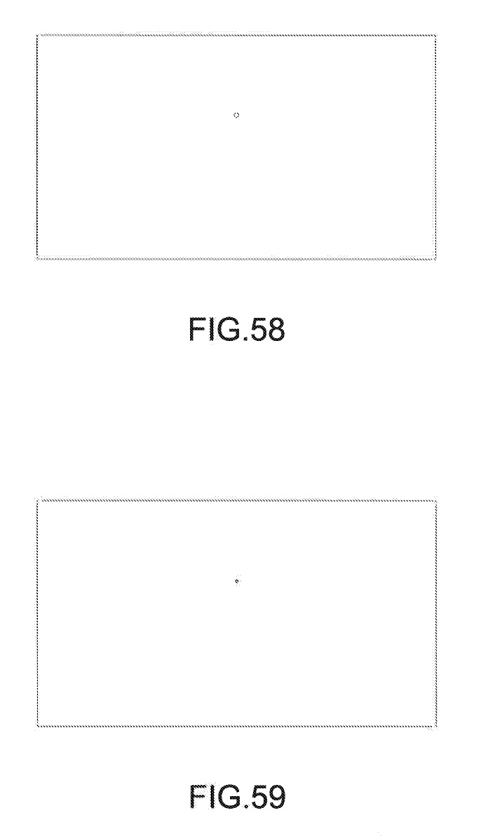

Next, when a trigger (e.g., end of input) is recognized, the lines are unified and integrated into the dot (FIG. 58). The dot is reduced in size (FIG. 58, FIG. 59) and starts to move after it is completely reduced in size (FIG. 59).

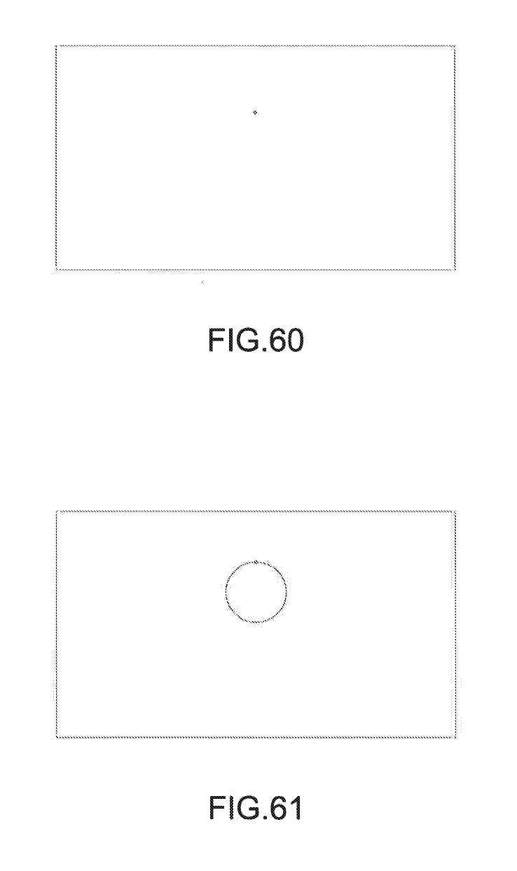

The dot continues to move and moves to draw a circle (FIG. 60). Along with this, a movement trajectory is displayed as a line (FIG. 61). This movement trajectory is also an example of the second display element.

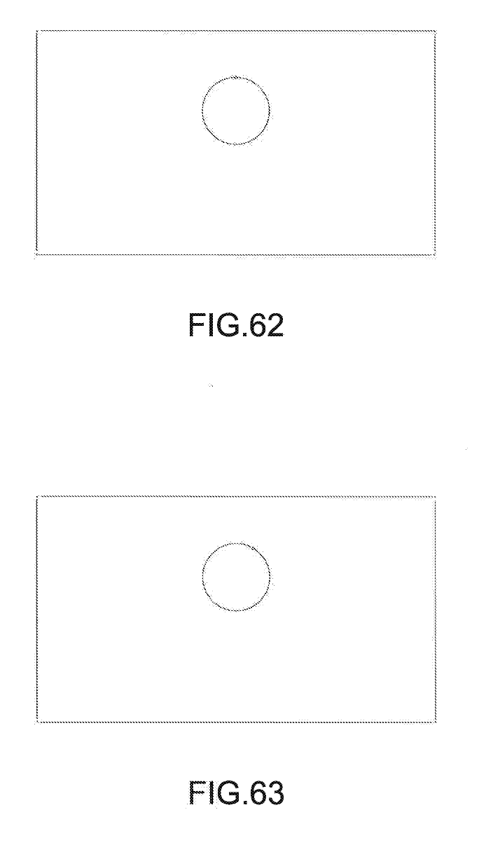

Next, the dot at a point on the line drawing the circle (FIG. 62) moves on the line (FIG. 63). In FIG. 62, the dot is positioned at an upper most point on the circle, which is not on either one of left- and right-hand sides. In other words, the dot is positioned at upper one of intersection points of the circle with a line vertically extending through the center. In FIG. 63, the dot moves to the right from that position.

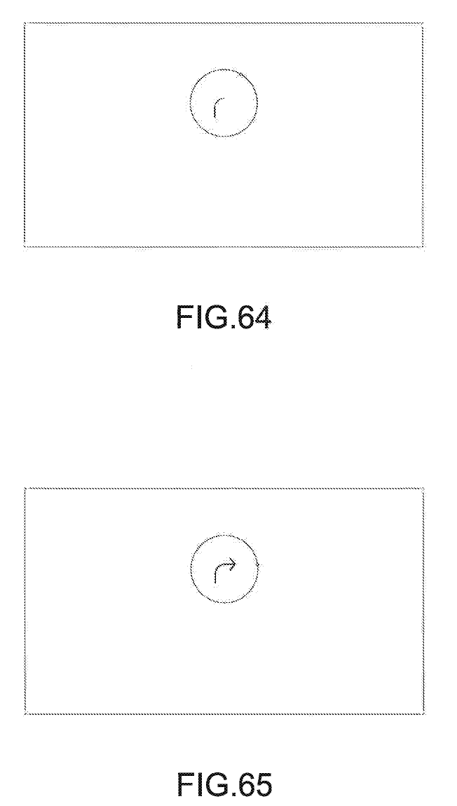

Next, an arrow indicating a travelling direction or the like starts to appear in a display area surrounded with the circle (FIG. 64). The arrow is entirely displayed and the dot moves in a direction indicated by the arrow (FIG. 65). At this time, a part of the arrow is temporarily displayed with a thin line and then the thin line is traced by a thick line (FIG. 64). The arrow finally displayed in the display area surrounded with the circle is emphasized with the thick line and displayed (FIG. 65).

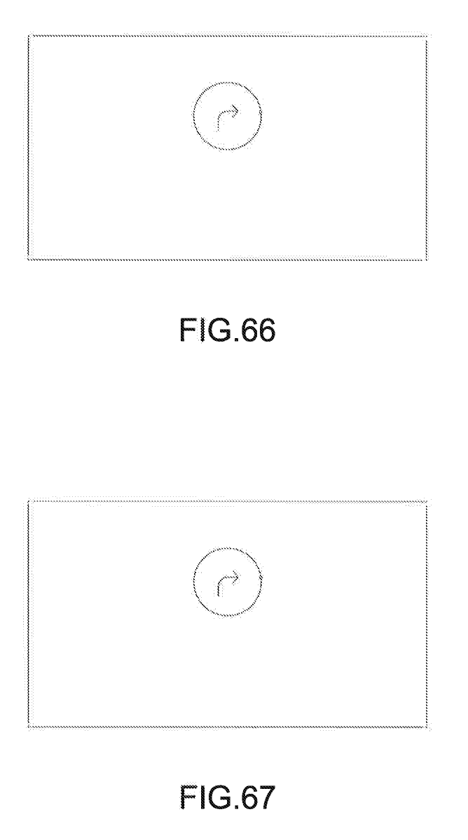

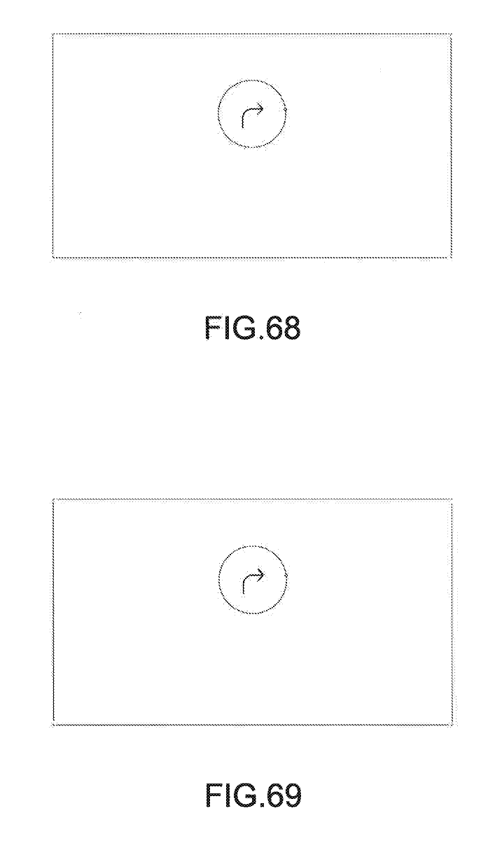

Next, the arrow temporarily becomes a thin line (FIG. 66) and is traced by a thick line from the root of the arrow again (FIG. 67, FIG. 68). Continuously, the entire arrow is emphasized with the thick line and displayed (FIG. 69). The animation of FIGS. 66 to 69 is repeated until it ends when a trigger, for example, the end of change in direction by the user is recognized.

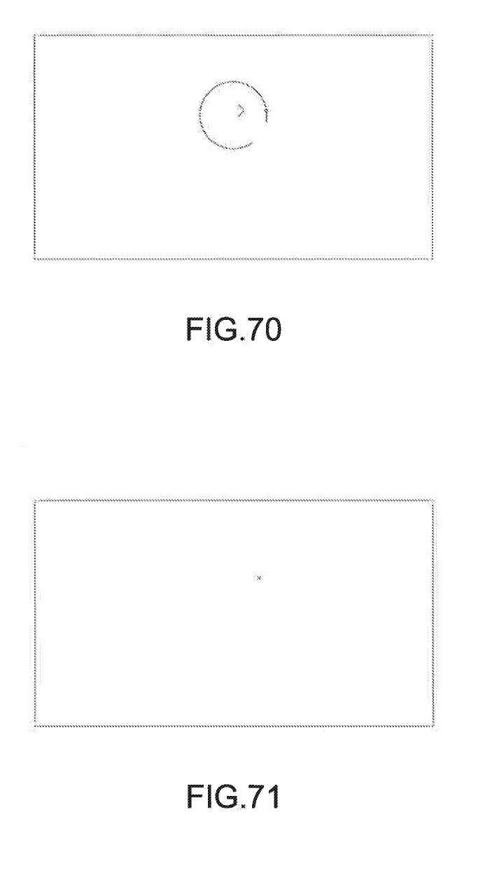

Next, when the trigger (e.g., end of change in direction) is recognized, the line is dissolved (FIG. 70). The line is integrated into the dot (FIG. 71).

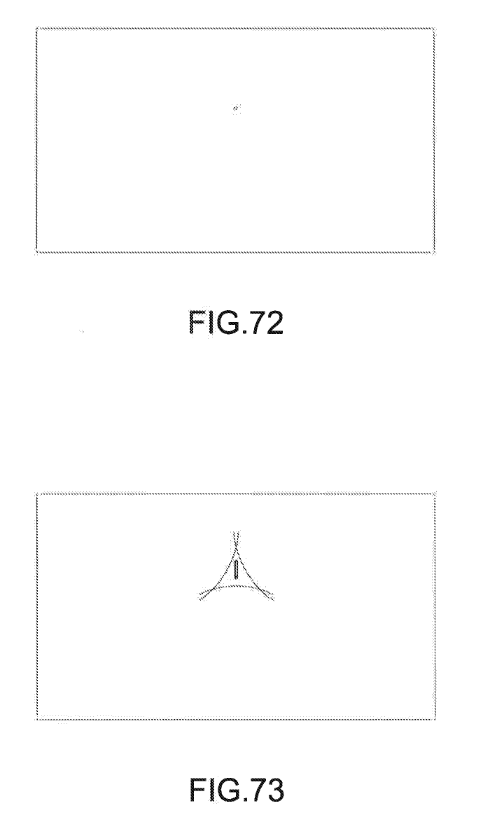

Next, the dot moves to a place at which next information is to be displayed (FIG. 72). By displaying an animation in which the dot moves to the place at which the next information is to be displayed as shown in FIG. 59 or FIG. 72, user's attention can be directed to the information to be displayed.

Next, three lines (one example of second display element) radially spread from the dot (FIG. 73). The three lines are curves having the same length. Further, a thick line is displayed on the dot and an exclamation mark is formed (FIG. 73).

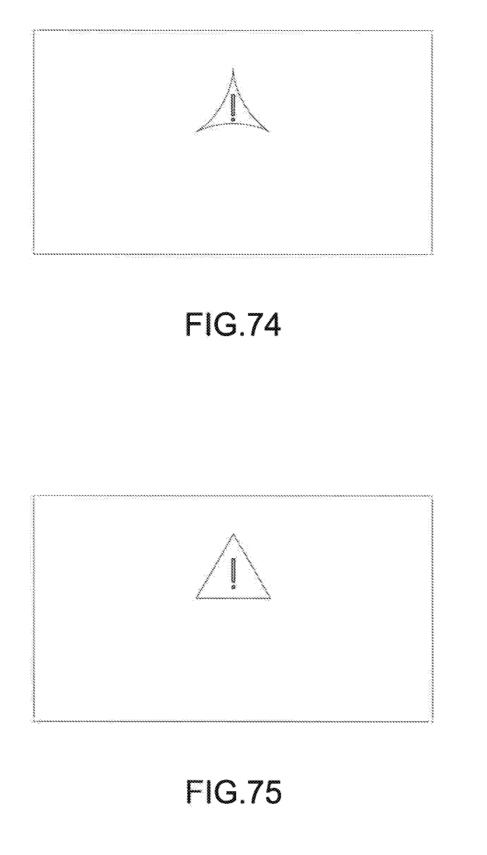

Next, the three lines spreading from the dot further spread, end points connect to one another, and a closed region is formed (FIG. 74). The exclamation mark displayed in FIG. 73 continues to be displayed within that closed region (FIG. 74).

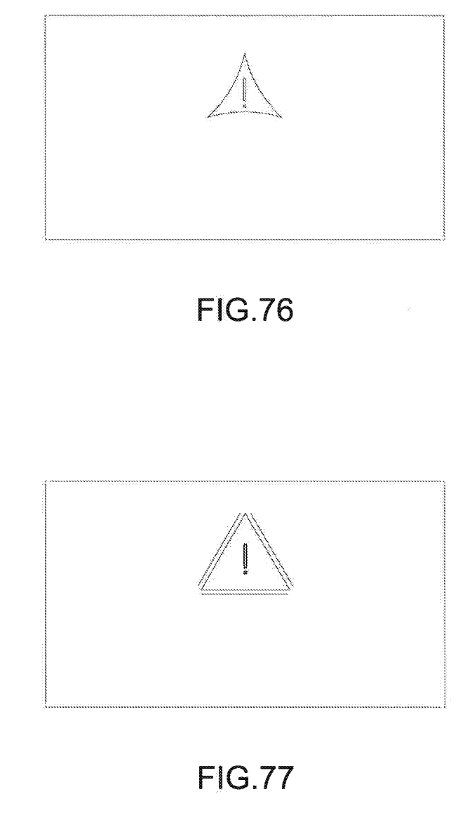

Next, the three curves become straight lines and the closed region of FIG. 74 forms an equilateral triangle (FIG. 75). The respective edges of the equilateral triangle are temporarily depressed inwards (FIG. 76) and an animation in which they return to the shape of the original equilateral triangle Is displayed (FIG. 77).

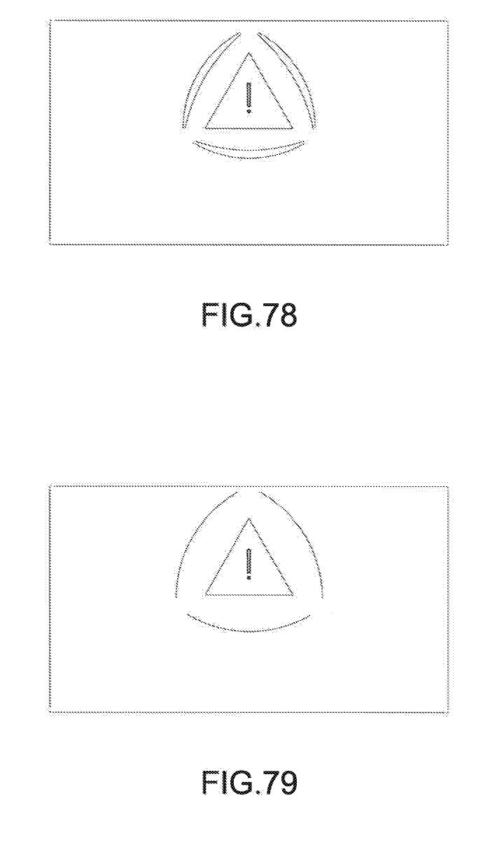

When the respective edges of the equilateral triangle are depressed (FIG. 76) and return to the shape of the original equilateral triangle (FIG. 77), the respective edges are copied to appear double (FIG. 77). The copied respective edges are deformed into point-symmetric figures having a center that is a center of a circumscribed circle or an inscribed circle of the equilateral triangle (FIG. 78) and faded out toward the outside (FIG. 79). The animation of FIGS. 75 to 79 is repeatedly displayed. The animation shown in FIGS. 75 to 79 is used in a case where there is information (caution) about which user's attention should particularly be called.

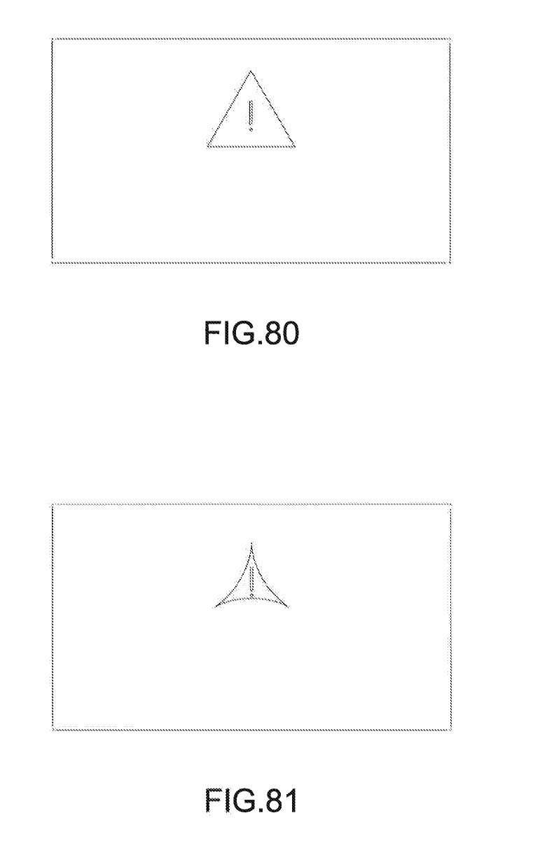

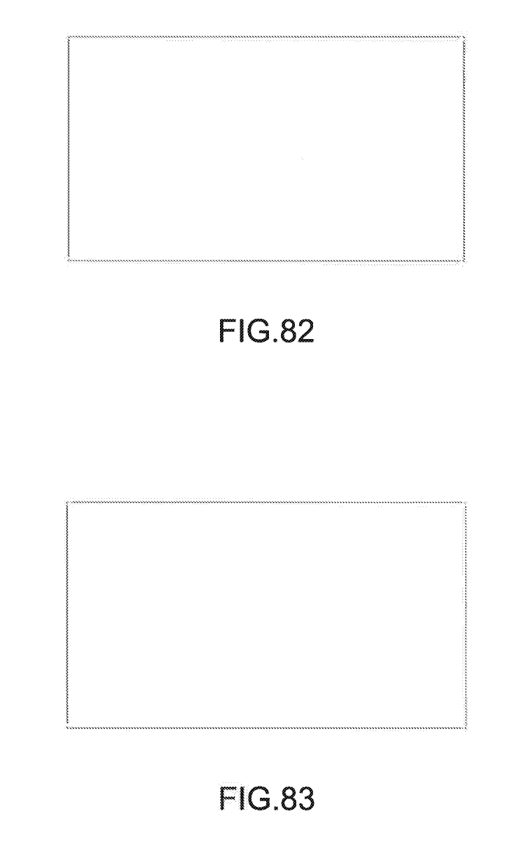

Next, when a trigger (e.g., end of caution) is recognized, the animation in which the lines pulse stops (FIG. 80) and the respective edges contract (FIG. 81). The dot and the line disappear and the initial state is displayed again (FIG. 82).

<Display Control Example 3>

The display control apparatus 1 displays an animation that changes in the order from FIGS. 83 to 102. This animation is an example of the display control combining Display Control Pattern 1 and Display Control Pattern 3 above. Hereinafter, the animation will be described.

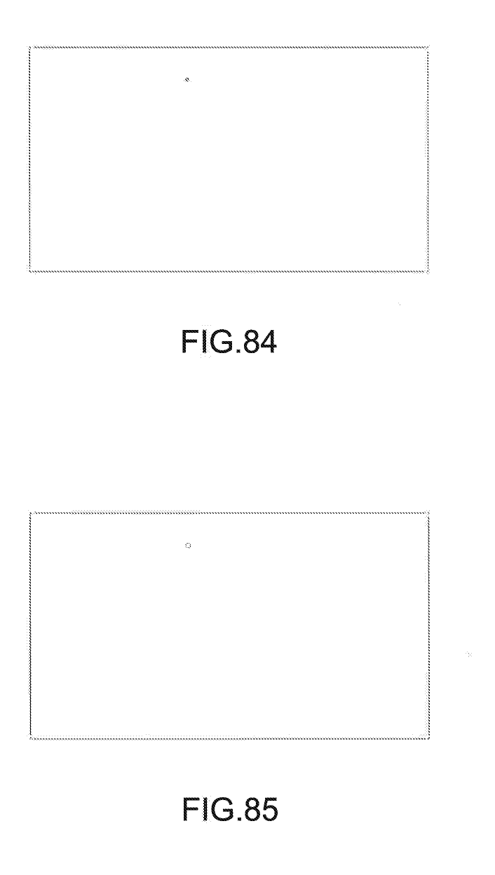

First of all, on a screen in an initial state (FIG. 83), a dot (first display element) is faded in and displayed (FIG. 84, FIG. 85).

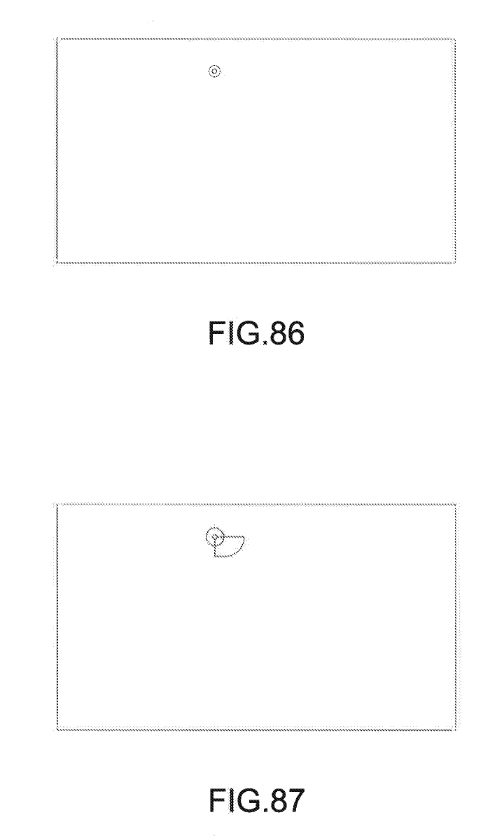

Next, an animation in which a line (second display element) radially spreads from the dot is displayed (FIG. 86). Next, an animation in which a line (another second display element) is pulled out of the dot is displayed (FIG. 87). Here, the pulled-out line is closed in advance and an area surrounded with the closed line has already been formed (FIG. 87). This area is an area in which information is to be displayed.

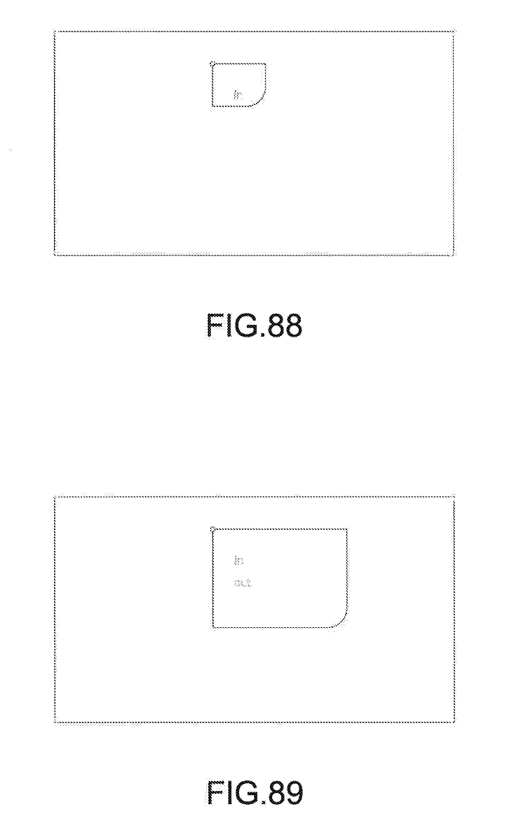

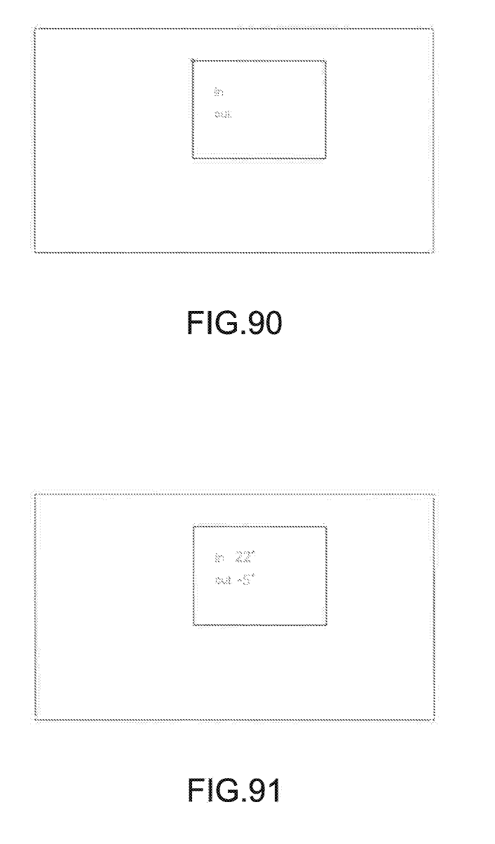

Continuously, the information display area is enlarged (FIG. 88, FIG. 89). The information display area finally becomes a rectangle (FIG. 90). Regarding the information area, a part of the rectangle is rounded during enlargement (FIG. 87, FIG. 88, FIG. 89).

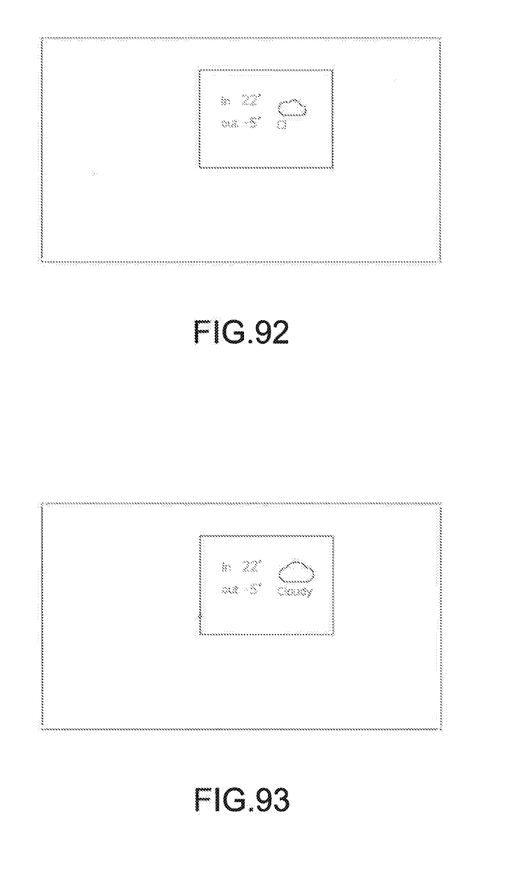

When the information display area is completed (FIG. 90), the dot temporarily disappears (FIG. 91). Continuously, additional information is further displayed in the information display area (FIG. 92), and then the dot appears again (FIG. 93).

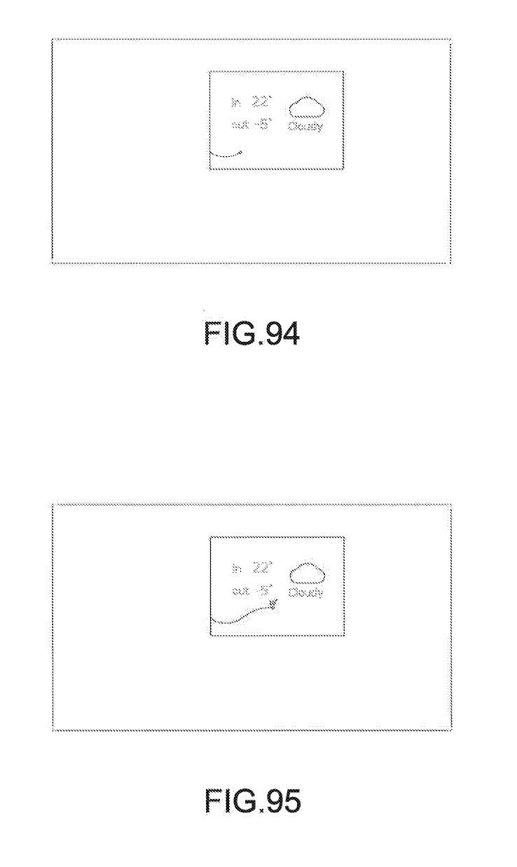

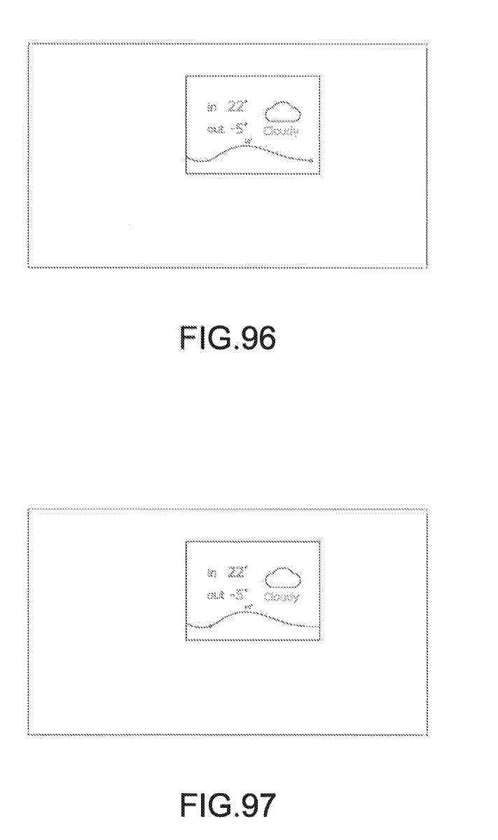

The dot appearing again moves within the information display area (FIG. 94). The trajectory along which the dot is moving is displayed as a line (FIG. 94, FIG. 95, FIG. 96). In other words, the line is pulled out of the moving dot and displayed.

When the dot stops moving within the information display area, the dot temporarily disappears and moves again following the displayed trajectory (FIG. 97). The animation in which the dot moves on the trajectory shown in FIG. 97 is repeated multiple times.

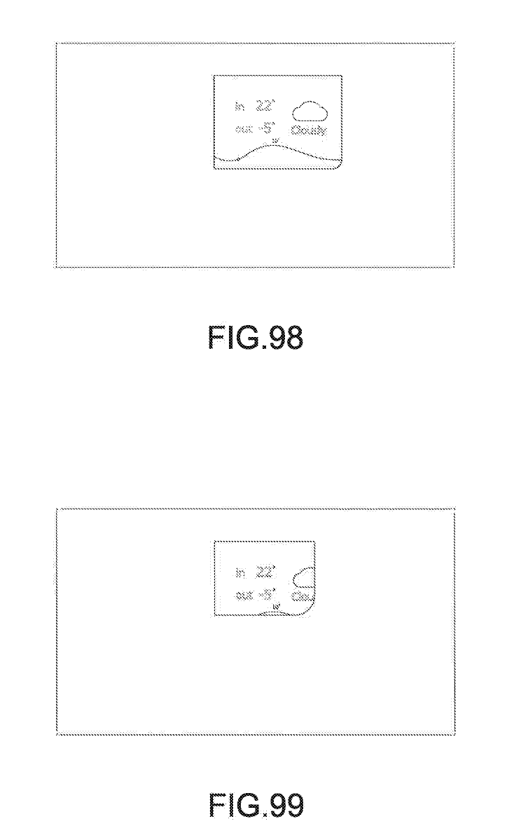

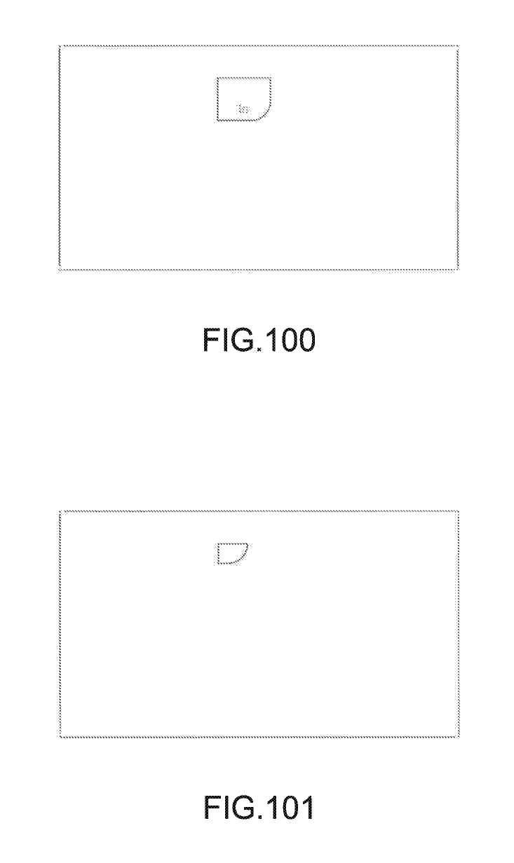

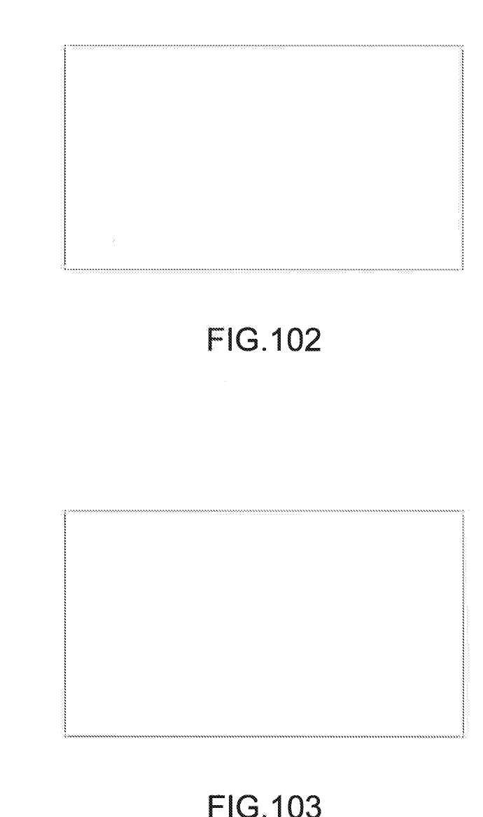

Next, when a trigger (e.g., manual trigger indicating that the user has checked the display information) is recognized, the information display area surrounded with the line starts to be reduced in size (FIG. 98). The information display area continues to be reduced in size (FIG. 99, FIG. 100, FIG. 101) and finally disappears and the initial state is displayed again (FIG. 102).

<Display Control Example 4>

The display control apparatus 1 displays an animation that changes in the order from FIGS. 103 to 130. This animation is an example of the display control combining Display Control Pattern 1 and Display Control Pattern 3 above. Hereinafter, the animation will be described.

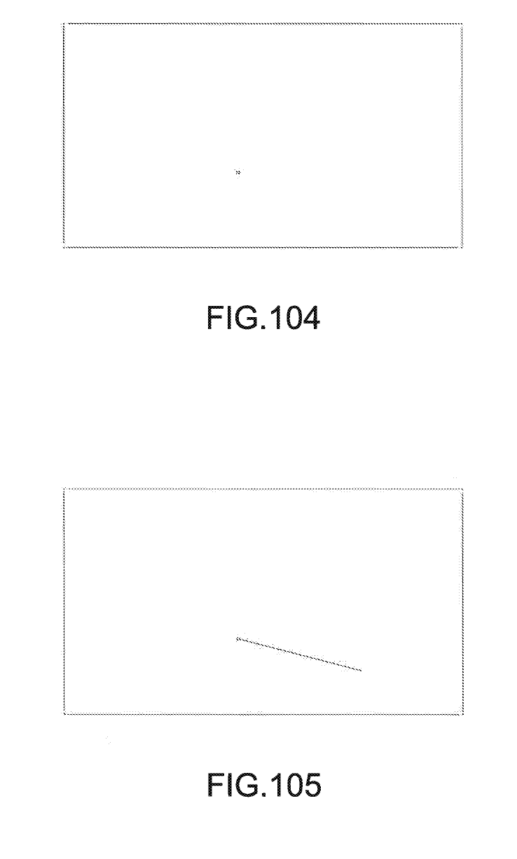

First of all, on a screen in an initial state (FIG. 103), a dot (first display element) is faded in and displayed (FIG. 104).

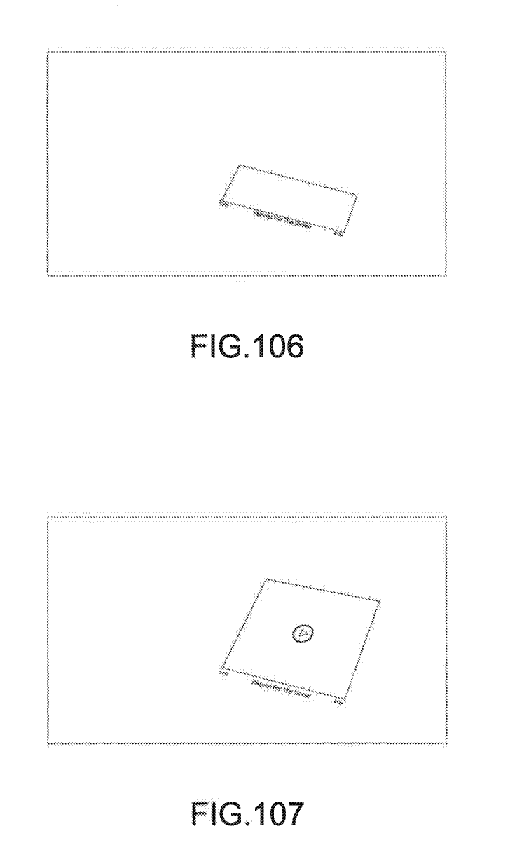

Next, an animation in which the line (second display element) is pulled out of the dot is displayed (FIG. 105). The line forms a rectangle (FIG. 106). The rectangle is deformed and GUI components necessary for a music player are displayed inside or around the rectangle (FIG. 107).

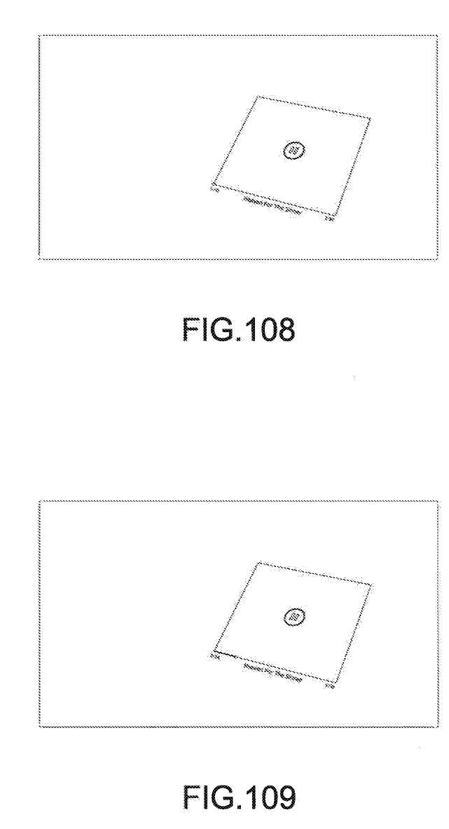

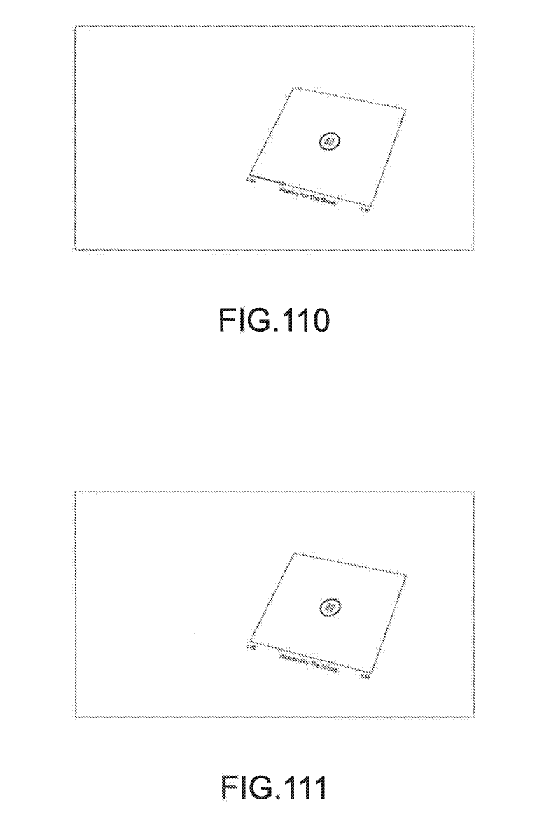

A seek bar of the music player is provided by one edge of the rectangle and the dot (FIG. 108, FIG. 109, FIG. 110, FIG. 111). That is, the dot is displayed at a lower left corner of the rectangle at the start of a piece of music (FIG. 108). At the end of that piece of music, the dot is displayed at a lower right corner of the rectangle.

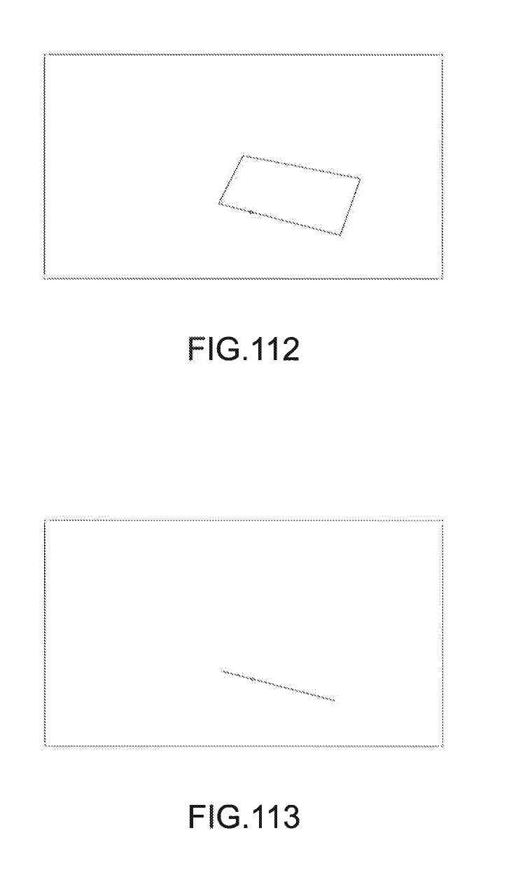

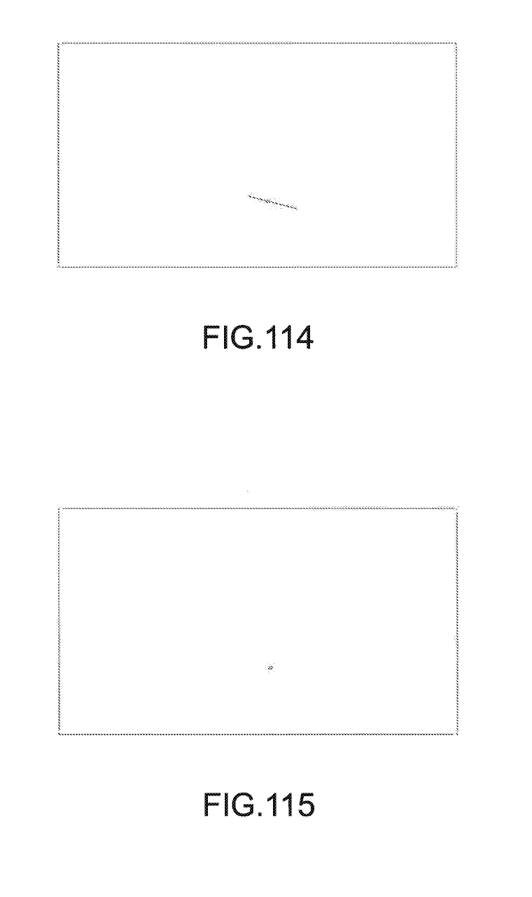

Next, when a trigger (e.g., end of music player according to user's explicit instruction) is recognized, an animation in which the rectangle is reduced in size is displayed (FIG. 112). Subsequently, the rectangle is dissolved (FIG. 113) and an animation in which the line is integrated into the dot is displayed (FIG. 114, FIG. 115).

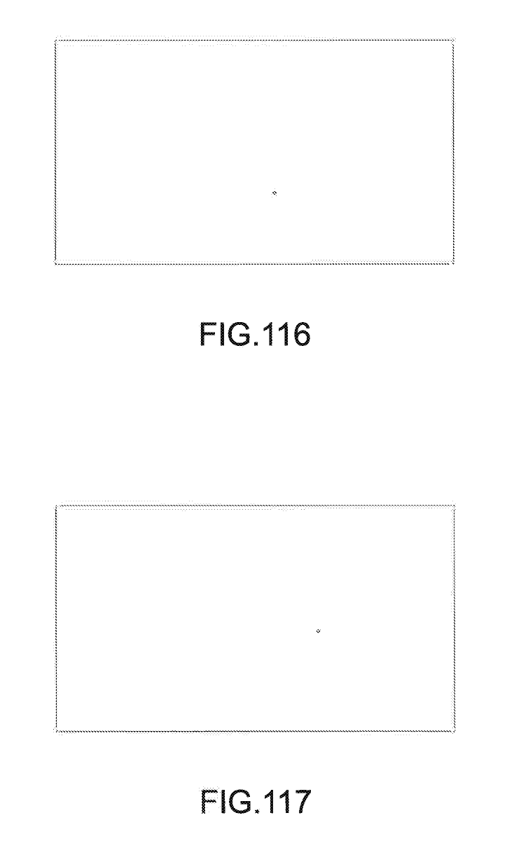

For example, if a clock application software is started following a music player application software, the animation shown in FIGS. 116 to 130 is displayed following the animation shown in FIGS. 103 to 115. Rather than separately displaying the GUI of the music player application software and the GUI of the clock application software, the GUI mainly constituted by the “dot” (first display element) and the “line” (second display element) is deformed into the GUI of each of the music player application software and the clock application software.

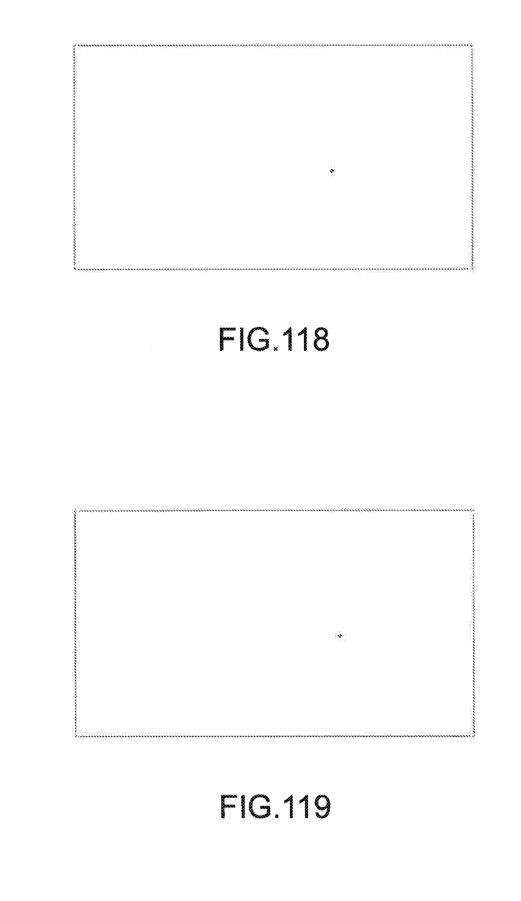

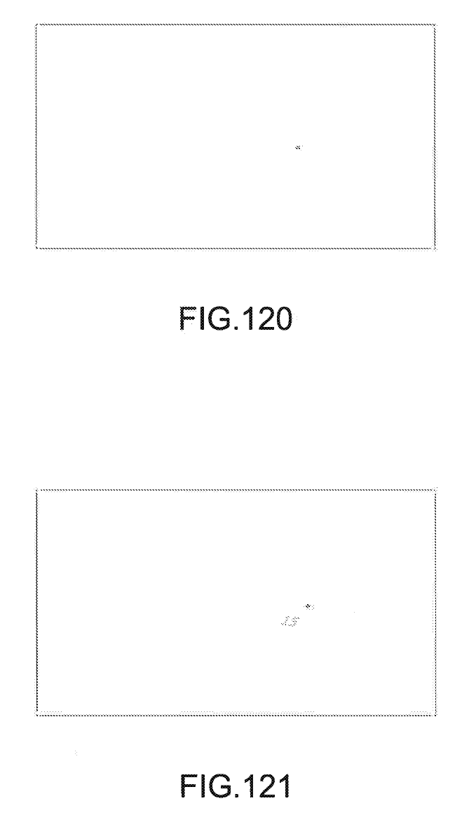

The dot moves to a place in which a clock GUI is to be displayed (FIG. 116, FIG. 117) and floats up and down or swings to/from the left and right there for a while (FIG. 118, FIG. 119, FIG. 120). The GUI shown in FIGS. 118 to 120 indicates waiting for a trigger. The trigger described here is, for example, a user's command (manual trigger) for instructing to start of next application software.

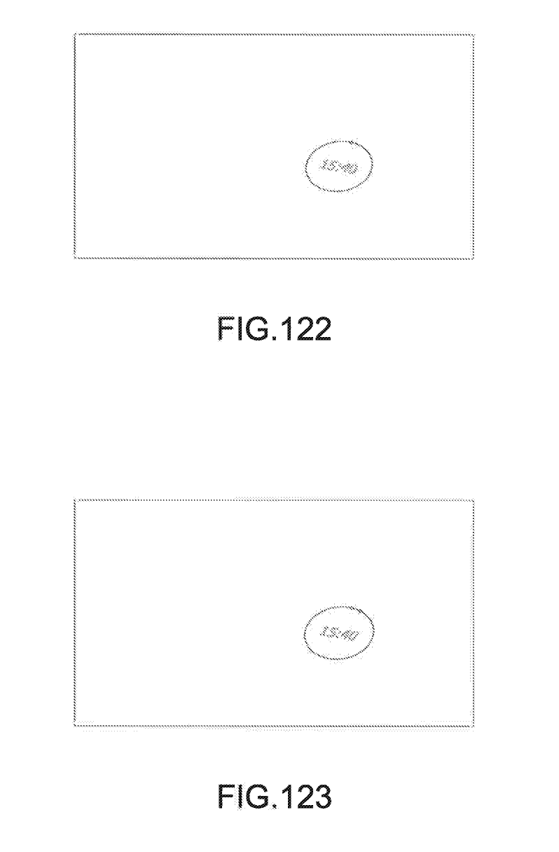

When the trigger is recognized, a part of the GUI starts to be displayed (FIG. 121). Next, a line is pulled out of the dot, is combined with a start point from which it is pulled out, that is, the dot and a display area is completed (FIG. 122). Information of which the user should be notified is displayed in the display area (FIG. 122).

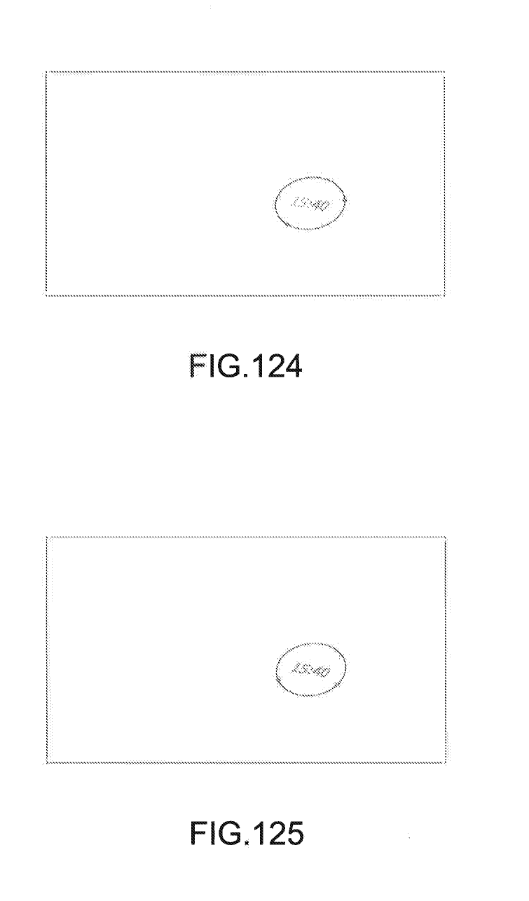

Next, an animation in which a second dot is split and generated from the dot is displayed (FIG. 123). The two dots move on the line (FIG. 124) and stop at positions corresponding to the display information of the display area (FIG. 125). In FIG. 125, the two dots stop at the positions indicated by the hands of a two-hand analog clock, corresponding to the time of 15:40.

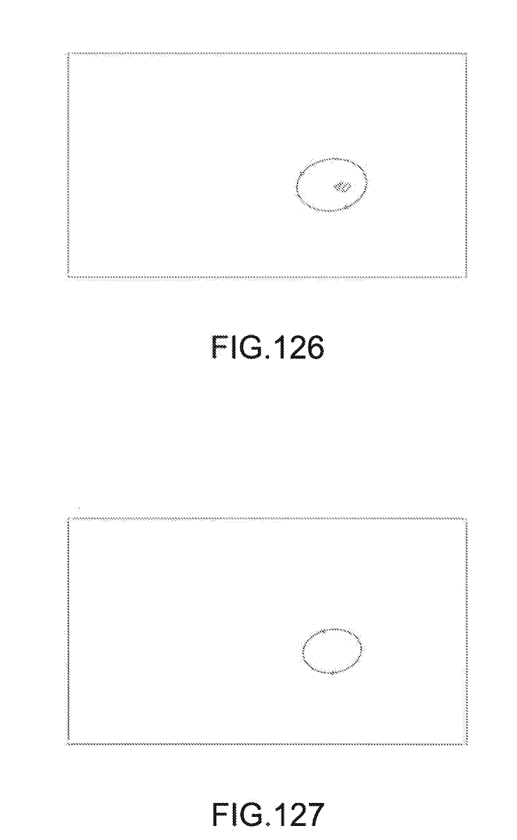

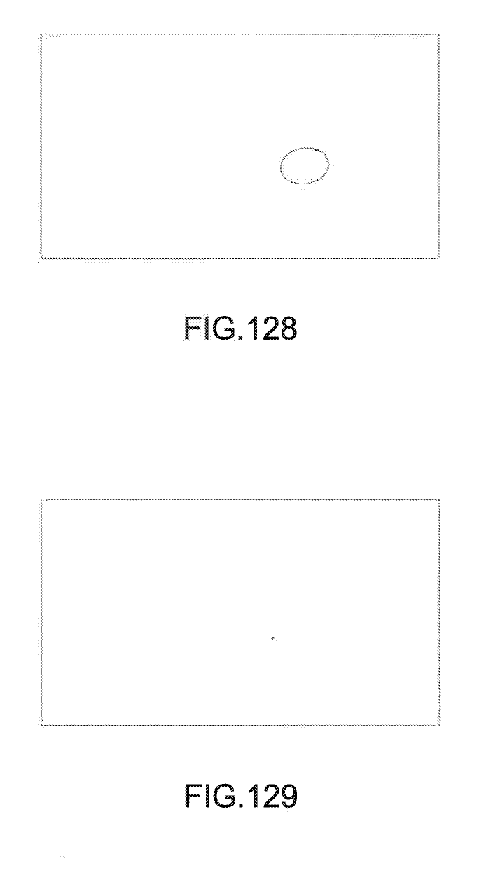

Next, when a trigger (e.g., end of display of clock application software) is recognized, the display information within the display area starts to be faded out (FIG. 126) and completely disappears (FIG. 127). Then, the GUI constituted by the dot and the line also starts to be reduced in size (FIG. 128) and the GUI is finally integrated into the single dot (FIG. 129).

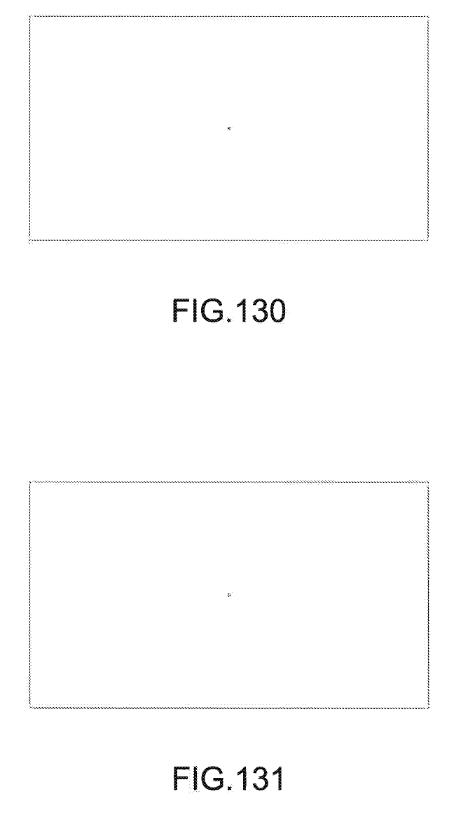

Next, the dot moves to the center (FIG. 130). The dot may be faded out and the initial state may be displayed again. Alternatively, an animation in which the line is pulled out of the dot again and deformed into a GUI of the next application may be displayed.

FIGS. 103 to 130 show the GUI in a certain plane as viewed not directly from above but obliquely from above.

<Display Control Example 5>

The display control apparatus 1 displays an animation that changes in the order from FIGS. 131 to 137. This animation is an example of the display control combining Display Control Pattern 1, Display Control Pattern 3, and Display Control Pattern 4 above. Hereinafter, the animation will be described.

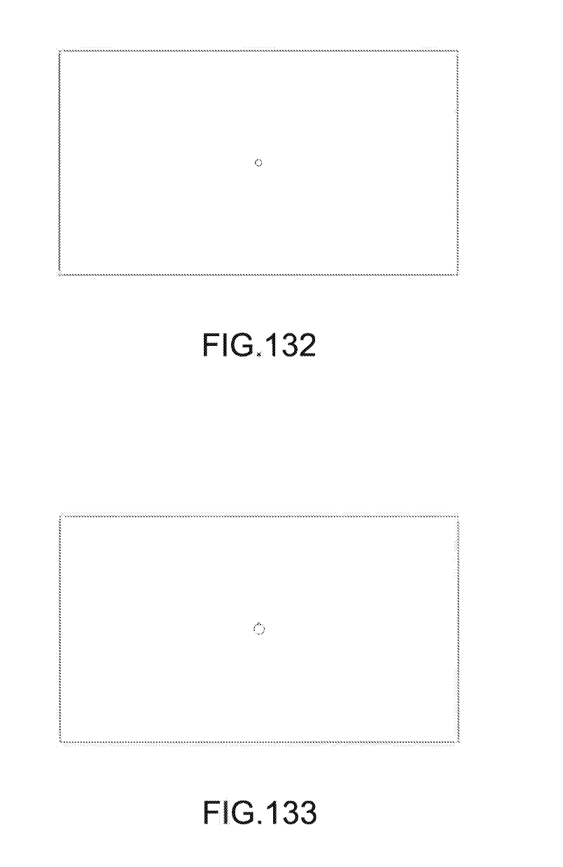

First of all, on a screen in an initial state, a dot (first display element) is faded in and displayed (FIG. 131). Next, the dot is enlarged (FIG. 132). While waiting for a trigger, contraction (FIG. 131) and enlargement (FIG. 132) of the dot are repeated.

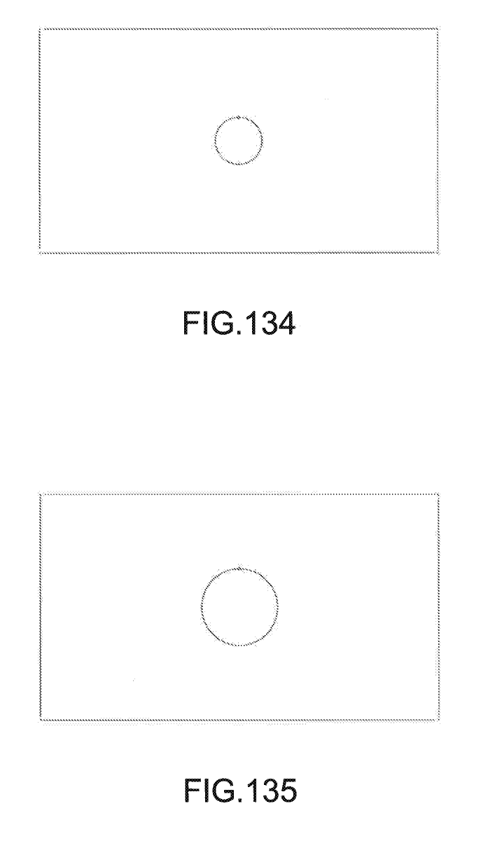

Next, an animation in which a line (second display element) spreads from the dot is displayed (FIG. 133, FIG. 134). The figure formed by the line has a circular shape. The dot is positioned at a point on the line. The circle radially spreads. The dot also moves along with the enlargement of the circle. Therefore, the positional relationship between the dot and the line does not change.

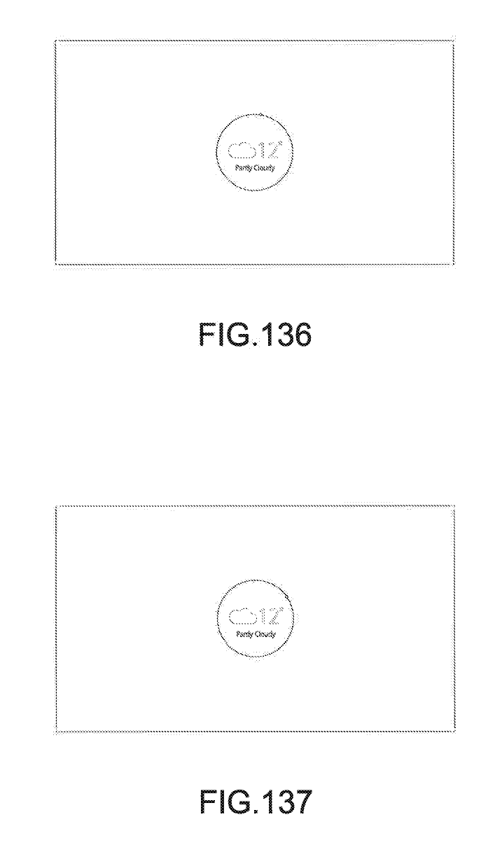

When the enlargement of the circle ends (FIG. 135), a display area surrounded with the circle is completed. Information of which the user should be notified is displayed in the display area (FIG. 136). The example shown in the figures is weather information.

Next, the dot moves on the line (FIG. 137) and implies to the user that all pieces of information, of which the user should be notified, have been displayed.

<Display Control Example 6>

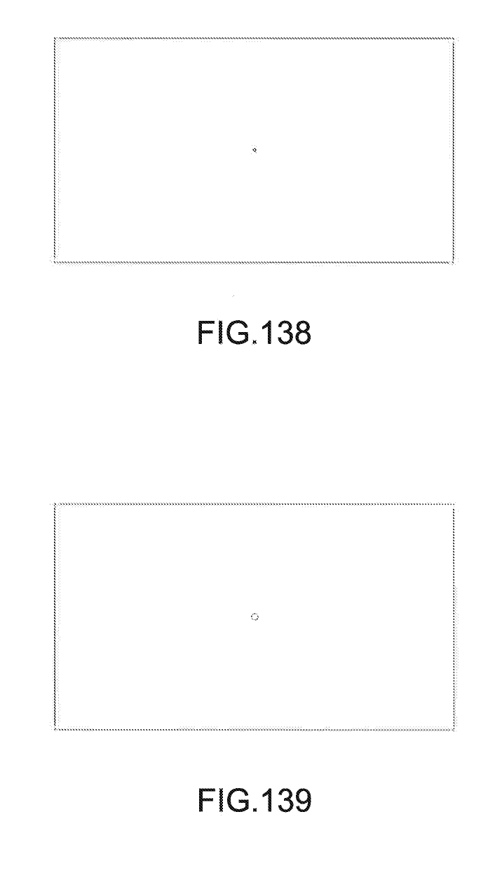

The display control apparatus 1 displays an animation that changes in the order from FIGS. 138 to 144. This animation is an example of the display control combining Display Control Pattern 1 and Display Control Pattern 3 above. Hereinafter, the animation will be described.

First of all, on a screen in an initial state, a dot (first display element) is faded in and displayed (FIG. 138). Next, the dot is enlarged (FIG. 139). While waiting for a trigger, contraction (FIG. 138) and enlargement (FIG. 139) of the dot are repeated.

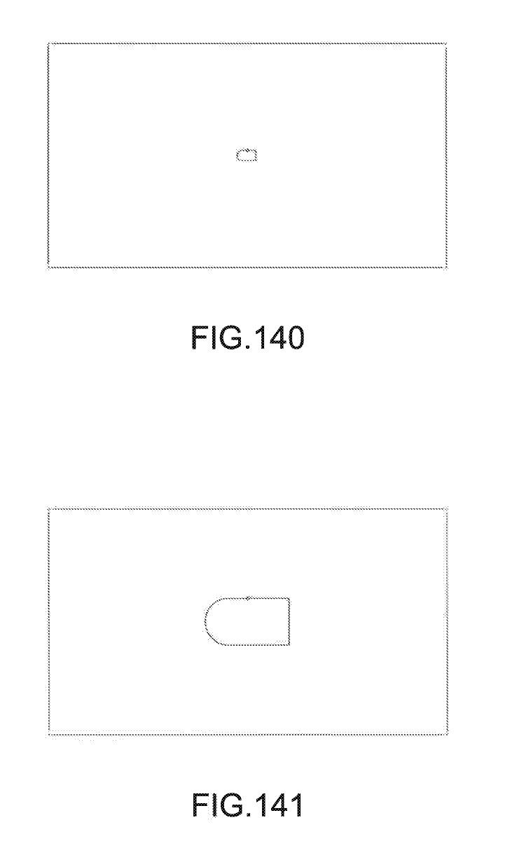

Next, an animation in which a line (second display element) spreads from the dot is displayed (FIG. 140, FIG. 141). The shape of the figure formed by the line is a shape combining a rectangle and a semi-circle (FIGS. 140 to 144). The region surrounded with the line becomes the display area.

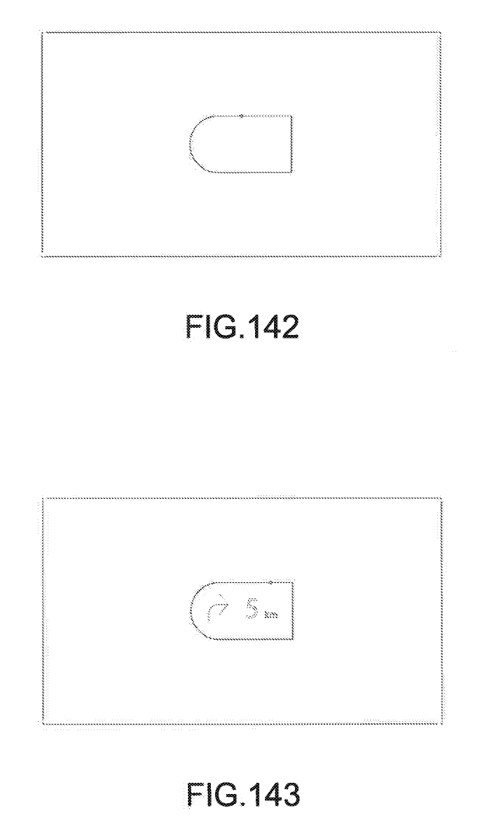

When the enlargement of the display area constituted by the dot and the line ends (FIG. 142), information is displayed (FIG. 143). At this time, literal characters are displayed in the rectangular portion and a figure is displayed in the semi-circular portion. In FIG. 143, to turn right and travel 5 km is shown, which is a part of the GUI of a car navigation system.

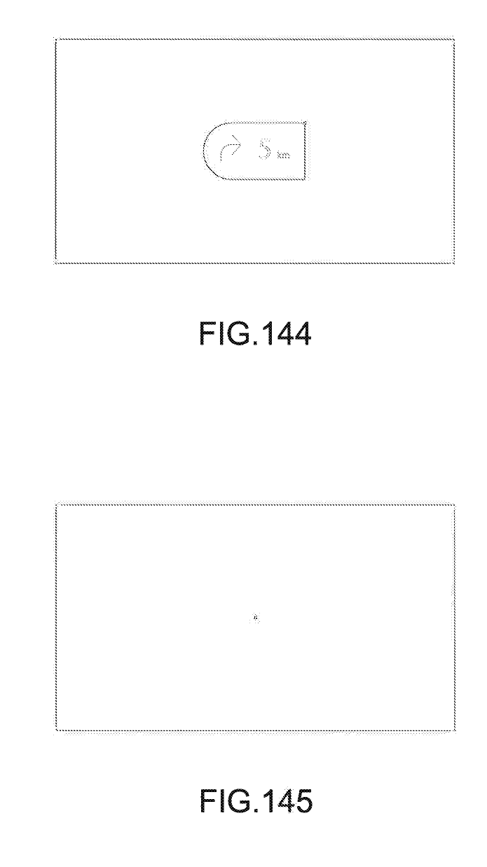

Next, the dot moves on the line and arrives at a corner of the rectangle (FIG. 144) and implies to the user that all pieces of the information, of which the user should be notified, have been displayed.

<Display Control Example 7>

The display control apparatus 1 displays an animation that changes in the order from FIGS. 145 to 151. This animation is an example of the display control combining Display Control Pattern 1 and Display Control Pattern 3 above. Hereinafter, the animation will be described.

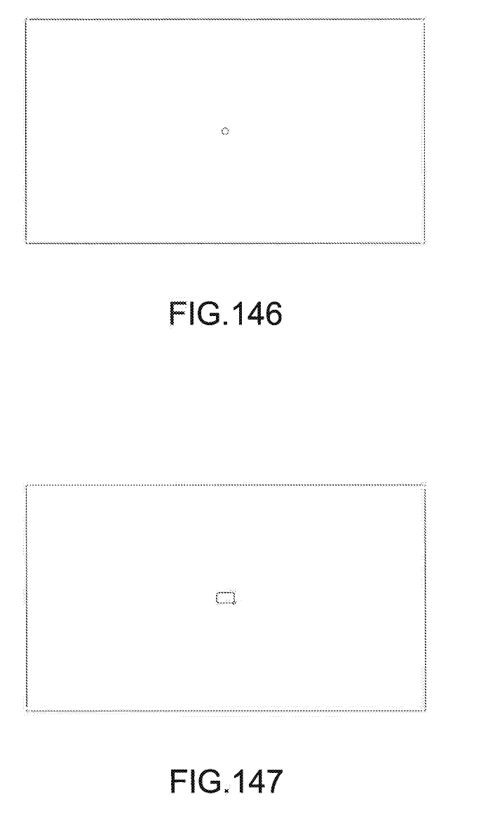

First of all, on a screen in an initial state, a dot (first display element) is faded in and displayed (FIG. 145). Next, the dot is enlarged (FIG. 146). While waiting for a trigger, contraction (FIG. 145) and enlargement (FIG. 146) of the dot are repeated.

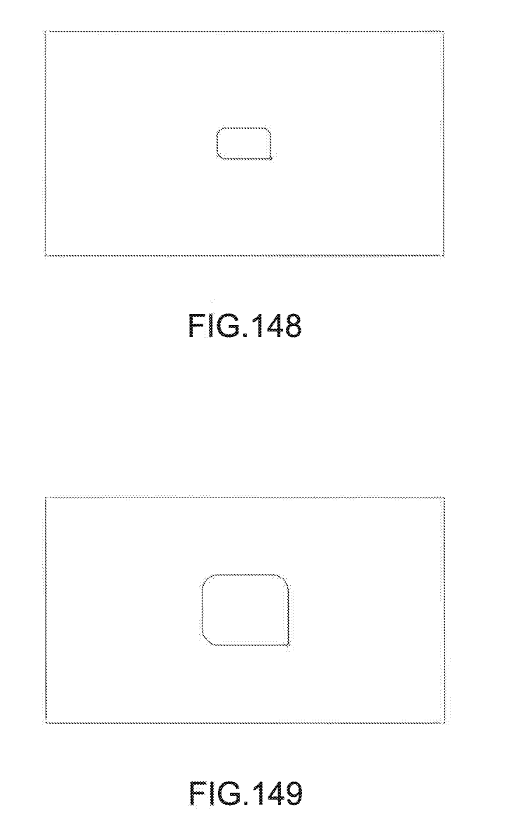

Next, an animation in which a line (second display element) spreads from the dot is displayed (FIG. 147, FIG. 148). The shape of the figure formed by the line is a rectangle whose corners excluding lower right one are rounded (FIGS. 147 to 151). The region surrounded with the line becomes the display area.

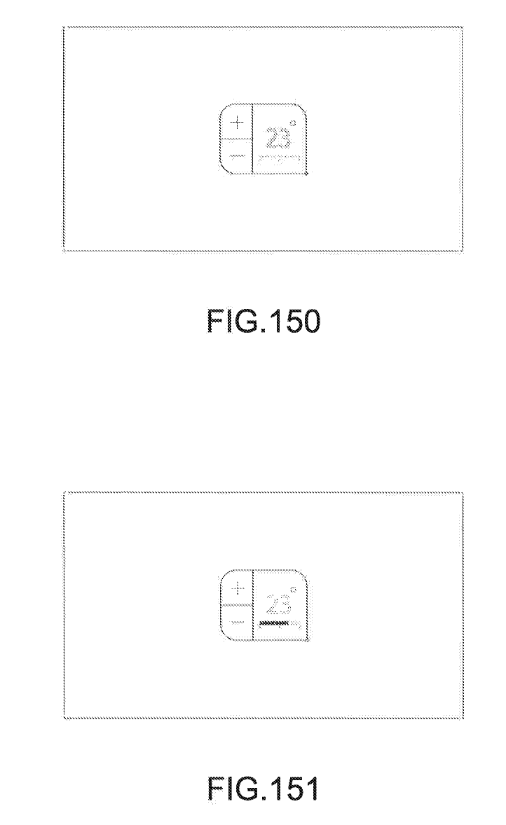

When the enlargement of the display area constituted by the dot and the line ends (FIG. 149), information is displayed (FIG. 150). FIGS. 150 and 151 show a remote controller of an air conditioner. In the figure, a GUI for changing a set temperature of the air conditioner and a GUI for displaying the set temperature are shown. When this remote controller is activated, an animation in which an indicator lights up is displayed (FIG. 151).

<Display Control Example 8>

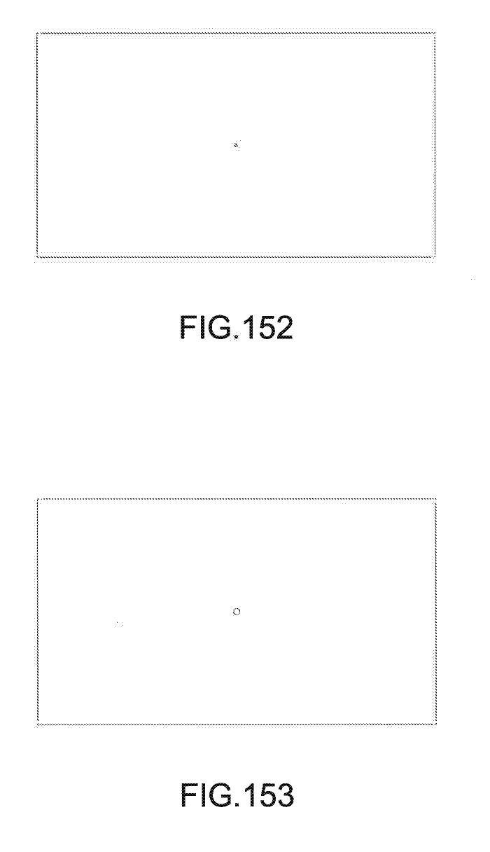

The display control apparatus 1 displays an animation that changes in the order from FIGS. 152 to 158. This animation is an example of the display control combining Display Control Pattern 1 and Display Control Pattern 3 above. Hereinafter, the animation will be described.

First of all, on a screen in an initial state, a dot (first display element) is faded in and displayed (FIG. 152). Next, the dot is enlarged (FIG. 153). While waiting for a trigger, contraction (FIG. 152) and enlargement (FIG. 153) of the dot are repeated.

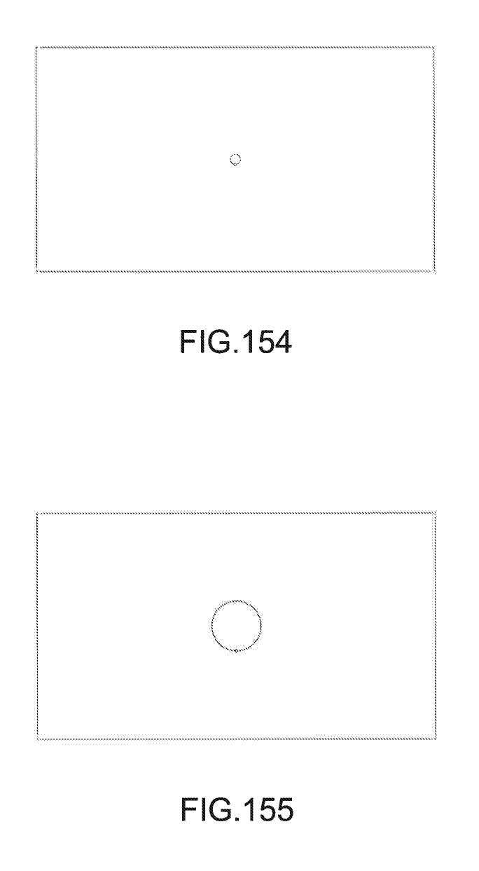

Next, an animation in which a line (second display element) spreads from the dot is displayed (FIG. 154, FIG. 155). The shape of the figure formed by the line, the figure formed by the line is a circular shape. The dot is positioned at a point on the line. The circle radially spreads. The dot also moves along with the enlargement of the circle. Therefore, the positional relationship between the dot and the line does not change.

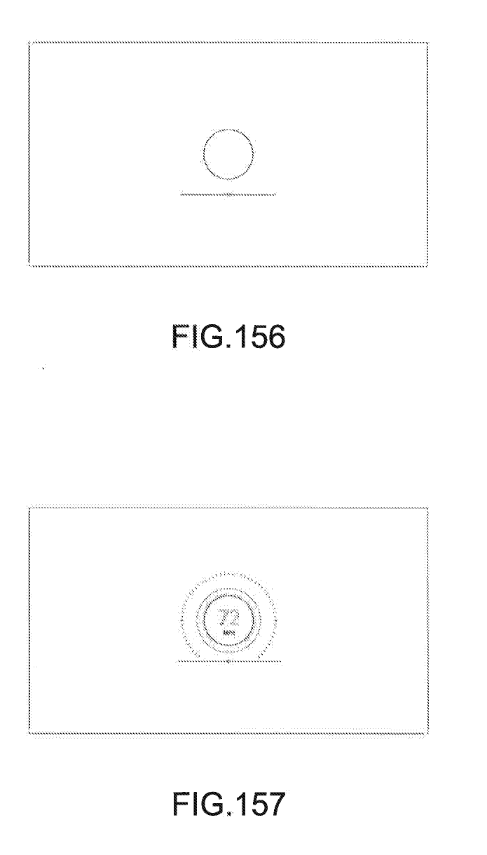

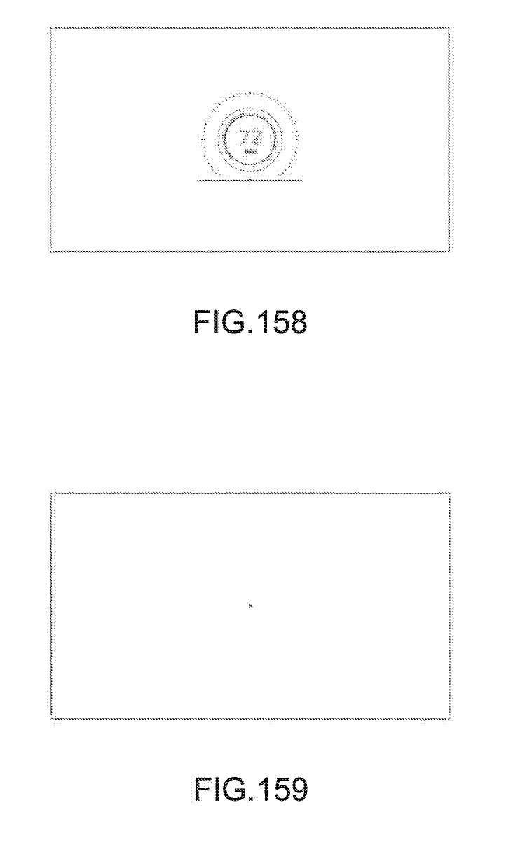

When the enlargement of the circle ends (FIG. 156), a display area surrounded with the circle is completed. Information of which the user should be notified is displayed in the display area (FIG. 157, FIG. 158). In the example shown in the figures is a speed (miles per hour).

When the enlargement of the circle ends (FIG. 156), the dot is separated from the line and moves downwards and new lines are pulled out of the dot to both the left and right horizontally and extend (FIG. 156). The two straight lines are both an example of the “second display element”.

Radially short lines are displayed surrounding the displayed circle (FIG. 157). The speed is digitally displayed in the display area inside the circle. In an indicator expressed by a plurality of short lines outside the circle, the speed is displayed in an analog manner (FIG. 158).

<Display Control Example 9>

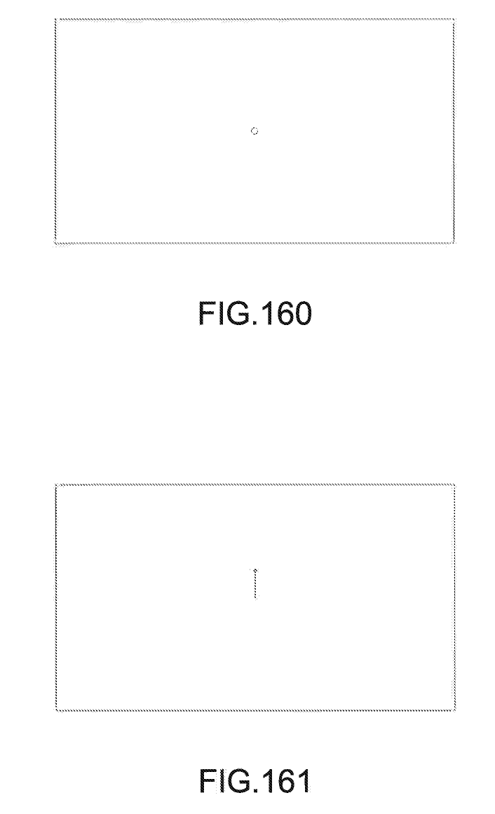

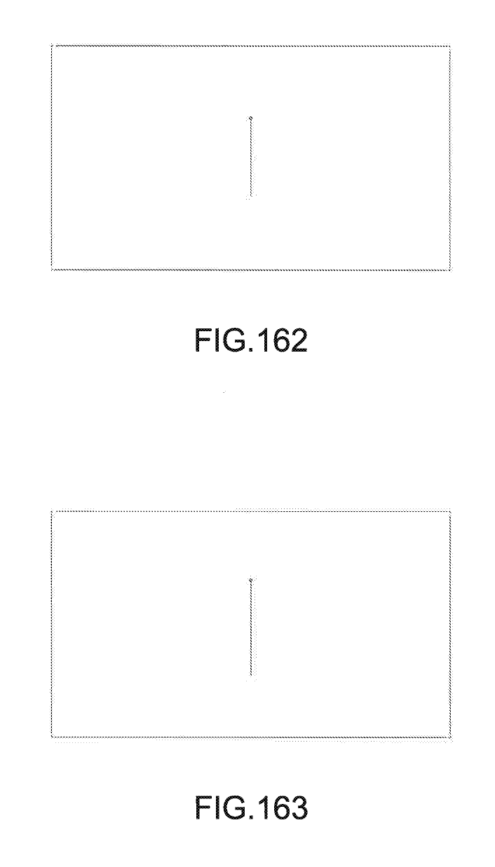

The display control apparatus 1 displays an animation that changes in the order from FIGS. 159 to 165. This animation is an example of the display control combining Display Control Pattern 1 and Display Control Pattern 3 above. Hereinafter, the animation will be described.

First of all, an animation in which a line (second display element) is pulled out of a dot (first display element) is displayed (FIG. 163). In FIG. 163, the line extends vertically downwards from the dot located at an upper center position.

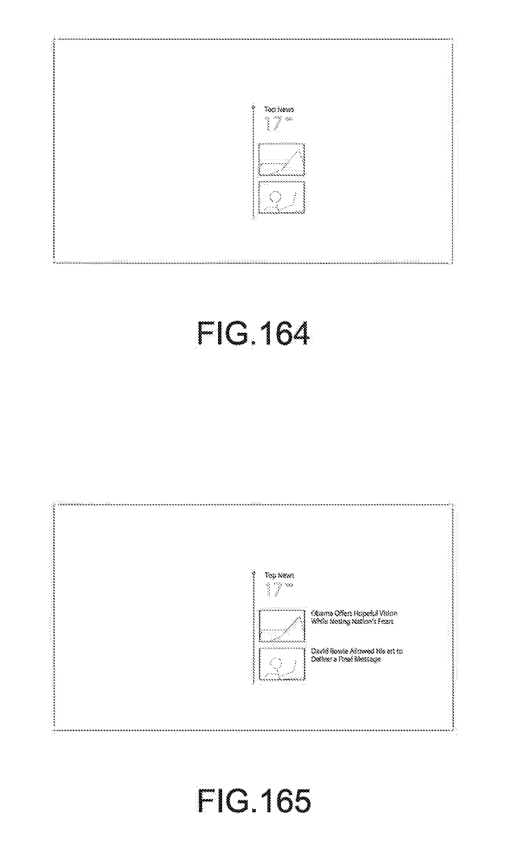

Next, information of which the user should be notified is displayed on one side of the line downwardly extending from the dot (FIG. 164). The display information shown in FIG. 164 and FIG. 165 is content (e.g., news and weather report).

Regarding the information of which the user should be notified, an icon, a photograph, and the like are first faded in and appear and catch the user's eyes (FIG. 164) and then descriptions are further faded in and appear next to the icon and the photograph and provide the user with more specific information (FIG. 165). Respective content items are aligned and arranged along the line downwardly extending from the dot (FIG. 164, FIG. 165).

<Display Control Example 10>

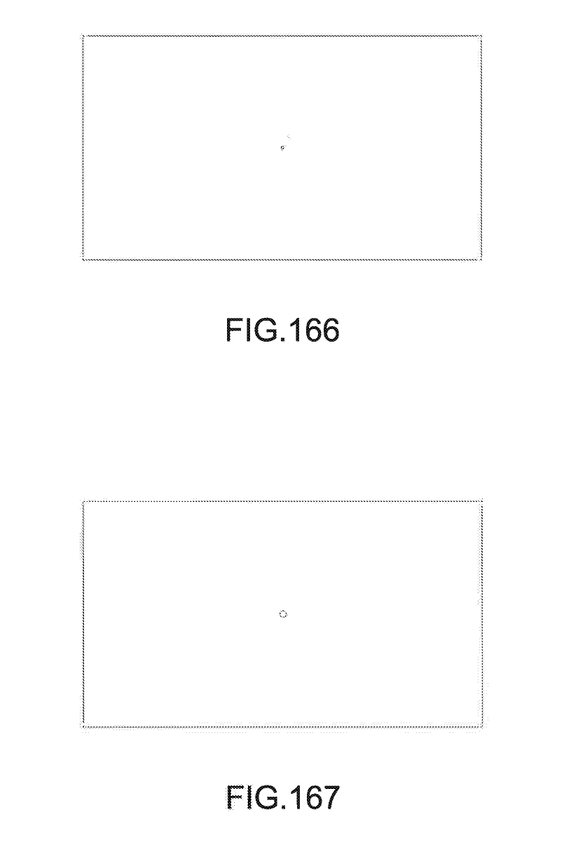

The display control apparatus 1 displays an animation that changes in the order from FIGS. 166 to 281. This animation is an example of the display control combining Display Control Pattern 1 and Display Control Pattern 3 above. Hereinafter, the animation will be described.

First of all, on a screen in an initial state, a dot (first display element) is faded in and displayed (FIG. 166). Next, the dot is enlarged (FIG. 167). While waiting for a trigger, contraction (FIG. 166) and enlargement (FIG. 167) of the dot are repeated.

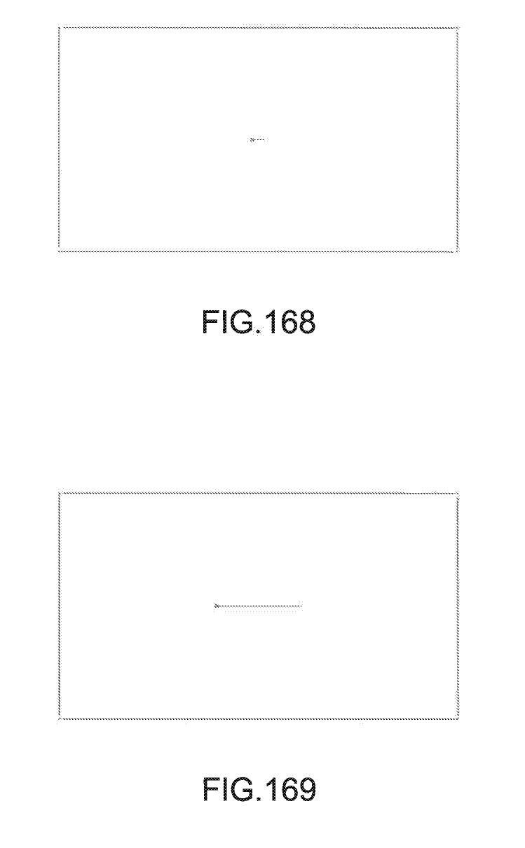

When a trigger (e.g., start of deformation of GUI) is recognized, an animation in which a line (second display element) is pulled out of the dot (first display element) is displayed (FIG. 168). In FIG. 168, the line extends to the right horizontally from the dot located at a center position.

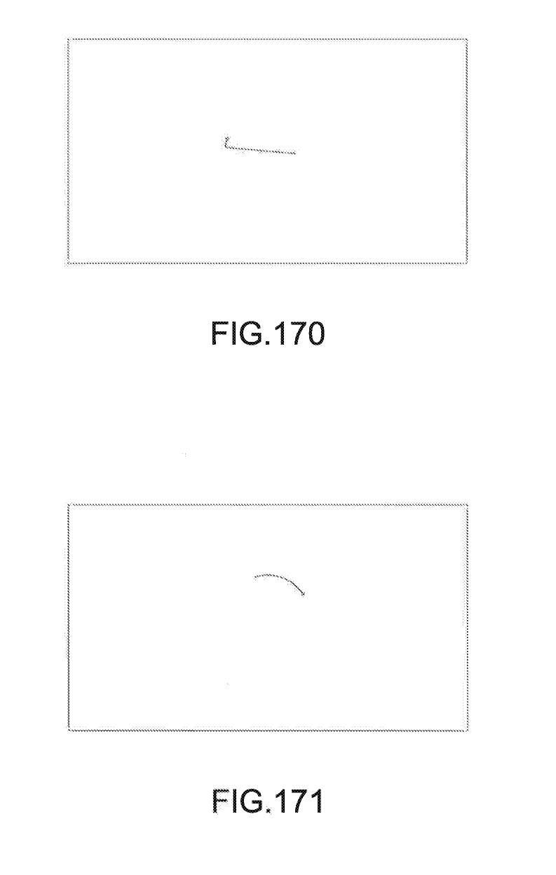

The dot moves to the left horizontally and the line also extends to the right horizontally (FIG. 169). The length of the line is limited. Once the line reaches a predetermined length, it does not extend anymore. The line pulled out of the dot follows the dot's movement while keeping a certain length (FIG. 170, FIG. 171).

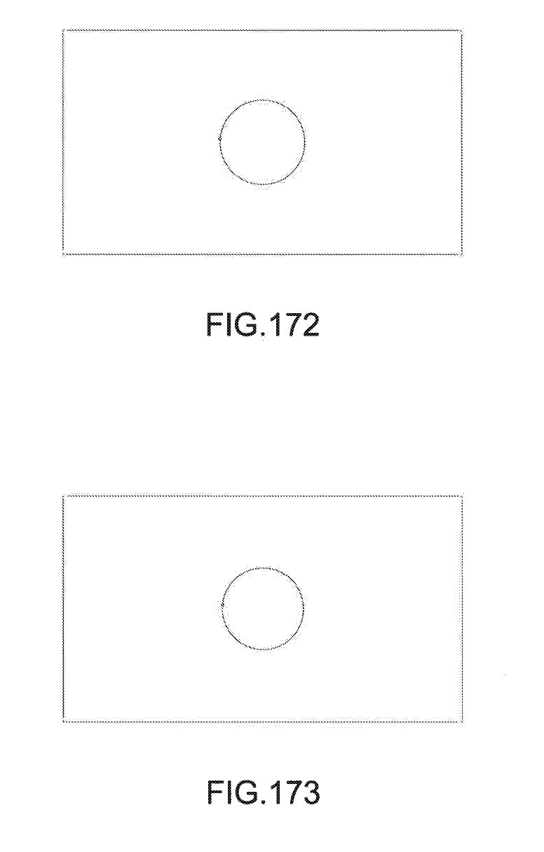

After the dot horizontally moves by a certain distance, it changes the direction of movement to draw a circumference (FIG. 170). The dot moves on the circumference (FIG. 171). Then, when the dot circulates once, the circle appears together with a fade-in animation (FIG. 172). This circle is a figure formed by the line (one example of second display element) pulled out of the dot. The area surrounded with this circle becomes a notification area of information of which the user should be notified.

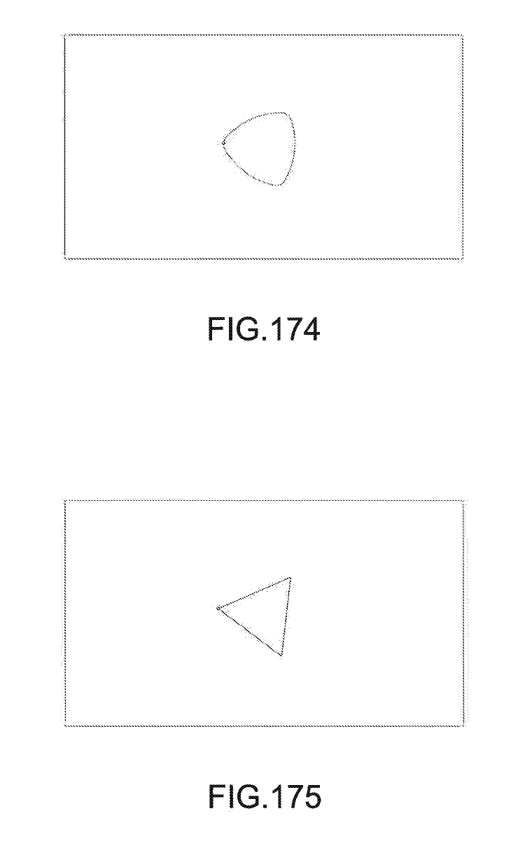

Next, the dot starts to move on the circumference (FIG. 173). When the dot stops at a certain point, the circle starts to be deformed (FIG. 174). The dot's shape (size) does not change and the shape of the figure formed by the line changes (FIGS. 174 to 179).

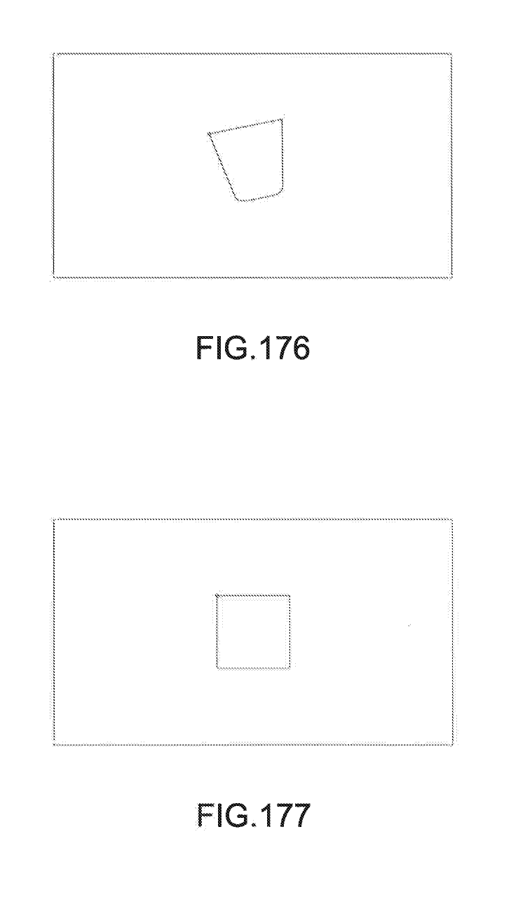

The circle starts to have corners formed (FIG. 174) and becomes an equilateral triangle (FIG. 175). Next, the corners of the equilateral triangle are gently deformed (FIG. 176) and deformed to have two round corners (FIG. 176). The two round corners are deformed to be right angles and the figure is deformed into a square (FIG. 177).

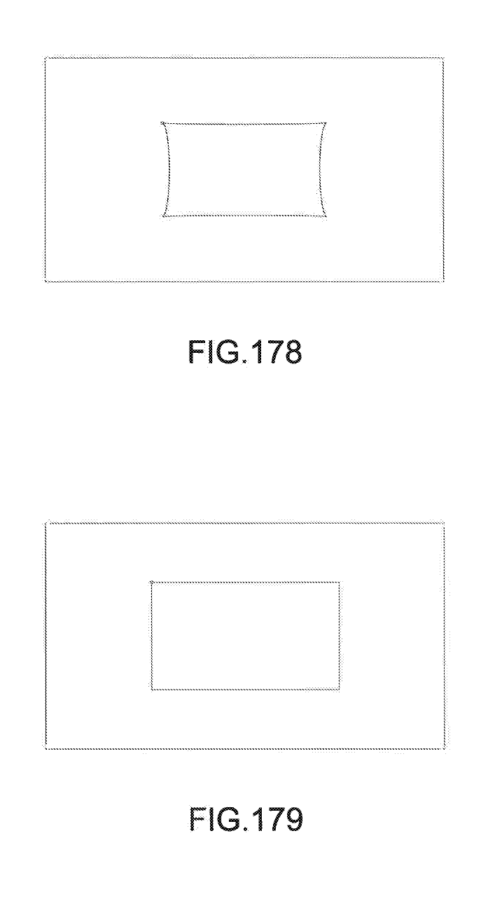

Next, an animation in which two opposed edges of the square linearly extend and the remaining two edges are warped is displayed (FIG. 178). Next, an animation in which the warped two edges become straight lines is displayed and the figure is deformed into a rectangle (FIG. 179).

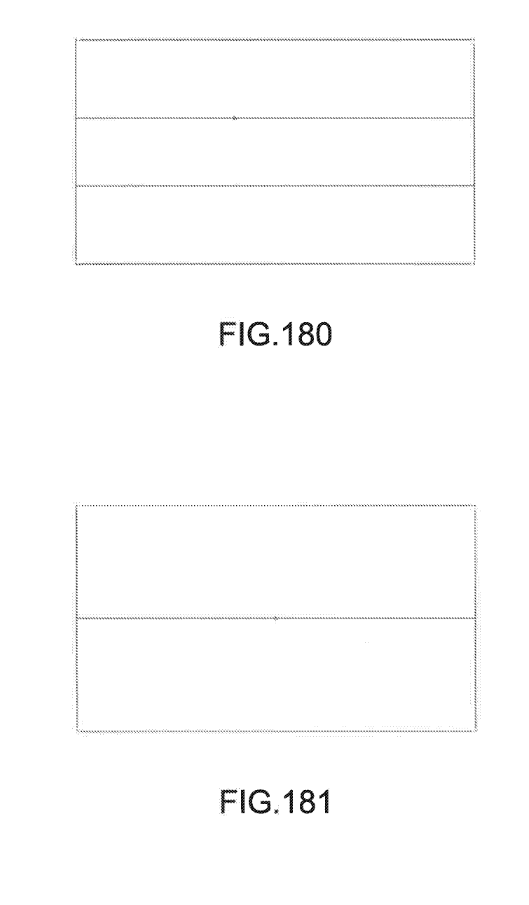

The linearly extending two edges continues to further extend and extend beyond both ends of the display screen (FIG. 180). When the figure formed by the line had a polygonal shape, the dot was at the corner of the polygon (FIG. 175, FIG. 177, FIG. 179). When the rectangle is deformed and the both ends disappear outside the displayable region, the dot moves from the position of the corner and moves on the straight line (FIG. 180). An animation in which two straight lines that had been originally the longer edges of the rectangle are integrated into one is displayed (FIG. 181).

<Display Control Example 11>

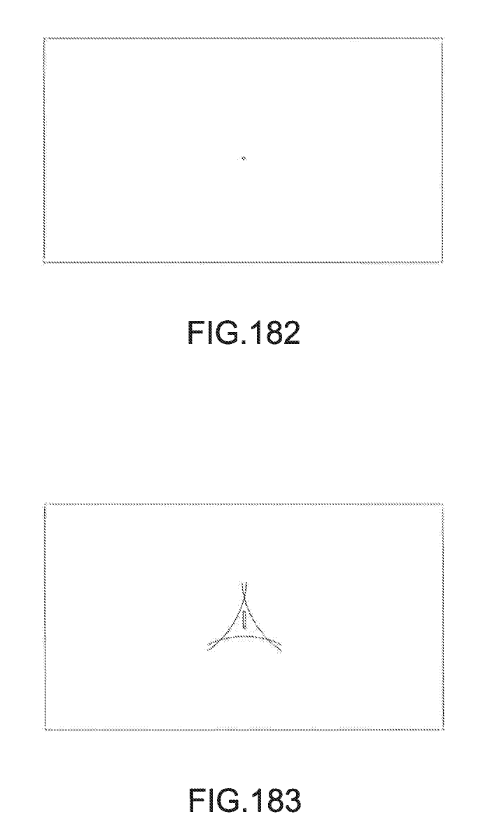

The display control apparatus 1 displays an animation that changes in the order from FIGS. 182 to 192. This animation is an example of the display control combining Display Control Pattern 1, Display Control Pattern 2, and Display Control Pattern 3 above. Hereinafter, the animation will be described.

First of all, on a screen in an initial state, a dot (first display element) is faded in and displayed (FIG. 182).

Next, three lines (second display element) radially spread from the dot (FIG. 183). The three lines are curves having the same length. Further, a thick line is displayed on the dot and an exclamation mark is formed (FIG. 183).

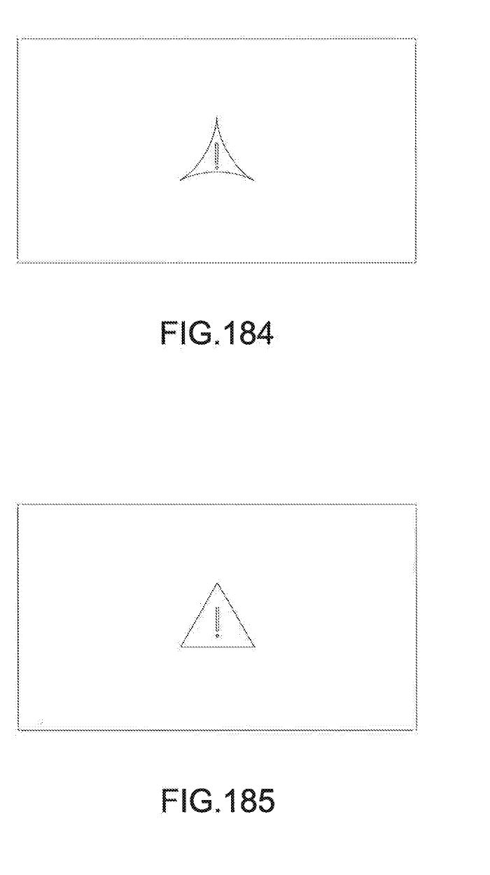

Next, the three lines spreading from the dot further spread, end points connect to one another, and a closed region is formed (FIG. 184). The exclamation mark displayed in FIG. 183 continues to be displayed within that closed region (FIG. 184).

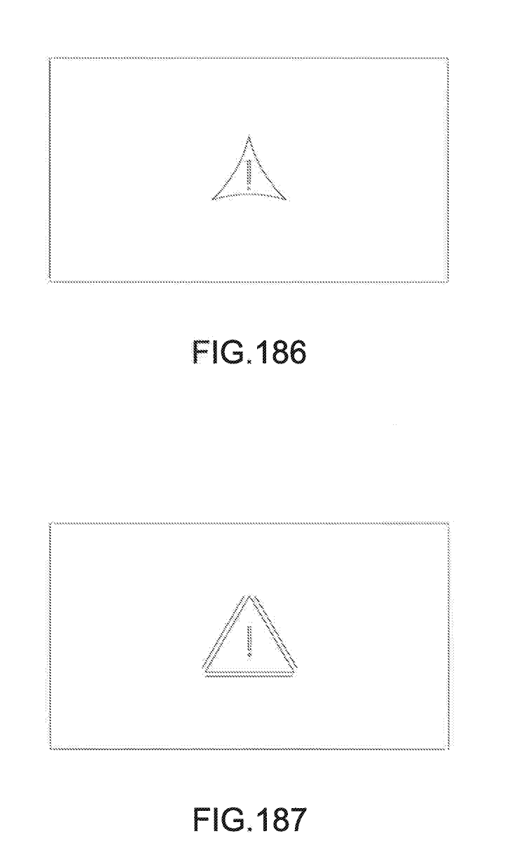

Next, the three curves become straight lines and the closed region of FIG. 184 forms an equilateral triangle (FIG. 185). An animation in which the respective edges of the equilateral triangle are temporarily depressed inwards (FIG. 186) and return to the shape of the original equilateral triangle is displayed (FIG. 187).

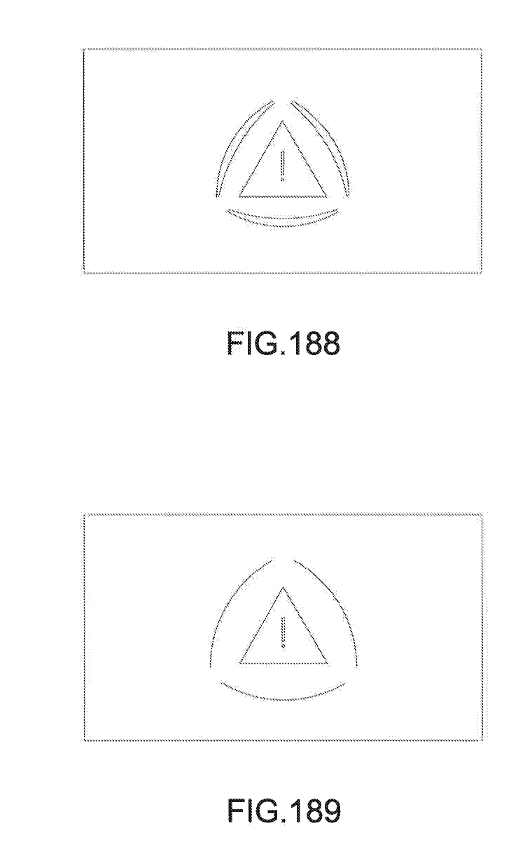

When the respective edges of the equilateral triangle are depressed (FIG. 186) and return to the shape of the original equilateral triangle (FIG. 187), the respective edges are copied to appear double (FIG. 187). The copied respective edges are deformed into point-symmetric figures having a center that is a center of a circumscribed circle or an inscribed circle of the equilateral triangle (FIG. 188) and faded out toward the outside (FIG. 189). The animation of FIGS. 185 to 189 is repeatedly displayed. The animation shown in FIGS. 185 to 189 is used in a case where there is information (caution) about which user's attention should particularly be called.

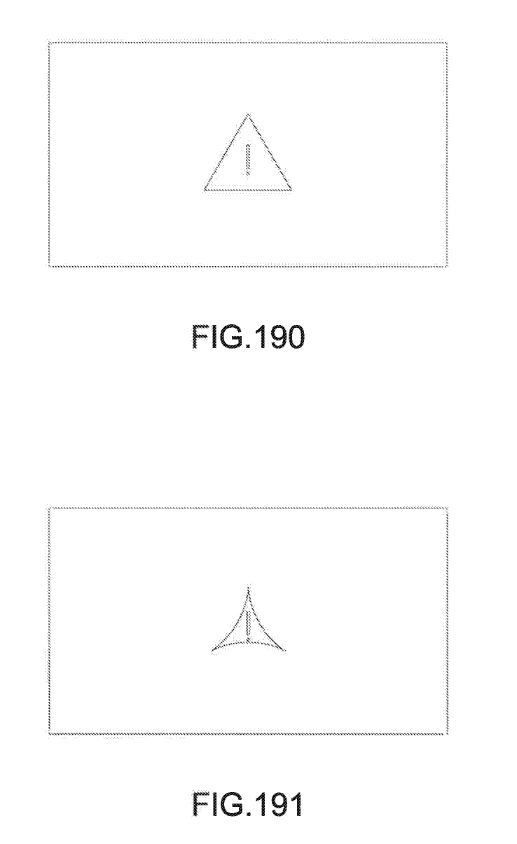

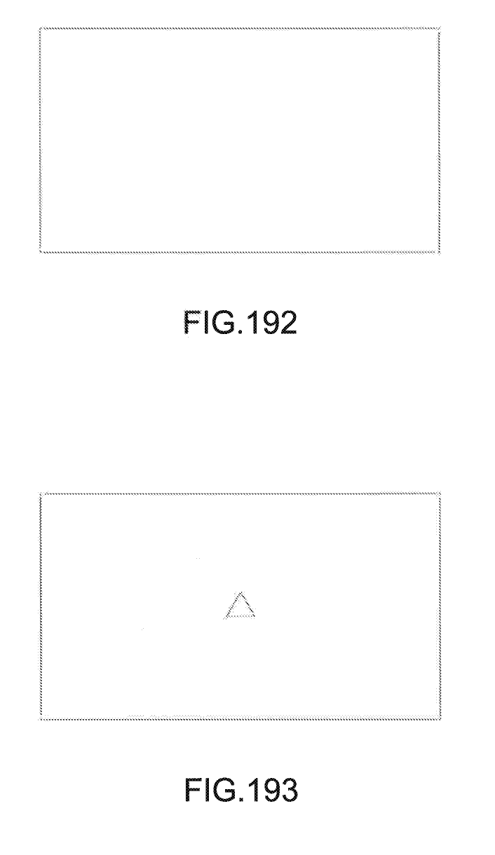

Next, when a trigger (e.g., end of caution) is recognized, the animation in which the lines pulse stops (FIG. 190) and the respective edges contract (FIG. 191). The dot and the line disappear and the initial state is displayed again (FIG. 192).

<Display Control Example 12>

The display control apparatus 1 displays an animation that changes in the order from FIGS. 193 to 201. This animation is an example of the display control combining Display Control Pattern 1, Display Control Pattern 2, and Display Control Pattern 3 above. Hereinafter, the animation will be described.

First of all, a polygon constituted by lines is displayed (FIG. 193). In FIG. 193, a triangle is displayed and it can be distinguished as a caution (precautions for user) only with the shape.

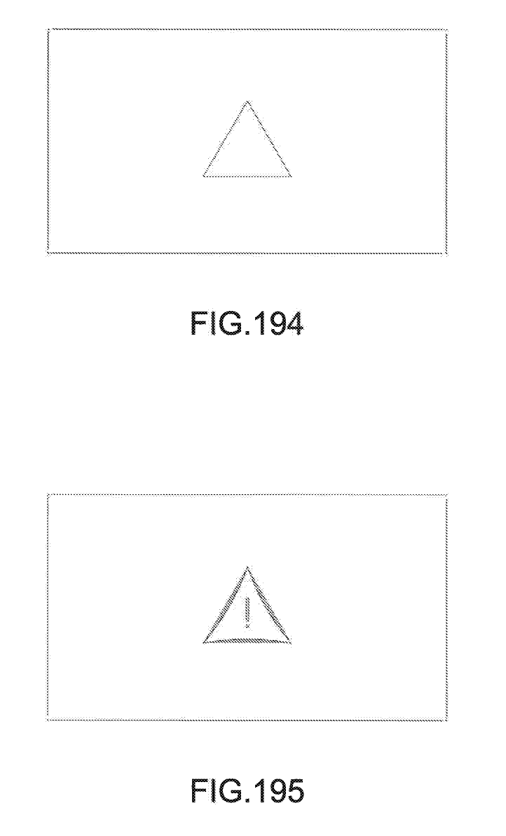

Next, the triangle is enlarged (FIG. 194). When the triangle reaches a predetermined size, the enlargement stops (FIG. 194). An exclamation mark is displayed in a display area inside the triangle (FIG. 195). Along with it, the lines that constitute the triangle are displayed as double lines or a plurality of lines (FIG. 195). A dot (first display element) is displayed as a part of the exclamation mark.

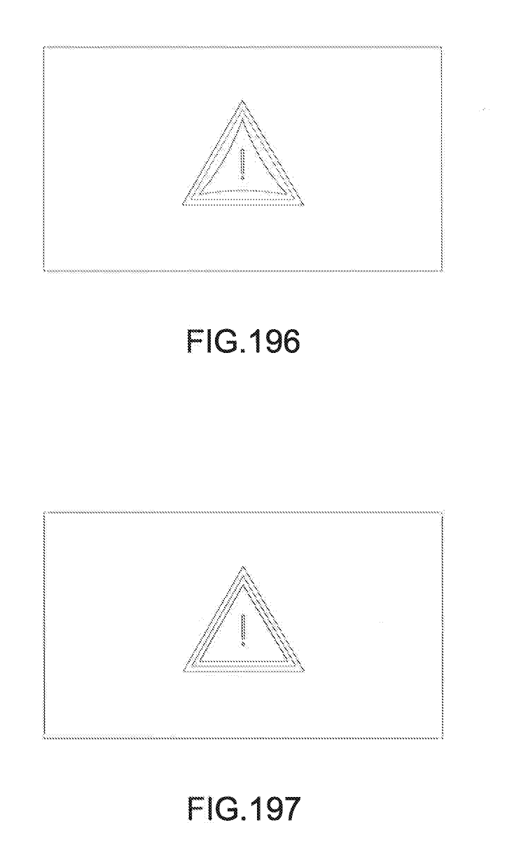

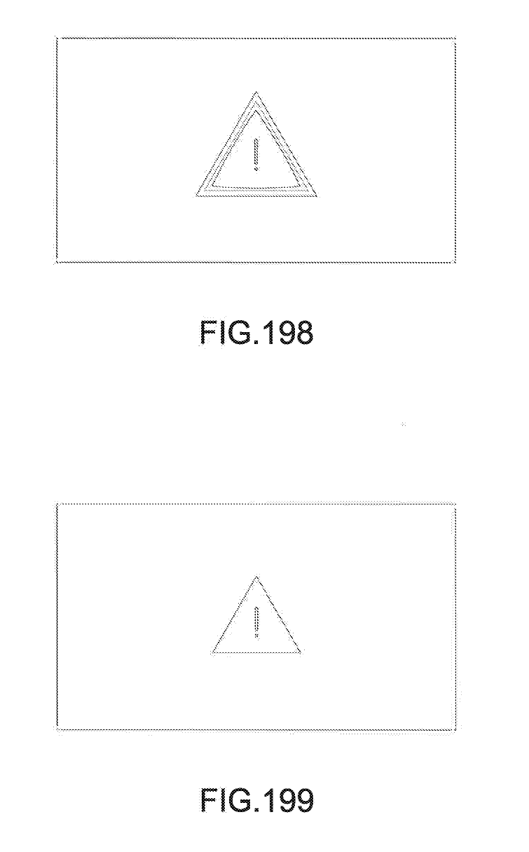

Next, the triangle is enlarged and expands (FIG. 195, FIG. 196, FIG. 197, FIG. 198). During expansion, the triangle having a size before expansion is copied and remains for a while keeping its size. By repeating this, the respective triangles are successively faded out from an inner triangle toward an outer triangle.

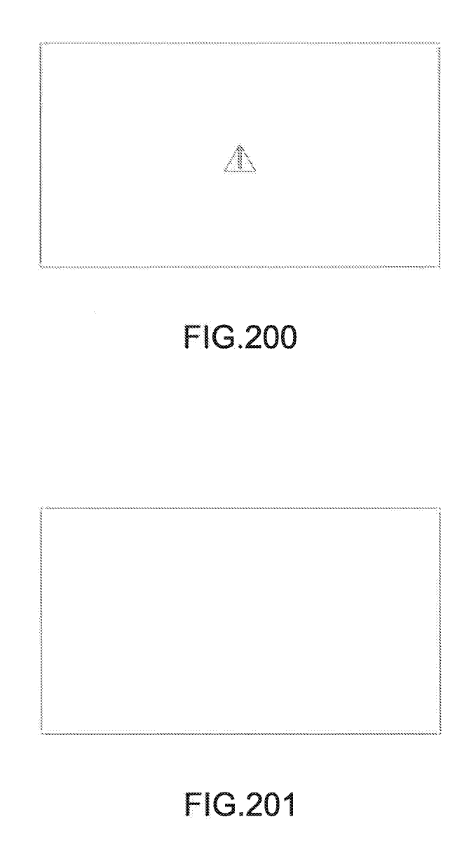

Next, when a trigger (e.g., end of notification) is recognized, the triangle starts to contract (FIG. 199) and contracts to be integrated into a single point (FIG. 200). Finally, the GUI constituted by the dot and the lines disappears and the initial state is displayed on the screen again (FIG. 201).

<Display Control Example 13>

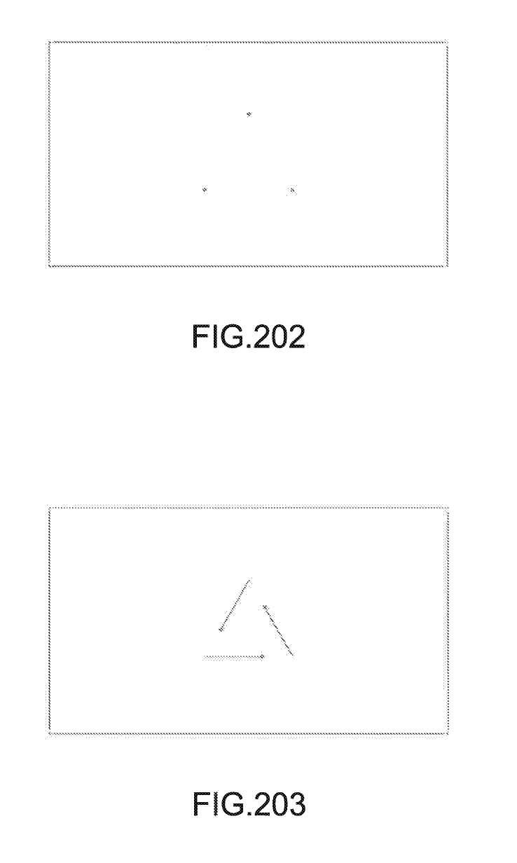

The display control apparatus 1 displays an animation that changes in the order from FIGS. 202 to 210. This animation is an example of the display control combining Display Control Pattern 1, Display Control Pattern 2, and Display Control Pattern 3 above. Hereinafter, the animation will be described.

First of all, on a screen in an initial state, a plurality of dots (first display element) are faded in and displayed (FIG. 202). In FIG. 202, three dots are displayed. The three dots are arranged at positions that forms an equilateral triangle when connected to one another with lines.

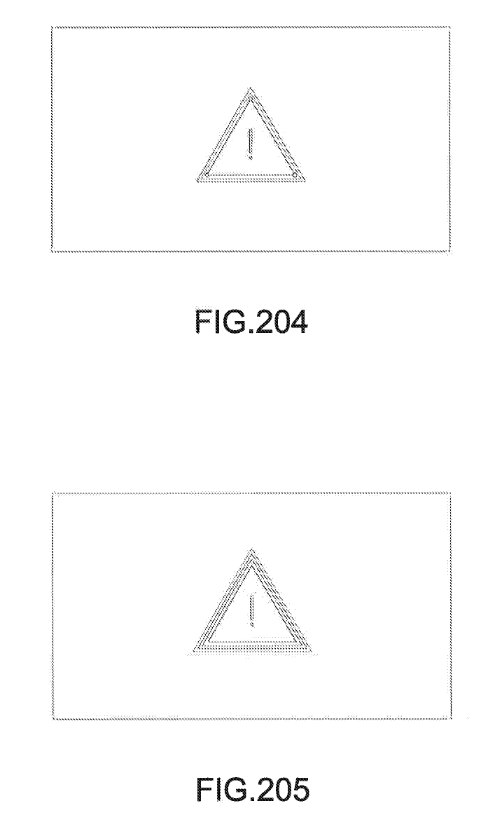

Next, an animation in which each dot moves and a line (second display element) is pulled out of each dot is displayed (FIG. 203). In such a manner that each dot moves and the line is pulled out of each of them, the equilateral triangle is drawn (FIG. 204).

A region surrounded with the equilateral triangle formed by the lines pulled out of the dots becomes the display area. An exclamation mark is displayed in the display area (FIG. 204). The exclamation mark is constituted by a dot and a bar extending thereabove (FIG. 204).

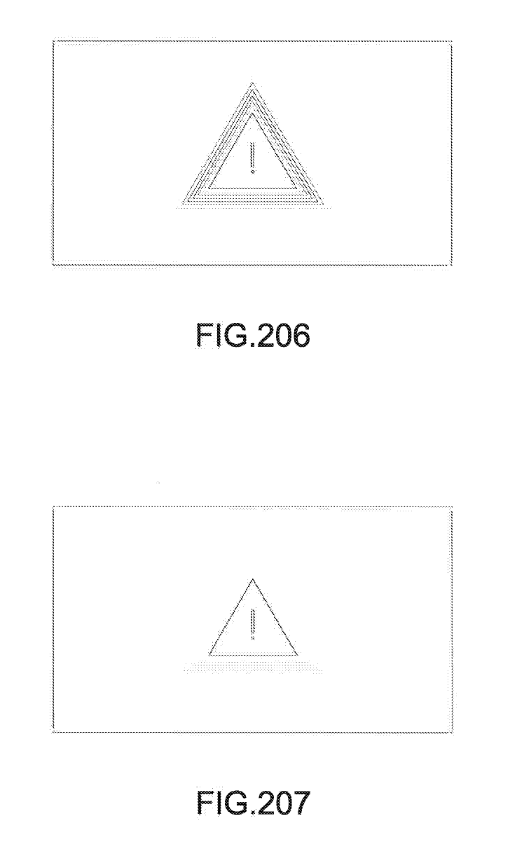

The equilateral triangle is copied and an animation in which the copied equilateral triangle is enlarged is displayed (FIG. 204, FIG. 205, FIG. 206). The processes of copying and enlarging are repeated, and hence a plurality of equilateral triangles having different sizes are displayed around the original equilateral triangle (FIG. 204, FIG. 205, FIG. 206). The dot (FIG. 204) displayed at the top of the equilateral triangle disappears (FIG. 205).

The enlargement of the copied equilateral triangles stops when it reaches a predetermined size (FIG. 206). When the enlargement of the largest triangle stops, the enlargement of the other triangles also stops (FIG. 206).

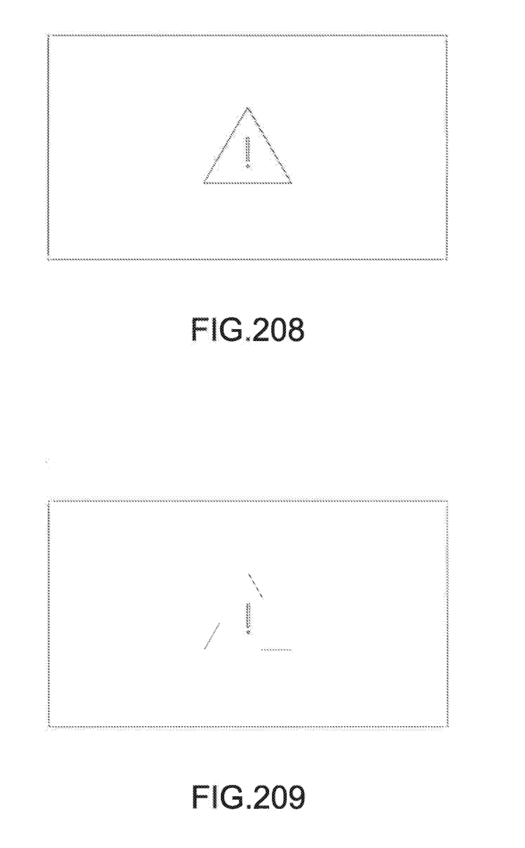

Next, an animation in which the copied equilateral triangles excluding the original equilateral triangle are faded out is displayed (FIG. 207, FIG. 208).

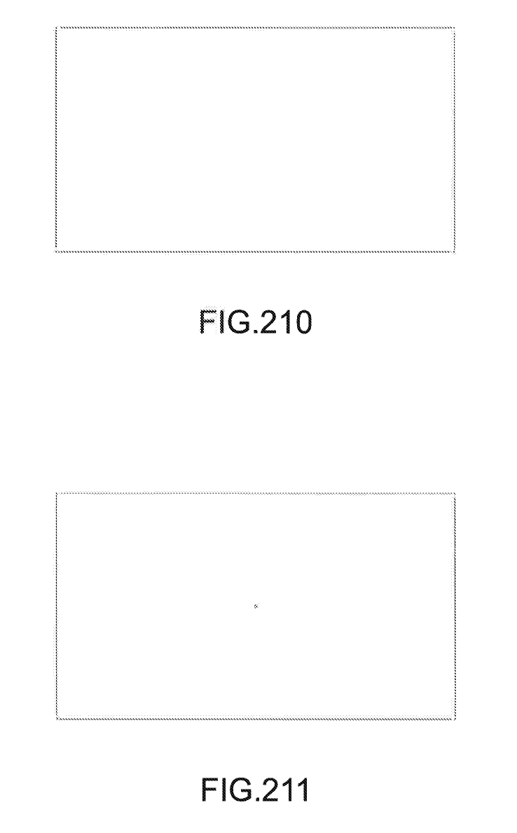

Next, the original equilateral triangle is dissolved (FIG. 209). Although the display information within the display area remains for a while (FIG. 209), the GUI constituted by the dot and the lines all disappears finally and the initial state is displayed on the screen again (FIG. 210).

<Display Control Example 14>

The display control apparatus 1 displays an animation that changes in the order from FIGS. 211 to 223. This animation is an example of the display control combining Display Control Pattern 1, Display Control Pattern 3, and Display Control Pattern 4 above. Hereinafter, the animation will be described.

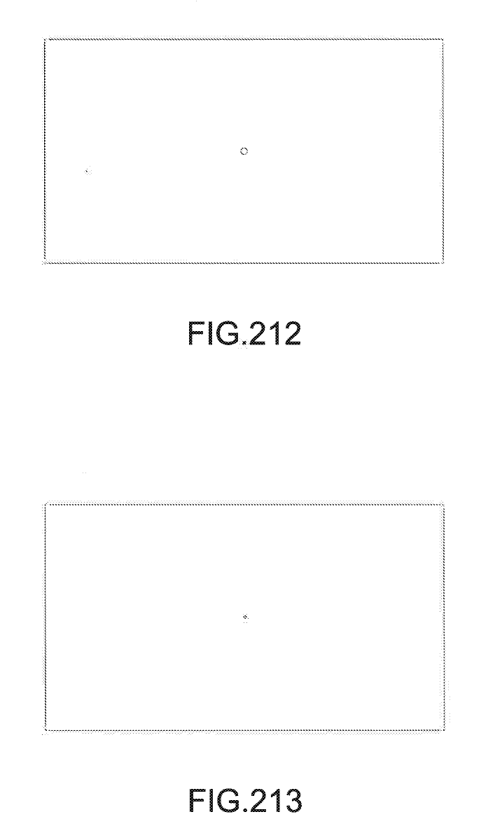

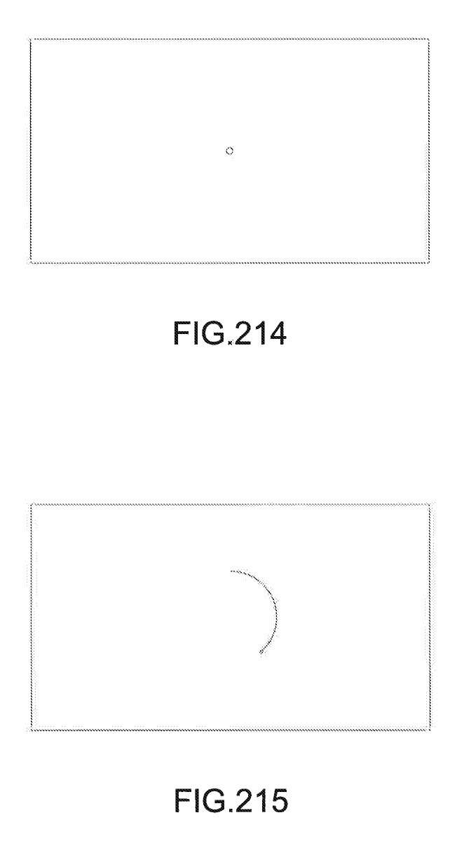

First of all, on a screen in an initial state, a dot (first display element) is faded in and displayed (FIG. 211). Next, the dot is enlarged (FIG. 212). While waiting for a trigger, contraction and enlargement of the dot are repeated (FIG. 211, FIG. 212, FIG. 213, FIG. 214).

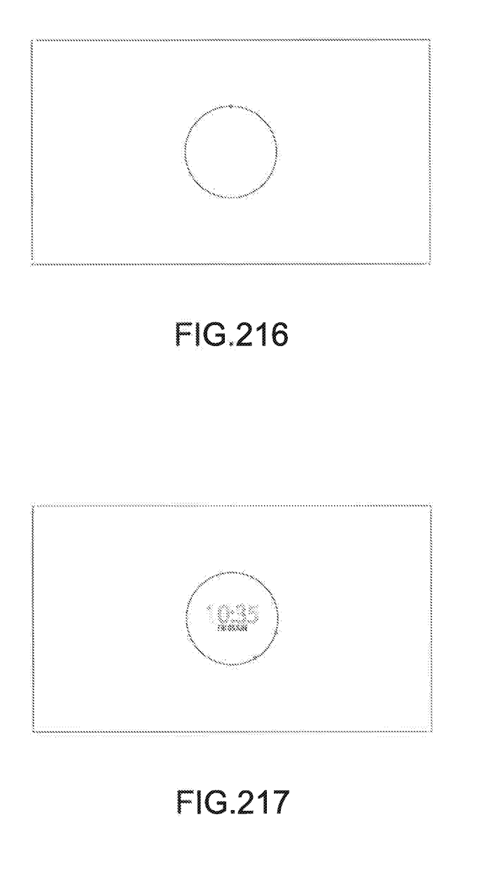

Next, an animation in which a line (second display element) spreads from the dot is displayed (FIG. 215). A figure formed by the line has a circular shape (FIG. 216). The dot is positioned at a point on the line (on circumference) (FIG. 216).

The information, of which the user should be notified, is displayed in the display area surrounded with the circle to the user (FIG. 217). The example shown in the figures is time information. The dot is split and two dots move on the circumference (FIG. 217) while at the same time the information is displayed in the display area.

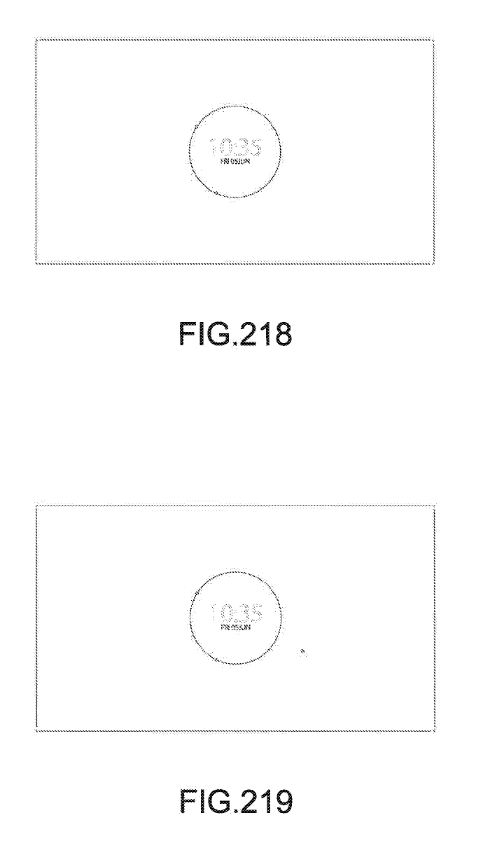

The time is digitally expressed in the display area within the circumference and is expressed by the two dots on the circumference in an analog manner (FIG. 218).

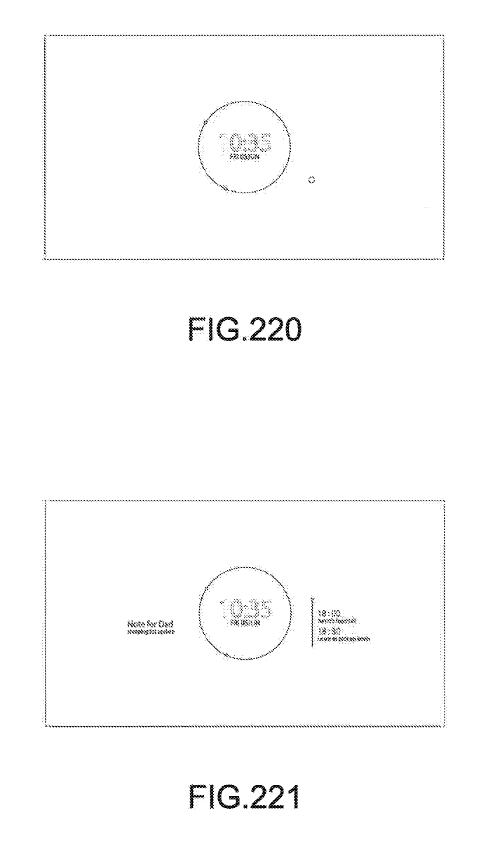

Next, another (third) dot is faded in and displayed (FIG. 219). The third dot is momentarily enlarged (FIG. 220). The third dot appears in a lower right portion outside a clock GUI expressed by the line and the dots (FIG. 219) and moves upwards (FIG. 221). Upon movement of the third dot, a line is pulled out of this dot (FIG. 221). Information of which the user should be notified is displayed on one side (right-hand side) of this line (FIG. 221). The example shown in the figures is schedule information regarding a user's schedule.

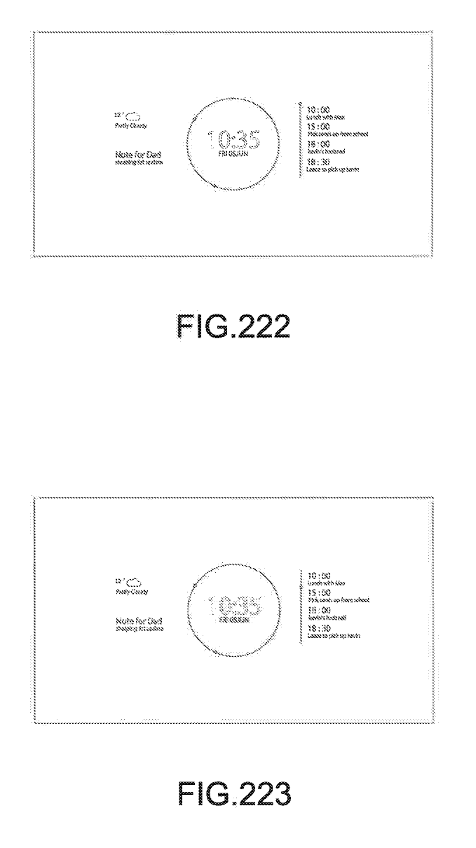

The notification information to the user is displayed on a left-hand side of the clock GUI expressed by the line and the dots (FIG. 221). The display is accompanied with a fade-in animation (FIG. 221). Weather information is further displayed on an upper side of the display area of the notification information to the user (FIG. 222). The display area of the weather information is stacked on the display area of the notification information to the user (FIG. 222).

The line pulled out of the third dot, which is shown in FIG. 221, functions as a slider expressing a lapse of time. Therefore, the third dot moves on this slider over time (FIG. 223).

<Display Control Example 15>

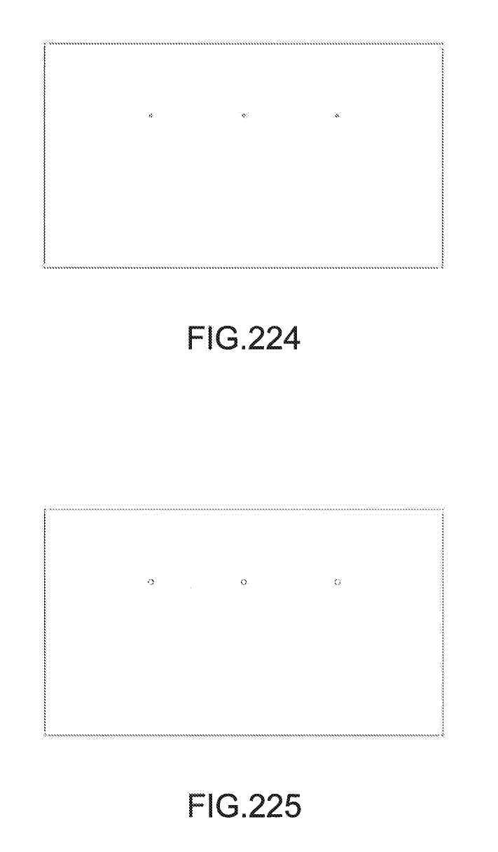

The display control apparatus 1 displays an animation that changes in the order from FIGS. 224 to 232. This animation is an example of the display control of Display Control Pattern 1 above. Hereinafter, the animation will be described.

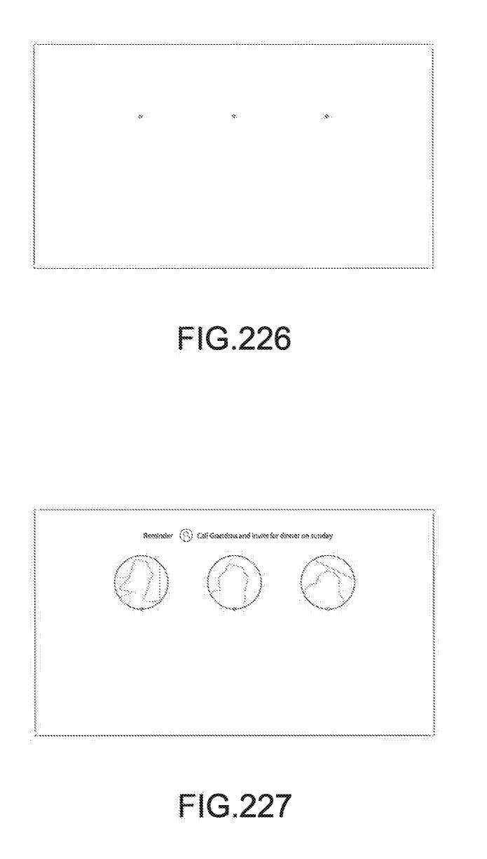

First of all, on a screen in an initial state, three dots (first display element) are faded in and displayed (FIG. 224). Next, each dot is enlarged (FIG. 225) and reduced in size (FIG. 226).

Next, a line (second display element) is pulled out of each dot and forms a circle (FIG. 227). The dot is on the circumference of each circle (FIG. 227). A display area of information of which the user should be notified is formed inside of each circle. The example shown in the figures is icons of call targets (FIG. 227).

The GUIs expressed by lines and dots shown in the figure is reminder application software including an interface to a call application. The display area of information of which the user should be notified is formed above the GUIs expressed by the lines and the dots (FIG. 227).

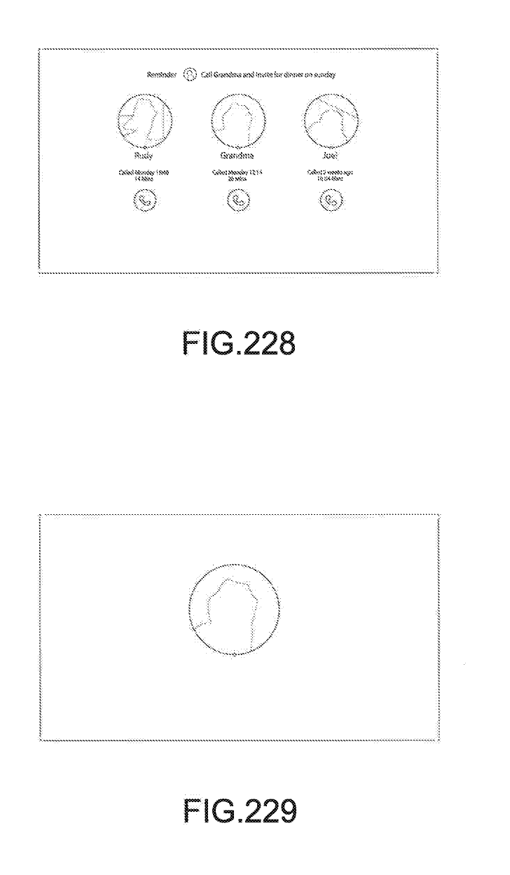

Next, more specifically, information of each of the call targets is displayed below each circle (FIG. 228). Subsequently, an icon for explicitly instructing an action to “call” is displayed below the information of the call targets (FIG. 228).

When a trigger of user's selection of any of the icons is recognized, the others excluding the circle formed by the line and the dot, which corresponds to this icon, disappear (FIG. 229). The remaining circle is enlarged and displayed (FIG. 229).

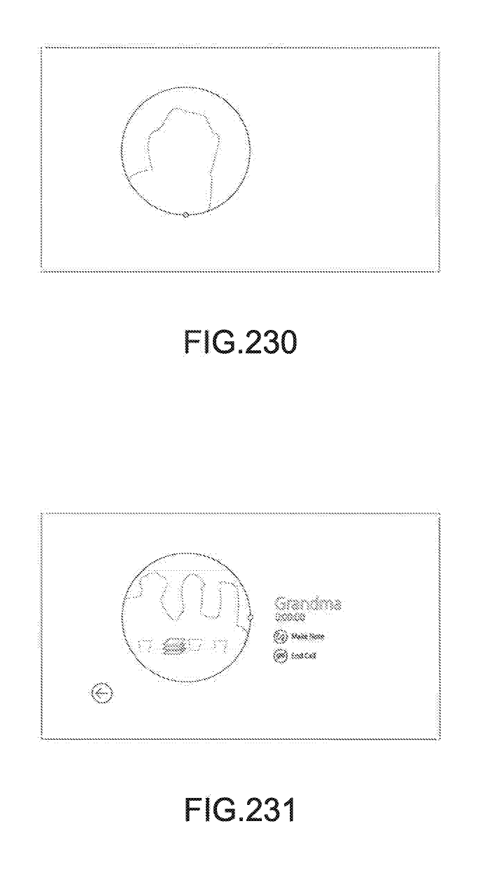

Next, the circle constituted by the line and the dot moves to the left on the screen (FIG. 230). At this time, the dot is located at a lower position of the circumference (FIG. 230). Next, the dot moves to the right on the circumference (FIG. 231). Then, information is displayed in a space generated on a right-hand side of the screen due to the movement of the circle (FIG. 231).

In the display area within the circle, information (photograph showing called person) associated with the information (called person) selected in FIG. 228 is displayed (FIG. 230, FIG. 231). Due to the display of the new information, the associated information changes (FIG. 231). In FIGS. 228 to 230, it is the photograph showing only the face of the called person. Meanwhile, in FIG. 231 in which the new information is displayed, the photograph including the called person has changed.

As the information displayed on the right-hand side of the screen, GUIs of a talk time with the called person, buttons for operating the call application, and the like are displayed (FIG. 231). Further, on the screen on which the GUIs of the call application are displayed, a button for returning to a state before calling, in other words, for terminating the application is displayed at a lower left position outside the circle (FIG. 231).

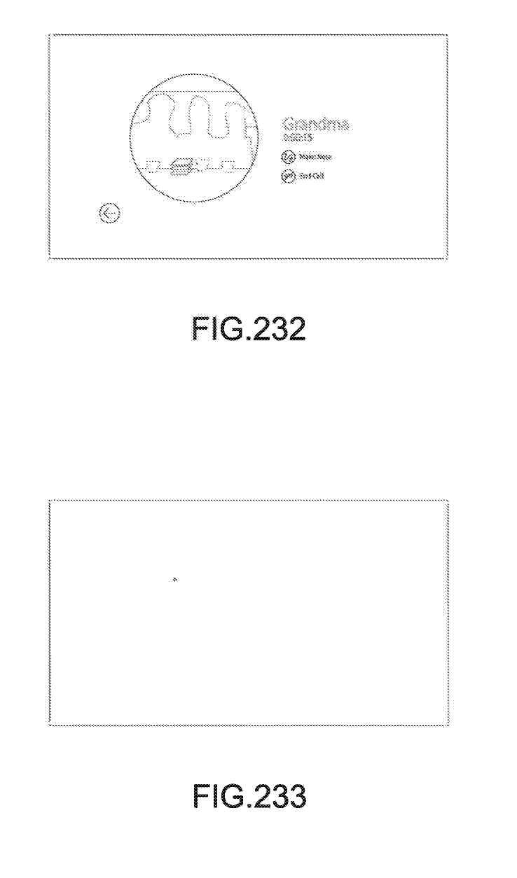

When the user starts to call a call destination through the use of the call application, the dot on the circumference temporarily disappears (FIG. 232).

<Display Control Example 16>

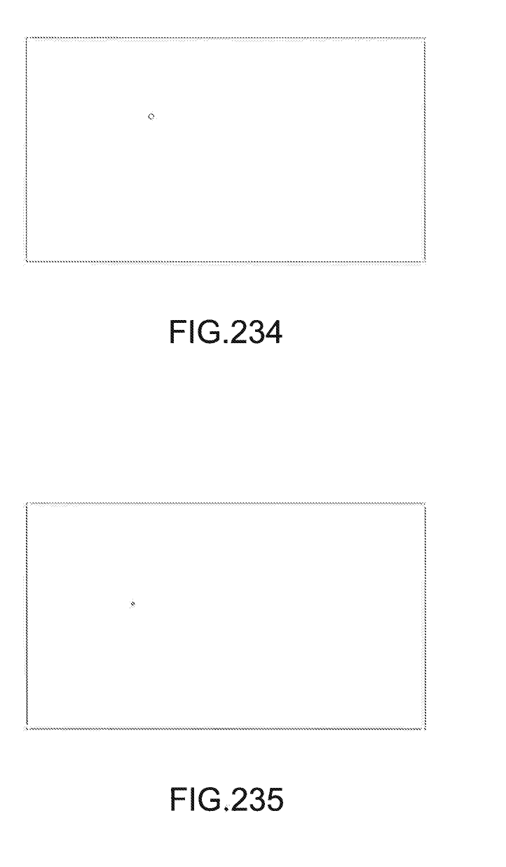

The display control apparatus 1 displays an animation that changes in the order from FIGS. 233 to 238. This animation is an example of the display control of Display Control Pattern 1 above. Hereinafter, the animation will be described.

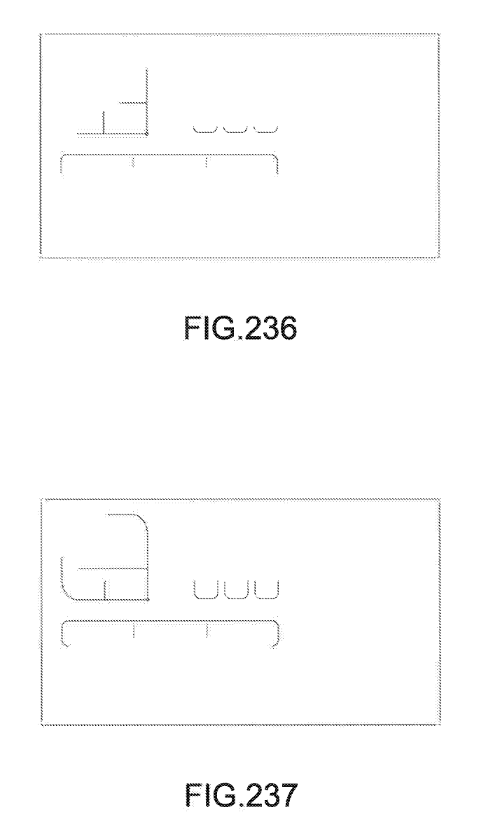

First of all, on a screen in an initial state, a dot (first display element) is faded in and displayed (FIG. 233). Next, the dot is enlarged (FIG. 236) and reduced in size (FIG. 237).

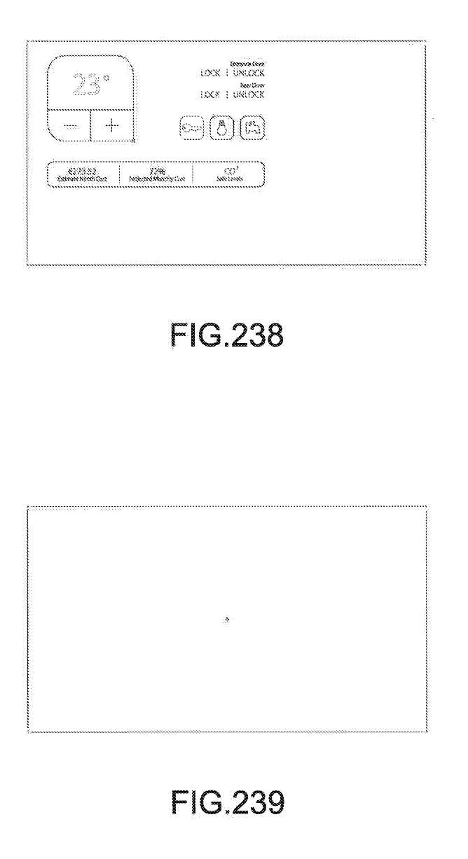

Next, lines (second display element) are pulled out of the dot (FIG. 236). In this example, dots are also pulled out of a space having no dots while at the same time the lines are pulled out of the dot (FIG. 236). The lines branch and extend (FIG. 236, FIG. 237). The branching lines are combined and become a frame of the display area (FIG. 237, FIG. 238).

The space surrounded with the lines becomes a display area in which information of which the user should be notified is displayed (FIG. 238). Pieces of information are also displayed outside the space surrounded with the lines. They are aligned along a straight line extended from the straight line that forms the outer line frame (FIG. 238).

The information within the display area is a GUI of a controller of a so-called “information home appliance” obtained by applying an information communication technology to a home appliance used in a home (FIG. 238).

<Display Control Example 17>

The display control apparatus 1 displays an animation that changes in the order from FIGS. 239 to 257. This animation is an example of the display control of Display Control Pattern 1 above. Hereinafter, the animation will be described.

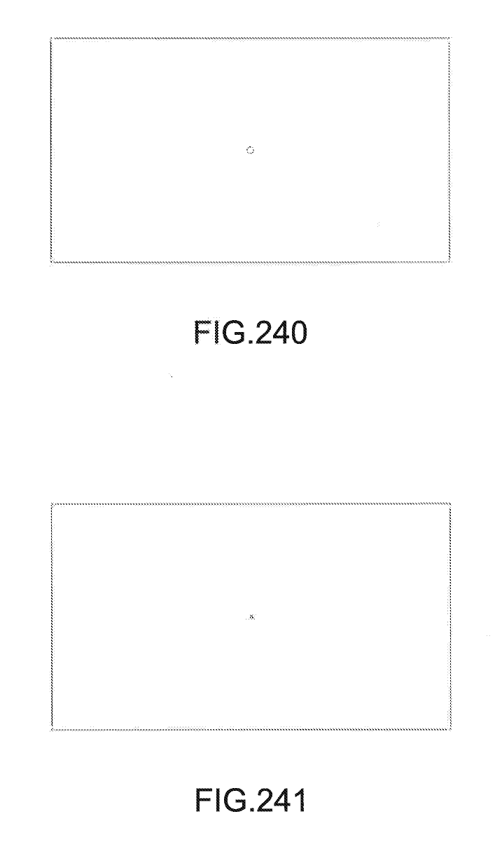

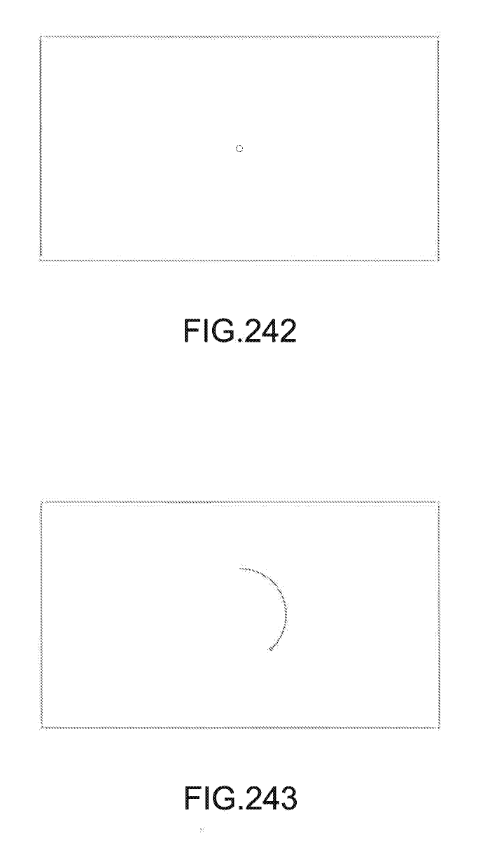

First of all, on a screen in an initial state, a dot (first display element) is faded in and displayed (FIG. 239). Next, the dot is enlarged (FIG. 240). While waiting for a trigger, contraction and enlargement of the dot are repeated (FIG. 239, FIG. 240, FIG. 241, FIG. 242).

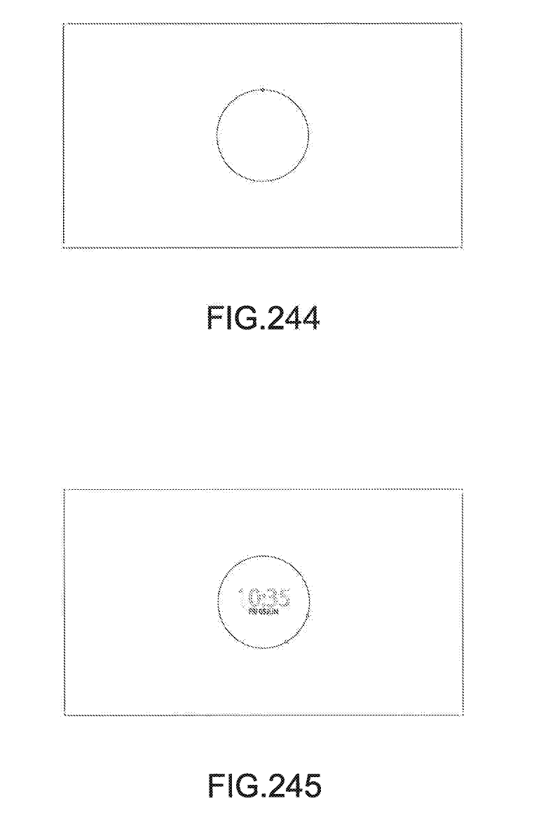

Next, an animation in which the line (second display element) is pulled out of the dot is displayed (FIG. 243). The dot circulates once while drawing a circle (FIG. 244). The movement trajectory of the dot is expressed by a line (FIG. 244). The dot stops at a point on the line (on circumference) (FIG. 244).

The dot is split into two dots (FIG. 245). The two dots move on the circumference (FIG. 245). The time is displayed through digital expression in the display area within the circle (FIG. 245).

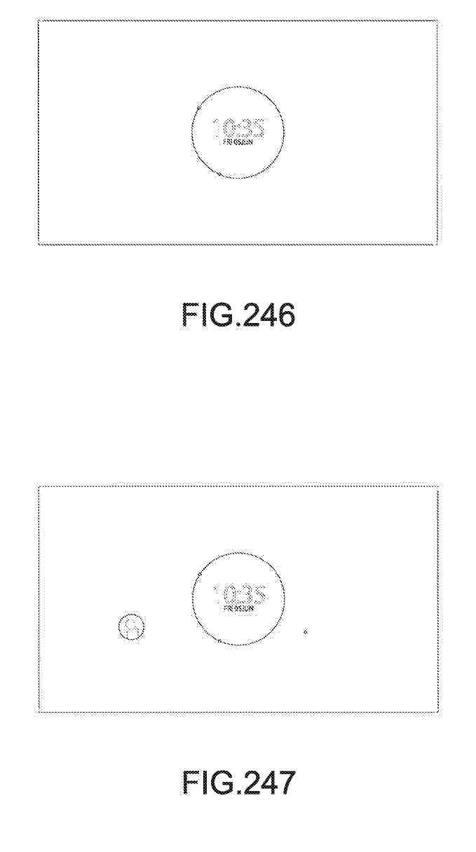

The two dots move on the circumference in a clockwise direction and stop at a position indicated by two hands if the time is expressed by the analog expression (FIG. 246).

Next, a third dot is faded in and appears at a lower right position outside the circle (FIG. 247). Further, an icon associated with a notification matter to the user from the display control apparatus 1 appears at a lower and left position outside the circle (FIG. 247).

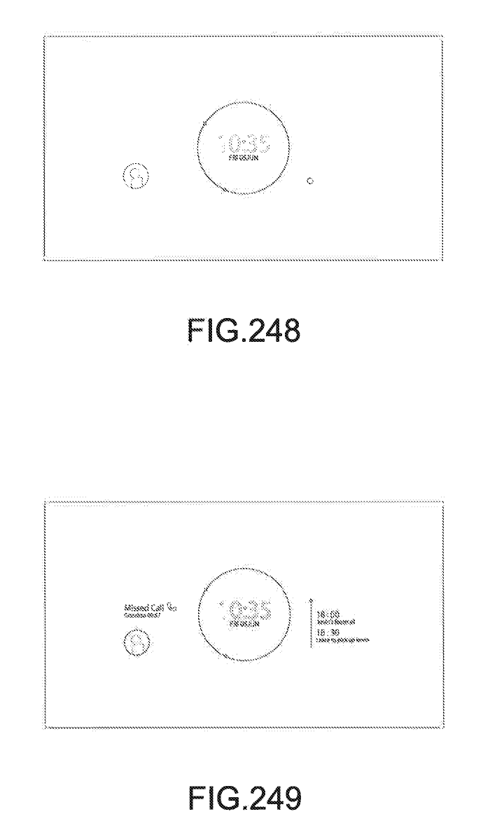

Next, an animation in which the appearing third dot is enlarged is displayed (FIG. 248). Due to the enlargement of this dot, a so-called “eye catching” effect is provided.

Next, the third dot returns to a normal size and moves upwards (FIG. 249). A line is downwardly pulled out of the third dot (FIG. 249). The pieces of schedule information appear, aligned on one side (right-hand side) of that line (FIG. 249).

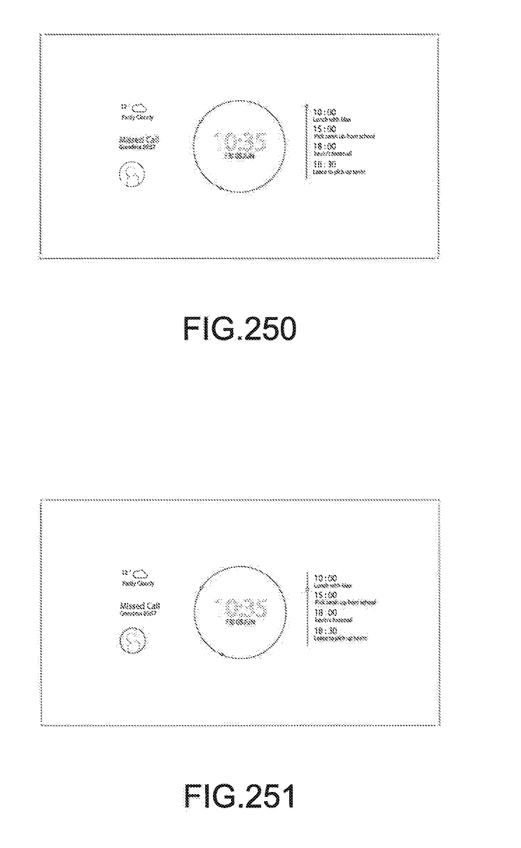

As the dot further moves upwards, the number of pieces of displayed schedule information increases (FIG. 250). Further, the number of notification matters to the user that are displayed on a left-hand side of the circle also increases (FIG. 250). The notification matters to the user are displayed, stacked to the top from the bottom (FIG. 250).

Regarding the screen that displays the notification matter to the user and the pieces of schedule information of the user, the display starts from FIG. 248 and transitions to the full-screen display of FIG. 250 through the display of FIG. 249.

When the user moves the third dot downwards, a piece of schedule information corresponding to the position of that third dot is highlighted or becomes clickable (FIG. 251).

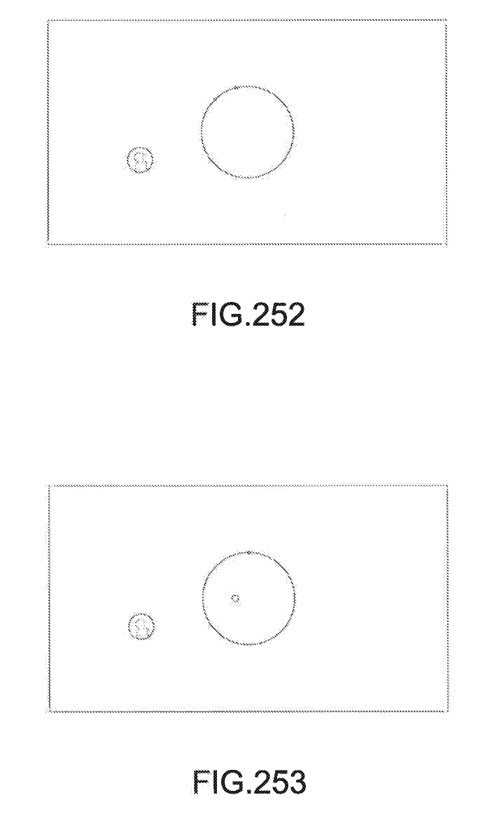

When the user taps a notification matter to the user which is associated with the icon, the other pieces of information excluding that icon, the circle, and the two dots on the circumference disappear (FIG. 252).

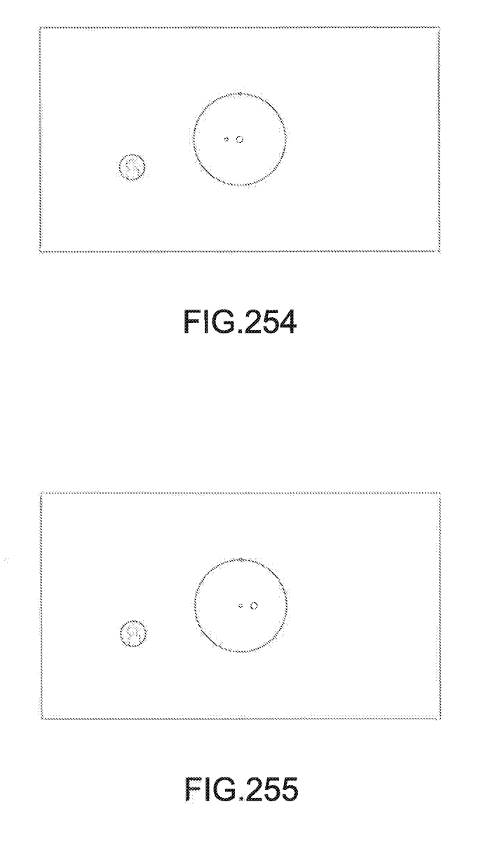

This icon instructs an action of calling. One of the two dots enters the circle (FIG. 253). The dot inside the circle is enlarged and moves to the left and right within the circle, leaving an afterimage (FIG. 253, FIG. 254, FIG. 255).

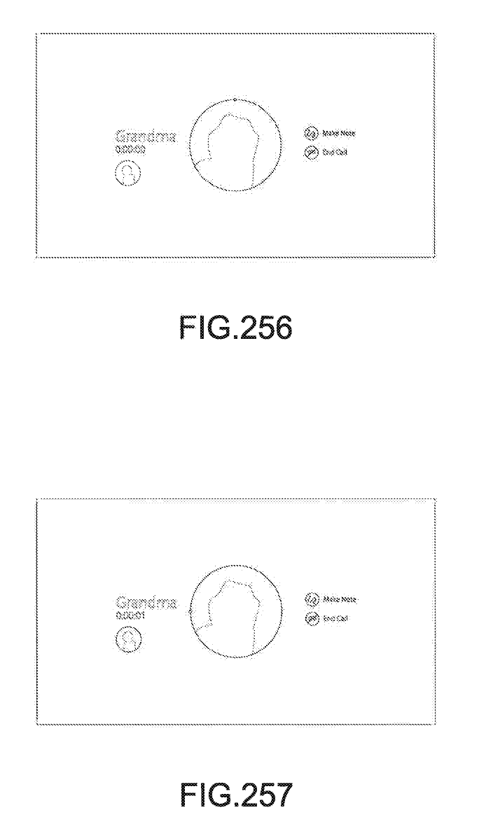

When calling is performed and a connection is established with a call destination, a talk time is displayed above the icon and a photograph of the face of a person that is the call destination is displayed in the information display area inside the circle (FIG. 256, FIG. 257). Actions that can be performed by the user are displayed with icons thereof in a space on the right-hand side outside the circle (FIG. 256, FIG. 257).

<Display Control Example 18>

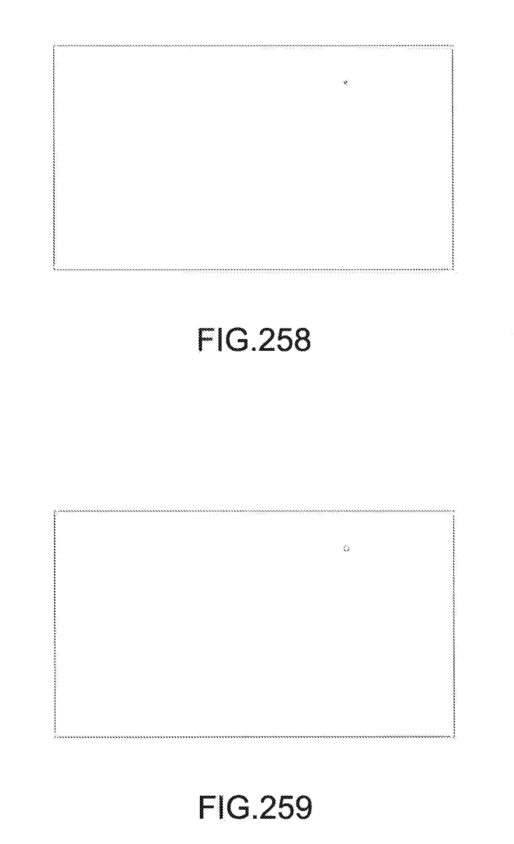

The display control apparatus 1 displays an animation that changes in the order from FIGS. 258 to 267. This animation is an example of the display control of Display Control Pattern 1 above. Hereinafter, the animation will be described.

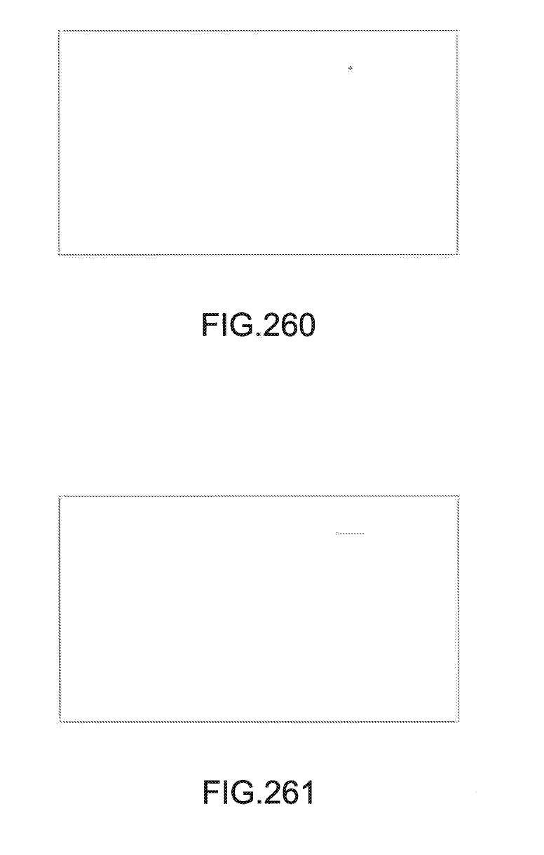

First of all, on a screen in an initial state, a dot (first display element) is faded in and displayed (FIG. 258). Next, the dot is enlarged (FIG. 259). While waiting for a trigger, contraction and enlargement of the dot are repeated (FIG. 258, FIG. 259, FIG. 260). Next, an animation in which the line (second display element) is pulled out of the dot is displayed (FIG. 261).

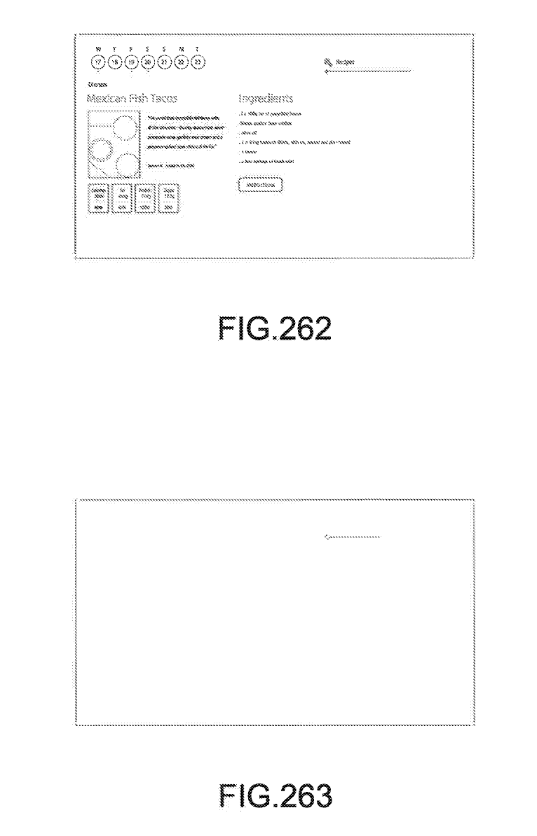

The dot is located at an upper right position of the screen and a line extends to the right from there (FIG. 258, FIG. 259, FIG. 260). A search box is set on the completely extending line (FIG. 262). When the user inputs literal characters, the information corresponding to the input literal characters is displayed in a free space on the screen (FIG. 262).

In this example, a cooking recipe is displayed (FIG. 262). The recipe is displayed and a button indicating “instruction” is shown (FIG. 262). With an action of clicking or tapping it by the user being a trigger, the displayed recipe and the like temporarily disappear and the line is also integrated into the dot (FIG. 263).

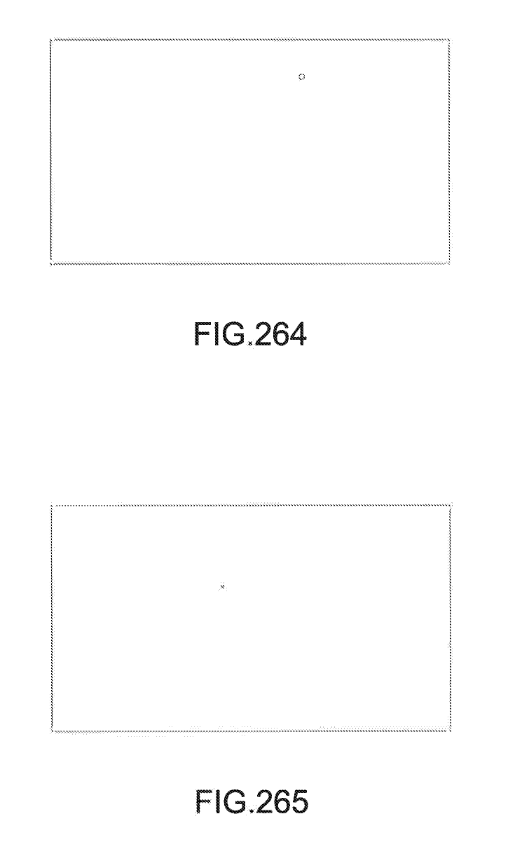

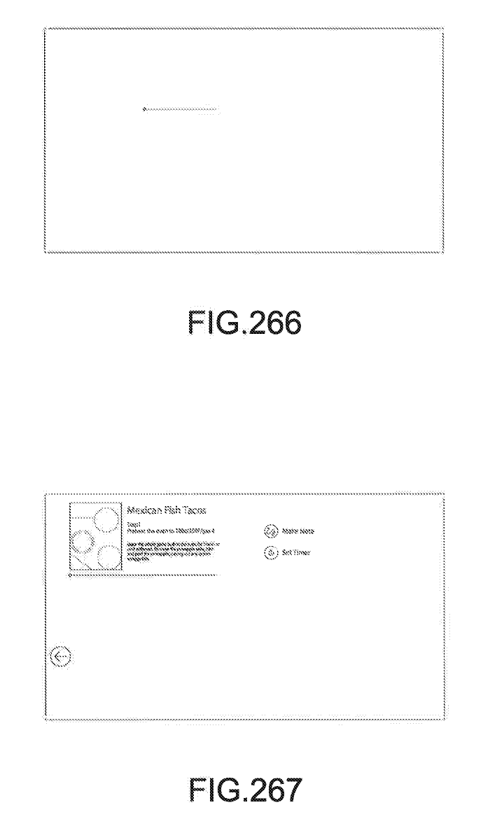

Subsequently, the dot is momentarily enlarged (FIG. 264) and returned to the original size and then moves (FIG. 265). The dot moves a position at which instructions of the recipe are displayed (FIG. 266, FIG. 267). A line is pulled out of the dot at that position (FIG. 266).

The line is pulled out of the dot to the right horizontally, a description of the recipe is displayed on one side (upper side) thereof, and actions that can be performed by the user are displayed together with icons thereof (FIG. 267). While audio instructions are being performed, this screen of FIG. 267 is displayed. On the instruction screen, an icon for returning the previous, recipe-displaying screen is displayed in a portion closest to the left of the screen (FIG. 267).

<Display Control Example 19>

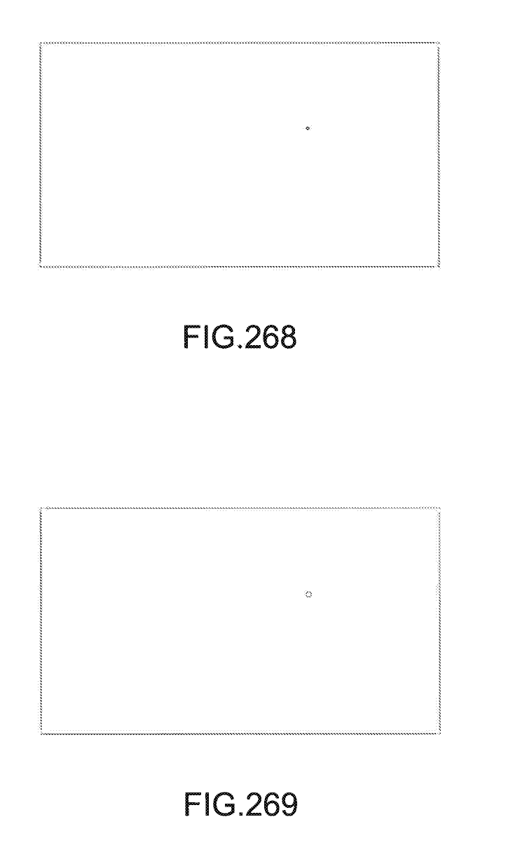

The display control apparatus 1 displays an animation that changes in the order from FIGS. 268 to 274. This animation is an example of the display control of Display Control Pattern 1 above. Hereinafter, the animation will be described.

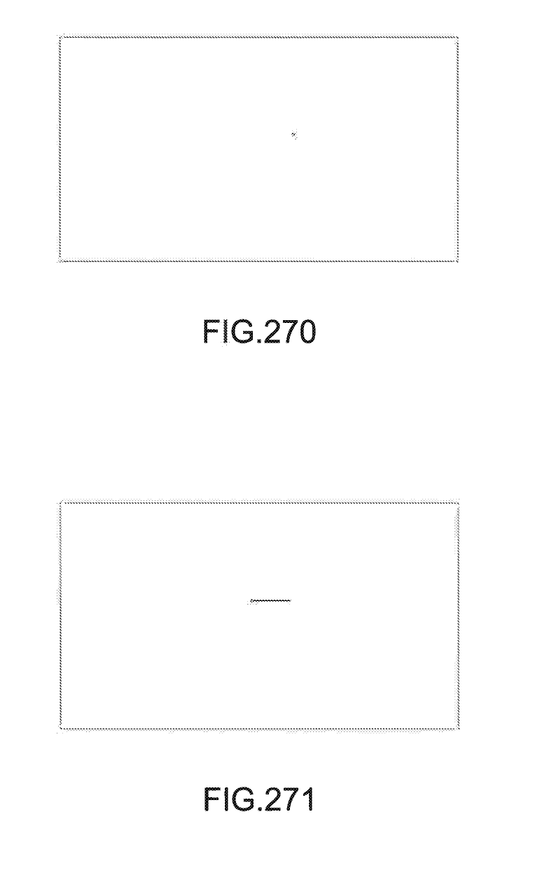

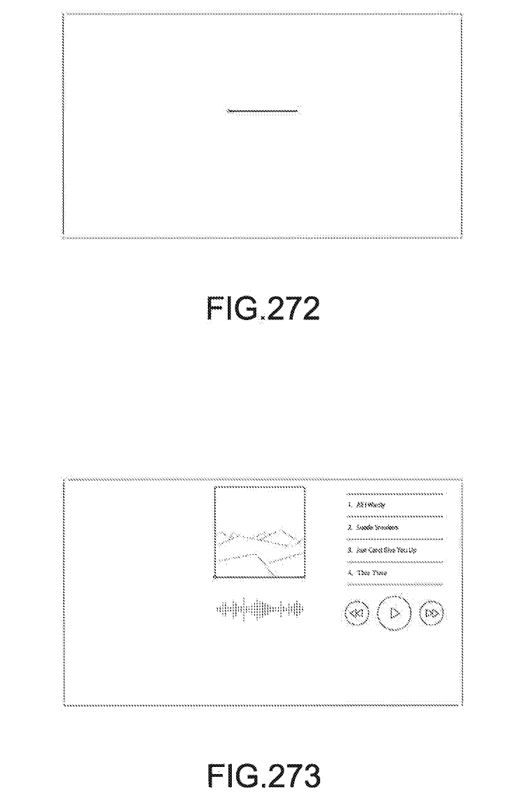

First of all, on a screen in an initial state, a dot (first display element) is faded in and displayed (FIG. 268). Next, the dot is enlarged (FIG. 269). While waiting for a trigger, contraction and enlargement of the dot are repeated (FIG. 268, FIG. 269, FIG. 270). Next, an animation in which the line (second display element) is pulled out of the dot is displayed (FIG. 271, FIG. 272).

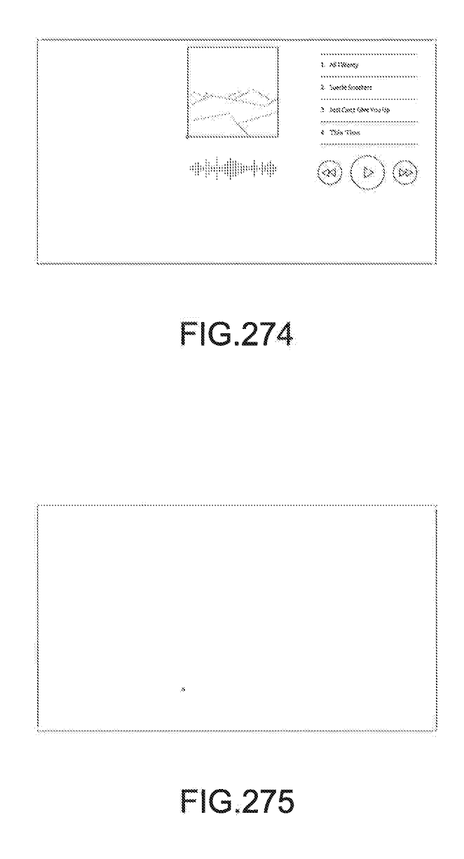

The dot is positioned at a center portion of the screen and a line extends to the right from there (FIG. 271, FIG. 272). On the completely extending line, there is set a rectangular frame that displays moving images and still images (FIG. 273). This example shows an example in which the GUI constituted by the line and the dot becomes a GUI of a media player (FIG. 273, FIG. 274). Outside this rectangular frame, GUI components of the media player and information (e.g., song name) of content that is a reproduction target are displayed (FIG. 273, FIG. 274).

<Display Control Example 20>

The display control apparatus 1 displays an animation that changes in the order from FIGS. 275 to 279. This animation is an example of the display control of Display Control Pattern 1 above. Hereinafter, the animation will be described.

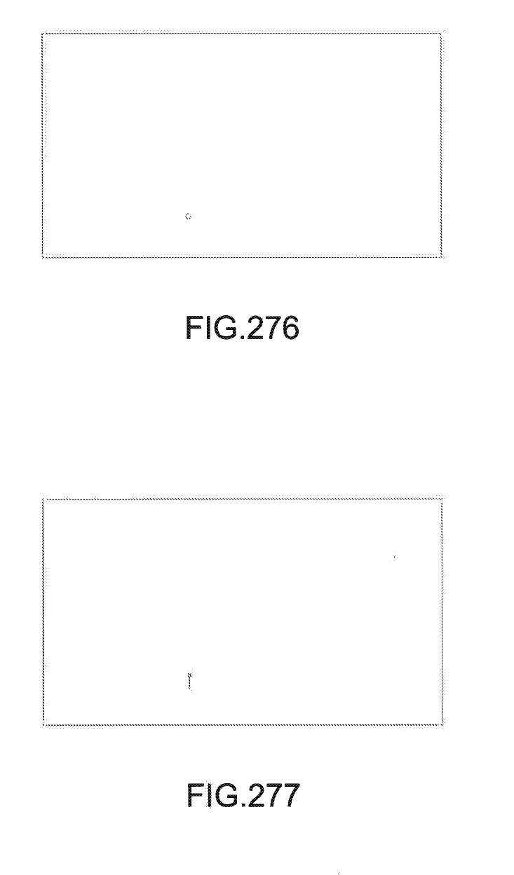

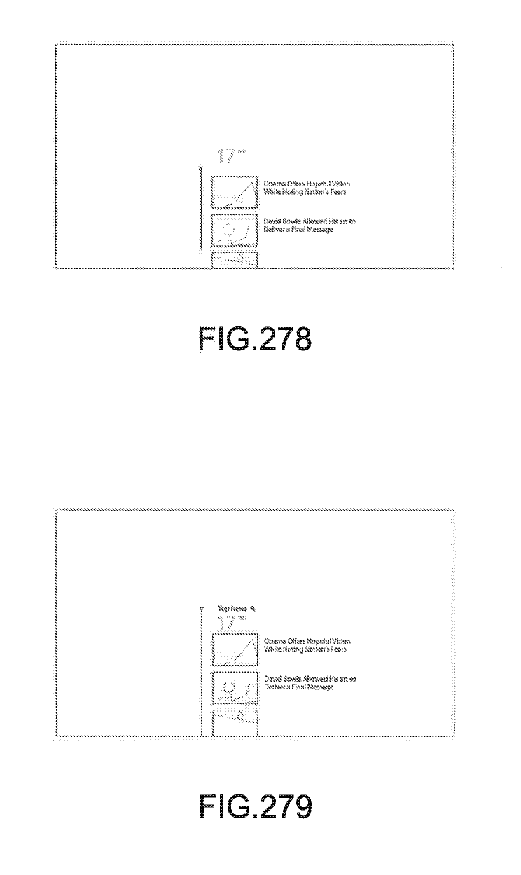

First of all, on a screen in an initial state, a dot (first display element) is faded in and displayed (FIG. 275). Next, the dot is enlarged (FIG. 276). Next, an animation in which the line (second display element) is pulled out of the dot is displayed (FIG. 277, FIG. 278, FIG. 279).

On one side (right-hand side) of the line, pieces of news content (e.g., news information and weather information) are aligned and displayed (FIG. 278, FIG. 279).

Linked with rising of the dot, the pieces of content aligned and displayed on the one side (right-hand side) of the line also rise (FIG. 278, FIG. 279).

<Display Control Example 21>

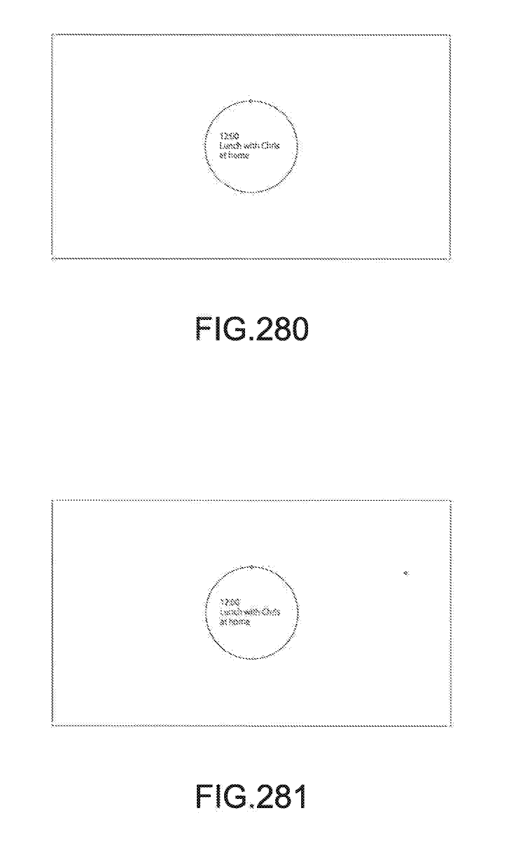

The display control apparatus 1 displays an animation that changes in the order from FIGS. 280 to 286. This animation is an example of the display control of Display Control Pattern 1 above. Hereinafter, the animation will be described.

The GUI constituted by the dot and the line is displayed (FIG. 280). The line is formed having a circle shape and the dot is located at a point on the circumference (FIG. 280). The inside of the circle is the display area of the information (FIG. 280).

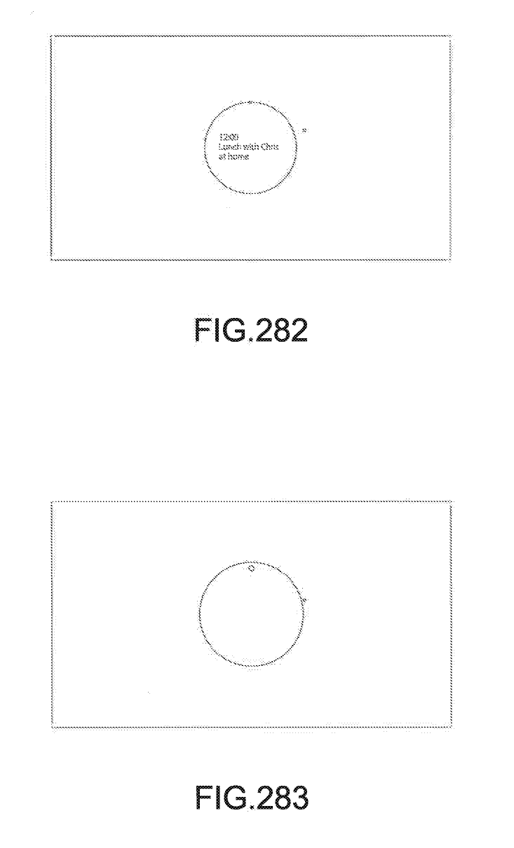

Next, another dot (second dot) is faded in outside the circle (FIG. 281). The second dot approaches the circle (FIG. 282). When the second dot comes in contact with the circle or near the circle (FIG. 283), the information display within the display area disappears (FIG. 283). Along with this, a copy of the circle constituted by the line is generated and enlarged (FIG. 283). The initial dot (first dot) is momentarily enlarged and the circle constituted by the line becomes thinner (FIG. 283).

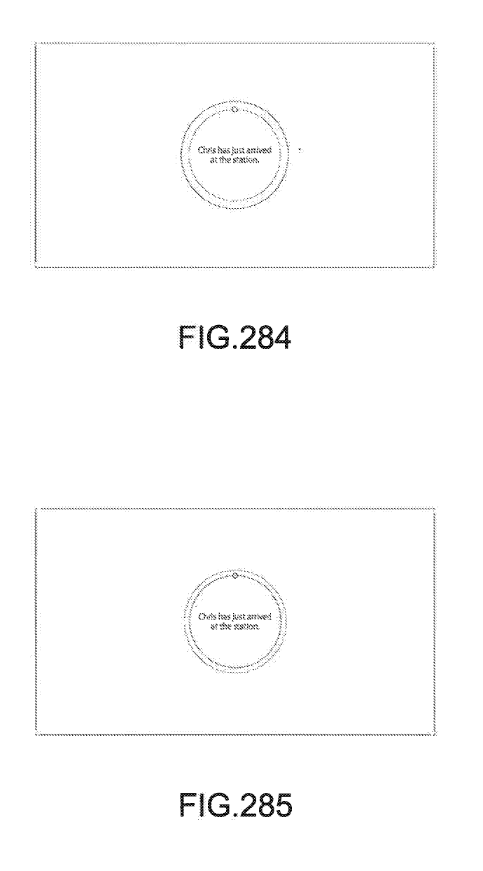

Subsequently, the second dot is faded out (FIG. 284). The display of the GUI constituted by the first dot and the line is restored and new information is displayed in the display area in the inside thereof (FIG. 284).

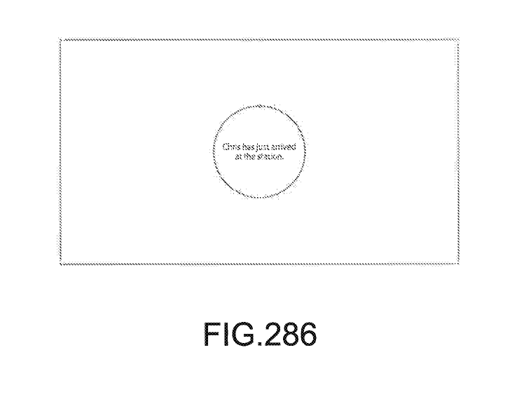

Subsequently, the second dot disappears (FIG. 285). The circle copied in FIG. 283 is faded out (FIG. 285). The GUI constituted by the first dot and the line remains (FIG. 286). It should be noted that the information of the information display area inside the circle surrounded with the line is replaced by new information (FIG. 286).

### CONCLUSION

Some of the above-mentioned specific examples provide solutions to the problem relating to how to make it easy for the user to notice information displayed at a position, at which the user does not expect that some information display is performed, while considering the safety of the user. They are suitable for displaying GUIs to be superimposed on an ordinary landscape like usage examples in which a table top screen and a projector-projected image are displayed on a wall surface or transparent window or usage examples with an HMD or HUD.

In the above-mentioned specific examples, predetermined information display is performed through the line (thin line) drawn by the dot's trajectory thereof starting from the dot, and hence it becomes easy for the user to notice them. The display control apparatuses according to the above-mentioned specific examples may be used in such a manner that a surface on which the GUI constituted by basically the dot and the line is projected is a table, a wall, or a window. In this case, a plurality of users can work using a common GUI.

Further, in the display control apparatuses according to the above-mentioned specific examples, a dot is first displayed. It is first displayed as small one and the field of view is not widely shielded, and hence display considering the safety can be realized and the effect thereof is advantageously exerted in a case where it is implemented with the HMD or HUD. Further, by first displaying the dot, subsequent information display items can be expected by the user. Thus, an inconvenience that a plurality of information display items are randomly displayed using a large space wastefully can also be overcome by user's cancellation at this phase.

### APPENDIX

It should be noted that the present technology may also take the following configurations.

(1)

A display control apparatus, including

a control unit that
outputs a first display element expressed on a display surface by a dot having a first color whose contrast is higher than that of the display surface,
outputs one or a plurality of second display elements expressed on the display surface by a line having the first color, and
moves or deforms at least any of the first display element and the second display elements.
   (2)

The display control apparatus according to (1), in which

the control unit deforms the second display element such that the second display element is pulled out of the first display element.

(3)

The display control apparatus according to (2), in which

the control unit deforms the second display element such that an end portion of the second display element pulled out of the first display element is combined with the first display element and draws an endless figure.

(4)

The display control apparatus according to (1), in which

the control unit deforms the second display element such that the second display element that is an endless figure is pulled out of the first display element.

(5)

The display control apparatus according to (3) or (4), in which

the control unit
outputs information presented to a user within the second display element that is the endless figure, and
determines a shape of the endless figure in a manner that depends on a type of the output information.
   (6)

The display control apparatus according to (5), in which

the control unit changes a width of the second display element in a manner that depends on the degree of necessity for calling attention.

(7)

The display control apparatus according to any one of (1) to (6), in which

the control unit
displays the plurality of second display elements while the plurality of second display elements are partially superimposed on each other, and
continuously deforms the plurality of superimposed second display elements over time.
   (8)

The display control apparatus according to (7), in which

the control unit outputs each of the plurality of second display elements to have a closed curve or polygonal shape.

(9)

The display control apparatus according to (7) or (8), in which

the control unit continuously deforms the plurality of superimposed second display elements over time, as a response to input from the user.

(10)

The display control apparatus according to (9), in which

the control unit
inputs voice as the input from the user, and
continuously deforms the plurality of superimposed second display elements over time while the voice input is being done, as a response of the voice input.
   (11)

The display control apparatus according to any one of (1) to (10), in which

the control unit outputs the second display element to have a width smaller than a diameter of the dot of the first display element.

(12)

A display control method executed by a control unit of a display control apparatus, the display control method including:

outputting a first display element expressed on a display surface by a dot having a first color whose contrast is higher than that of the display surface;

outputting one or a plurality of second display elements expressed on the display surface by a line having the first color; and

moving or deforming at least any of the first display element and the second display elements.

(13)

A display control program that causes a control unit of a display control apparatus to execute steps of:

outputting a first display element expressed on a display surface by a dot having a first color whose contrast is higher than that of the display surface;

outputting one or a plurality of second display elements expressed on the display surface by a line having the first color; and

moving or deforming at least any of the first display element and the second display elements.

### REFERENCE SIGNS LIST

1 . . . display control apparatus
11 . . . display control unit
12 . . . storage unit
13 . . . input unit
14 . . . output unit
15 . . . display surface

1. A display control apparatus, comprising
a control unit that
outputs a first display element expressed on a display surface by a dot having a first color whose contrast is higher than that of the display surface,
outputs one or a plurality of second display elements expressed on the display surface by a line having the first color, and
moves or deforms at least any of the first display element and the second display elements.

2. The display control apparatus according to claim 1, wherein
the control unit deforms the second display element such that the second display element is pulled out of the first display element.

3. The display control apparatus according to claim 2, wherein
the control unit deforms the second display element such that an end portion of the second display element pulled out of the first display element is combined with the first display element and draws an endless figure.

4. The display control apparatus according to claim 1, wherein
the control unit deforms the second display element such that the second display element that is an endless figure is pulled out of the first display element.

5. The display control apparatus according to claim 3, wherein
the control unit
outputs information presented to a user within the second display element that is the endless figure, and
determines a shape of the endless figure in a manner that depends on a type of the output information.

6. The display control apparatus according to claim 5, wherein
the control unit changes a width of the second display element in a manner that depends on the degree of necessity for calling attention.

7. The display control apparatus according to claim 1, wherein
the control unit
displays the plurality of second display elements while the plurality of second display elements are partially superimposed on each other, and
continuously deforms the plurality of superimposed second display elements over time.

8. The display control apparatus according to claim 7, wherein
the control unit outputs each of the plurality of second display elements to have a closed curve or polygonal shape.

9. The display control apparatus according to claim 7, wherein
the control unit continuously deforms the plurality of superimposed second display elements over time, as a response to input from the user.

10. The display control apparatus according to claim 9, wherein
the control unit
inputs voice as the input from the user, and
continuously deforms the plurality of superimposed second display elements over time while the voice input is being done, as a response of the voice input.

11. The display control apparatus according to claim 1, wherein
the control unit outputs the second display element to have a width smaller than a diameter of the dot of the first display element.

12. A display control method executed by a control unit of a display control apparatus, the display control method comprising:
outputting a first display element expressed on a display surface by a dot having a first color whose contrast is higher than that of the display surface;
outputting one or a plurality of second display elements expressed on the display surface by a line having the first color; and
moving or deforming at least any of the first display element and the second display elements.

13. A display control program that causes a control unit of a display control apparatus to execute steps of:
outputting a first display element expressed on a display surface by a dot having a first color whose contrast is higher than that of the display surface;
outputting one or a plurality of second display elements expressed on the display surface by a line having the first color; and
moving or deforming at least any of the first display element and the second display elements.
